(19) United States
(12) Patent Application Publication
(10) Pub. No.: US 2006/0165919 A1
(43) Pub. Date: Jul. 27, 2006

(54) Coating composition, optical film, anti-reflection film, polarizing plate and image display device using the same

(75) Inventors: Takato Suzuki, Minami-Ashigara-shi (JP); Masataka Yoshizawa, Minami-Ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: FUJI PHOTO FILM CO., LTD., Minami-Ashigara-shi (JP)

(21) Appl. No.: 11/339,521

(22) Filed: Jan. 26, 2006

(30) Foreign Application Priority Data
Jan. 27, 2005 (JP) P2005-019557

(51) Int. Cl. C09K 19/00

(52) U.S. Cl. 428/1.31

(57) ABSTRACT

A coating composition comprises: a fluoroaliphatic group-containing copolymer comprising a repeating unit A corresponding to a fluoroaliphatic group-containing monomer and a repeating unit B corresponding to at least one monomer, wherein a material obtained by polymerization of only the repeating unit B exhibits a glass transition point of 300K or more. A coating composition comprises: a fluoroaliphatic group-containing copolymer comprising a repeating unit A corresponding to a fluoroaliphatic group-containing monomer and a repeating unit B corresponding to at least one monomer, wherein the fluoroaliphatic group-containing copolymer exhibits a glass transition point of 273K or more.

### BACKGROUND OF THE INVENTION

1. Field of the Invention

The present invention relates to a coating composition, an optical film, an anti-reflection film, a polarizing plate and an image display device using the same.

2. Description of the Related Art

In recent years, the development of materials for various coating methods has been under way. In particular, thin layer coating technique involving spreading to a thickness on the order of from few micrometers to scores of nanometers is required for optical film forming, printing, photolithography, etc. The coating precision required for this technique has been increasing with the reduction of the thickness of layer, the rise of the size of substrate and the coating rate, etc. In the production of optical film in particular, the control over the layer thickness is a very important key governing the optical properties. Thus, the demand for technique that can realize a higher coating speed while keeping the coating precision high has been growing more and more. An anti-reflection layer is normally disposed on the outermost surface of the display in a display device such as cathode ray tube display device (CRT), plasma display (PDP), electroluminescence display (ELD) and liquid crystal display device (LCD) to reduce reflectance by the principle of optical interference so that the drop of contrast or reflection of image due to reflection of external light can be prevented.

With the recent spread of these display devices, particularly those having a smaller depth and a larger display area than the related art CRT, display devices having a higher precision and a higher quality have been demanded more and more. Accordingly, high uniformity in surface conditions of anti-reflection layer has been keenly demanded. The term “uniformity in surface conditions” as used herein is meant to indicate that there is neither dispersion of optical properties such as anti-reflection properties nor dispersion of film physical properties such as scratch resistance in all the display area.

As a method of producing an anti-reflection layer there may be used an inorganic vacuum evaporation method such as the formation of anti-glare anti-reflection layer excellent in gas barrier properties, anti-glare properties and anti-reflection properties made of silicon oxide layer by CVD described in JP-A-2004-331812. From the standpoint of mass productivity, however, a method of producing an anti-reflection layer involving all-wet spreading over a web having a continuous length.

The all-wet spreading method using a solvent is very advantageous from the standpoint of productivity but can very difficultly keep the solvent dryability constant shortly after spreading and thus can easily cause unevenness in surface conditions.

Representative examples of unevenness in surface conditions include drying unevenness attributed to the difference in solvent drying speed and wind unevenness, that is, thickness unevenness attributed to drying wind. The rise of coating speed for the purpose of further raising the productivity in the all-wet spreading is an essential technique. However, when the coating speed is merely raised, the speed of drying wind, too, is raised relatively. Further, the coat layer is affected also by the wind accompanying the high speed movement of the support, worsening wind unevenness. Thus, the coating speed cannot be raised too much in the related art in order to obtain an anti-reflection layer having little dispersion of optical properties and film physical properties.

It is known that the leveling properties can be enhanced to advantage to eliminate drying unevenness. As one of methods of enhancing the leveling properties there has been proposed a method involving the incorporation of a surface active agent in a coating composition. This method is based on a mechanism that a coating composition having a surface active agent incorporated therein exhibits a lowered surface tension and hence enhanced wetting properties with respect to the adherend, making it possible to reduce the surface tension or its change at the coat layer forming step and hence prevent heat convection and improve film uniformity (see Kotinguyo Tenkazai no Saishin Gijutsu (Advanced Technology of Coating Additives), compiled under the supervision of Haruo Kiryu, CMC, pp. 92-103, 2001). The optimum kind of surface active agent depends on the compatibility with solvent, resin and various additives in the desired coating composition. In the case where spreading is effected with a solvent, however, it is effective to use a fluorine-based surface active agent which is soluble in the solvent and has the highest surface tension reducing capacity. In general, a fluorine-based surface active agent is composed of a compound having in the same molecule a fluoroaliphatic group for realizing a surface tension reducing capacity and a solvent-philic group contributing to the affinity for coating and molding compositions, if the active agent is used as an additive. Such a compound is obtained by the copolymerization of a monomer having a fluoroaliphatic group with a monomer having a solvent-philic group.

Representative examples of the monomer having a solvent-philic group to be copolymerized with the monomer having a fluoroaliphatic group include poly (oxyalkylene) acrylate, and poly(oxyalkylene) methacrylate.

The use of related art fluorine-based surface active agents makes it possible to improve resistance to drying or wind unevenness but is disadvantageous in that these fluorine-based surface active agents are transferred. The term “transfer” as used herein is meant to indicate a phenomenon that the fluorine-based surface active agent moves to an object which comes in contact with the surface of the coat layer. In some detail, the fluorine-based surface active agent moves to the conveyance roll which comes in contact with the back side of the web thus coated or the coat layer during the coating step. When the fluorine-based surface active agent moves to the back side of the web, the adhesivity at the step of laminating the anti-reflection layer is lowered, causing easy exfoliation. Further, when the web is again conveyed into the coating step, the fluorine-based surface active agent is secondarily transferred to the conveyance roll, causing the contamination of the subsequent web or easy slippage during conveyance.

### SUMMARY OF THE INVENTION

An aim of the invention is to provide (1) a coating composition comprising a surface active agent (preferably fluoroaliphatic group-containing copolymer) which can attain both improvement in resistance to drying unevenness and wind unevenness and elimination of transfer of surface active agent, particularly fluorine-based surface active agent.

Another aim of the invention is to provide (2) an anti-reflection film having a high uniformity in surface conditions and sufficient anti-reflection properties.

A further aim of the invention is to provide (3) a polarizing plate and an image display device comprising such an anti-reflection film.

The inventors made extensive studies of the structure of the fluoroaliphatic group in the fluoroaliphatic group-containing monomer which is a constituent component of fluorine-based surface active agent and the fluoroaliphatic group-containing monomer in the fluorine-based surface active agent and the formulation of the fluoroaliphatic group-containing monomer. As a result, it was found that when the glass transition point of the fluoroaliphatic group-containing monomer and the fluorine-based surface active agent are predetermined to be not lower than a specific value focusing the glass transition point of these materials, a composition having little drying or wind unevenness during spreading and suppressed transferability can be obtained.

In other words, the aforementioned aims of the invention are accomplished by the following constitutions.

(1) A coating composition comprising a fluoroaliphatic group-containing copolymer containing a repeating unit A corresponding to a fluoroaliphatic group-containing monomer and a repeating unit B corresponding to at least one monomer, wherein a material (polymer) obtained by polymerization of only the repeating unit B exhibits a glass transition point of 300K or more.

(2) A coating composition comprising a fluoroaliphatic group-containing copolymer containing a repeating unit A corresponding to a fluoroaliphatic group-containing monomer and a repeating unit B corresponding to at least one monomer, wherein the fluoroaliphatic group-containing copolymer exhibits a glass transition point of 273K or more. The glass transition point of the aforementioned copolymer is preferably from not lower than 300K to not higher than 500K.

(3) The coating composition as defined in Clause (1) or (2), wherein the repeating unit A corresponding to fluoroaliphatic group-containing monomer comprises a fluoroaliphatic group-containing monomer represented by the following general formula [1]: 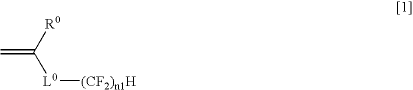
wherein R⁰ represents a hydrogen atom, halogen atom or methyl group; L⁰ represents a divalent connecting group; and n1 represents an integer of from not smaller than 1 to not greater than 18.

(4) The coating composition as defined in Clause (1) or (2), wherein the repeating unit A corresponding to fluoroaliphatic group-containing monomer comprises a fluoroaliphatic group-containing monomer represented by the following general formula [2]: 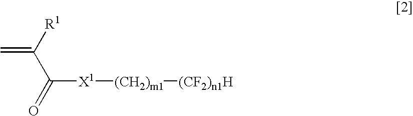
wherein R¹ represents a hydrogen atom, halogen atom or methyl group; X¹ represents an oxygen atom, sulfur atom or —N(R²)— in which R² represents a hydrogen atom or a C₁-C₈ alkyl group which may have substituents; and n1 represents an integer of from not smaller than 1 to not greater than 18.

(5) The coating composition as defined in Clause (1) or (2), wherein the repeating unit A corresponding to fluoroaliphatic group-containing monomer comprises a fluoroaliphatic group-containing monomer represented by the following general formula [3]: 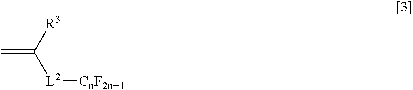
wherein R³ represents a hydrogen atom, halogen atom or methyl group; L² represents a divalent connecting group; and n represents an integer of from not smaller than 1 to not greater than 6.

(6) The coating composition as defined in Clause 1 or 2, wherein the repeating unit A corresponding to fluoroaliphatic group-containing monomer comprises a fluoroaliphatic group-containing monomer represented by the following general formula [4]: 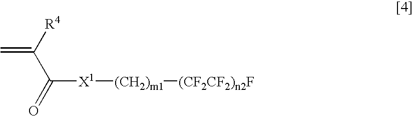
wherein R⁴ represents a hydrogen atom or methyl group; X¹ represents an oxygen atom, sulfur atom or —N(R²)— in which R² represents a hydrogen atom or a C₁-C₄ alkyl group which may have substituents; m1 represents an integer of from not smaller than 1 to not greater than 6; and n2 represents an integer of from not smaller than 1 to not greater than 3.

(7) The coating composition as defined in Clause (3), wherein n1 in the general formula [1] is 6.

(8) The coating composition as defined in Clause (4), wherein n1 in the general formula [2] is 6.

(9) The coating composition as defined in Clause 5, wherein n in the general formula [3] is 6.

(10) The coating composition as defined in Clause 6, wherein n2 in the general formula [4] is 3.

(11) The coating composition as defined in any one of Clauses (1) to (10), wherein the repeating unit B is an isobornyl acrylate or isobornyl methacrylate unit.

(12) The coating composition as defined in any one of Clauses (1) to (10), wherein the repeating unit B is a tertiary butyl acrylate or tertiary butyl methacrylate unit.

(13) The coating composition as defined in any one of Clauses (1) to (12), wherein the fluoroaliphatic group-containing copolymer is included in an amount of 0.15% by mass or less based on the total amount of the coating composition.

(14) The coating composition as defined in any one of Clauses (1) to (13), wherein a mass-average molecular weight of the fluoroaliphatic group-containing copolymer is from 5,000 to 25,000.

(15) An optical film obtained by spreading a coating composition as defined in any one of Clauses (1) to (14) into at least one layer.

(16) An optical film obtained by spreading a coating composition as defined in any one of Clauses (1) to (14) into at least one layer, and then, onto the layer thus formed, spreading another layer.

(17) An anti-reflection film comprising an optical film as defined in Clause (15) or (16), wherein the optical film has anti-reflection property.

(18) A polarizing plate comprising an anti-reflection film as defined in Clause (17) provided on at least one side of a polarizing layer.

(19) A polarizing plate comprising an anti-reflection film as defined in Clause (17) as one of protective films for polarizing layer and an optically anisotropic optical compensation film as the other.

(20) An image display device comprising an anti-reflection film as defined in Clause (17) or a polarizing plate as defined in Clause (18) or (19) disposed therein.

### BRIEF DESCRIPTION OF THE DRAWINGS

FIG. 1 is diagrammatic sectional view illustrating an example of the layer configuration of the anti-reflection film according to the invention;

FIG. 2 is diagrammatic sectional view illustrating another example of the layer configuration of the anti-reflection film according to the invention;

FIG. 3 is diagrammatic sectional view illustrating a further example of the layer configuration of the anti-reflection film according to the invention;

FIG. 4 is diagrammatic sectional view illustrating a still further example of the layer configuration of the anti-reflection film according to the invention;

FIG. 5 is diagrammatic sectional view illustrating a still further example of the layer configuration of the anti-reflection film according to the invention;

FIG. 6 is diagrammatic sectional view illustrating a still further example of the layer configuration of the anti-reflection film according to the invention;

FIG. 7 is a diagrammatic sectional view illustrating a still further example of the layer configuration of the anti-reflection film according to the invention with the outlook of anti-glare properties emphasized;

FIG. 8 is a sectional view of a coater comprising a slot die embodying the invention;

FIGS. 9A and 9B are sectional views illustrating the sectional shape of the slot die 13 as compared with the related art slot die;

FIG. 10 is a perspective view illustrating the slot die at the coating step embodying the invention and its periphery;

FIG. 11 is a sectional view illustrating the pressure-reducing chamber 40 and the web W disposed close to each other (back plate 40a is integrated with chamber 40); and

FIG. 12 is a sectional view illustrating the pressure-reducing chamber 40 and the web W disposed close to each other (back plate 40a is fixed to chamber 40 with 40c).

(1) denotes a transparent support; (2) denotes a hard coat layer; (3) denotes a middle refractive layer; (4) denotes a high refractive layer; (5) denotes a low refractive layer; 10 denotes a coater; 11 denotes a backup roller; W denotes a web; 14 denotes a coating solution; 14a denotes a bead; 14b denotes a coat layer; 16 denotes a slot; 17 denotes a forward end lip; 18 denotes a land; 18a denotes a upstream lip land; 18b denotes a downstream lip land; I_{UP} denotes a length of upstream lip land 18a; I_{LO} denotes a length of downstream lip land 18b; LO denotes an overbite length (distance between the distance between the upstream lip land 18b and the web W and the distance between the upstream lip land 18a and the web W); GL denotes a gap between the forward lip 17 and the web W (gap between the downstream lip land 18b and the web W); 30 denotes a related art slot die; 31a denotes an upstream lip land; 31b denotes a downstream lip land; 32 denotes a pocket; 33 denotes a slot; 40 denotes a pressure-reducing chamber; 40a denotes a back plate; 40b denotes a side plate; GB denotes a gap between back plate 40a and web W; GS denotes a gap between side plate 40b and web W.

### DETAILED DESCRIPTION OF THE INVENTION

Preferred embodiments of the composition, coating composition, optical film and anti-reflection film according to the invention, the method of producing the anti-reflection film, the polarizing plate comprising the anti-reflection film and the image display device comprising same will be described in detail hereinafter. The term “(meth)acryloyl” as used herein is meant to indicate “at least any of acryloyl and methacryloyl”. This applies also to “(meth)acrylate”, “(meth)acrylic acid”, etc. The term “(numerical value 1) to (numerical value 2)” as used hereinafter to represent physical properties or other properties is meant to indicate “(numerical value 1) to (numerical value 2), both inclusive”.

[Composition]

Firstly, the copolymer having a fluoroaliphatic group which is a composition of the invention (hereinafter occasionally referred to as “fluorine-based surface active agent of the invention”) will be described in detail hereinafter. The fluorine-based surface active agent is composed of a copolymer of at least one of monomer units represents by the general formulae [1], [2], [3] and [4] with at least one of repeating units B. As the monomer represented by the repeating unit B there is preferably used a monomer which is homopolymerized to form a material (polymer) having a glass transition point of 300K (Kelvin) or more, more preferably 350K or more, most preferably 400K or more (preferably 500K or less). Preferred examples of the repeating unit B will be given below.

Acrylic acid, 1-adamanthyl (meth)acrylate, adamanthyl crotonate, adamanthyl solvate, 4-biphenyl (meth)acrylate, tert-butyl (meth)acrylate, 2-tert-butylphenyl (meth) acrylate, 4-tert-butylphenyl (meth) acrylate, cesium (meth)acrylate, 3-chloro-2,2-bis(chloromethyl)propyl (meth)acrylate, 2-chlorophenyl (meth)acrylate, 4-chlorophenyl (meth)acrylate, 2,4-dichlorophenyl (meth)acrylate, 4-cyanobenzyl (meth)acrylate, 2-cyanobutyl (meth) acrylate, 2-cyanoisobutyl (meth)acrylate, 4-cyanobutyl (meth)acrylate, 2-cyanoethyl (meth)acrylate, 2-cyanoheptyl (meth)acrylate, 2-cyanohexyl (meth) acrylate, cyanomethyl (meth)acrylate, 4-cyanophenyl (meth)acrylate, 2-cyanoisopropyl (meth) acrylate, cyclododecyl (meth) acrylate, 1,2,3,4-di-O-isopropylidene-α-D-gallactopyranose-6-O-yl (meth) acrylate, 3,5-dimethyladamanthyl (meth)acrylate, 3,5-dimethyladamanthyl crotonate, 3-dimethylaminophenyl (meth)acrylate, 2-ethoxycarbonylphenyl (meth) acrylate, 4-ethoxycarbonylphenyl (meth)acrylate, ferrocenylmethyl (meth)acrylate, 3-fluoroalkyl-α-fluoro(meth)acrylate, 4-fluoroalkyl-α-fluoro(meth) acrylate, 5-fluoroalkyl-α-fluoro(meth)acrylate, 8-fluoroalkyl-α-fluoro(meth)acrylate, 17-fluoroalkyl-α-fluoro(meth)acrylate, furfuryl (meth)acrylate, hexadecyl (meth)acrylate, isobornyl (meth)acrylate, magnesium (meth)acrylate, 2-methoxycarbonylphenyl (meth)acrylate, 3-methoxycarbonylphenyl (meth) acrylate, 4-methoxycarbonylphenyl (meth)acrylate, 4-methoxyphenyl (meth)acrylate, 2-naphthyl (meth)acrylate, pentabromobenzyl (meth)acrylate, pentachlorophenyl (meth)acrylate, phenyl (meth)acrylate, potassium (meth)acrylate, sodium (meth)acrylate, tetradecyl (meth)acrylate, o-tollyl (meth)acrylate, p-tollyl (meth)acrylate, zinc (meth)acrylate, acrylamide, N-alkylacrylamide (in which the alkyl group is one having from 1 to 3 carbon atoms such as methyl, ethyl and propyl), N,N-dialkylacrylamide (in which the alkyl group is one having from 1 to 6 carbon atoms), N-hydroxyethyl-N-methylacrylamide, N-2-acetamideethyl-N-acetylacrylamide.

Methacrylamide, N-alkylmethacrylamide (in which the alkyl group is one having from 1 to 3 carbon atoms such as methyl, ethyl and propyl), N,N-hydroxyethyl-N-methyl methacrylamide, N-2-acetaamideethyl-N-acetyl methacrylamide.

Allyl acetate, allyl caproate, allyl caprate, allyl laurate, allyl palmitate, allyl stearate, allyl benzoate, allyl acetoacetate, allyl lactate, allyl oxyethanol.

Hexyl vinyl ether, octyl vinyl ether, decyl vinyl ether, ethylhexyl vinyl ether, methoxyethyl vinyl ether, ethoxyethyl vinyl ether, chloroethyl vinyl ether, 1-methyl-2,2-diemtylpropyl vinyl ether, 2-ethylbutyl vinyl ether, hydroxyethyl vinyl ether, diethylene glycol vinyl ether, dimethylaminoethyl vinyl ether, diethylaminoethyl vinyl ether, butylaminoethyl vinyl ether, benzyl vinyl ether, tetrahydrofuryl vinyl ether.

Vinyl butyrate, vinyl isobutyrate, vinyl trimethyl acetate, vinyl diethyl acetate, vinyl valate, vinyl caproate, vinyl chloroacetate, vinyl dichloroacetate, vinyl methoxy acetate, vinyl butoxy acetate, vinyl lactate, vinyl-p-phenyl butyrate, vinyl cyclohexyl carboxylate, dimethyl itaconate, diethyl itaconate, dibutyl itaconate, dibutyl fumarate, crotonic acid, itaconic acid, acrylonitrile, methacrylonitrile, maleylonitrile, styrene.

Particularly preferred among these materials are acrylic acid, 1-adamanthyl (meth)acrylate, 4-biphenyl (meth)acrylate, tert-butyl (meth)acrylate, 2-cyanobutyl (meth)acrylate, 2-cyanoheptyl (meth) acrylate, cyanomethyl (meth)acrylate, 3,5-dimethyl adamanthyl (meth)acrylate, isobornyl (meth)acrylate, and naphthyl (meth)acrylate. Most desirable among these materials are tert-butyl (meth)acrylate and isobornyl (meth)acrylate.

In the coating composition comprising a fluoroaliphatic group-containing copolymer containing a repeating unit A corresponding to fluoroaliphatic group-containing monomer and a repeating unit B corresponding to the aforementioned monomer, the glass transition point of the fluoroaliphatic group-containing copolymer is preferably 273K or more, more preferably from not lower than 300K to not higher than 500K.

The glass transition point of the repeating unit B is as disclosed in “Polymer Handbook 4th Edition”. The glass transition point of the fluorine-based surface active agent is measured using a Type DSC6200R differential scanning calorimeter (produced by Seiko Instruments Inc.). Referring to the measurement conditions, the sample is cooled to −100° C., and then heated to 120° C. at a rate of 20° C./min. During this procedure, the sample was measured for glass transition point according to the method disclosed in “Nyumon Kobunshi Bussei (Introduction to Physical Properties of Polymers)”, The Society of Polymer Science, Japan.

The fluoroaliphatic group-containing monomer represented by the general formula [1] will be further described hereinafter.

In the general formula [1] of the invention, R⁰ represents a hydrogen atom, halogen atom or methyl group, preferably a hydrogen atom or methyl group. L⁰ represents a divalent connecting group, preferably a divalent connecting group containing oxygen atom, sulfur atom and nitrogen atom. The suffix n1 represents an integer of from 1 to 18, preferably from 4 to 12, more preferably from 6 to 8, most preferably 6.

Further, the fluorine-based surface active agent may contain two or more fluoroaliphatic group-containing monomer polymerizing units represented by the general formula [1] as constituent units.

In the general formula [2] of the invention, R¹ represents a hydrogen atom, halogen atom or methyl group, preferably hydrogen atom or methyl group. X¹ represents an oxygen atom, sulfur atom or —N(R²)—, preferably oxygen atom or —N(R²)—, more preferably oxygen atom. R² represents a hydrogen atom or C₁-C₈ alkyl group, preferably hydrogen atom or C₁-C₄ alkyl group, more preferably hydrogen atom or methyl group. The suffix m1 represents an integer of from 1 to 6, preferably from 1 to 3, more preferably 1. The suffix n1 represents an integer of from 1 to 18, preferably from 4 to 12, more preferably from 6 to 8, most preferably 6.

Further, the fluorine-based surface active agent may contain two or more fluoroaliphatic group-containing monomer polymerizing units represented by the general formula [2] as constituent units.

Specific examples of the fluoroaliphatic group-containing monomer represented by the general formula [1] or [2] will be given below, but the invention is not limited thereto.

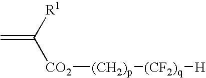

| | R¹ | p | q |
|---|---|---|---|
| F-1 | H | 1 | 4 |
| F-2 | CH₃ | 1 | 4 |
| F-3 | F | 1 | 4 |
| F-4 | H | 2 | 4 |
| F-5 | CH₃ | 3 | 4 |
| F-6 | H | 1 | 6 |
| F-7 | CH₃ | 1 | 6 |
| F-8 | F | 1 | 6 |
| F-9 | H | 2 | 6 |
| F-10 | CH₃ | 2 | 6 |
| F-11 | H | 3 | 6 |
| F-12 | H | 1 | 8 |
| F-13 | CH₃ | 1 | 8 |
| F-14 | F | 1 | 8 |
| F-15 | CH₃ | 2 | 8 |
| F-16 | H | 3 | 8 |
| F-17 | CH₃ | 3 | 8 |
| F-18 | H | 1 | 10 |
| F-19 | CH₃ | 1 | 10 |
| F-20 | F | 1 | 10 |
| F-21 | H | 2 | 10 |
| F-22 | CH₃ | 2 | 10 |

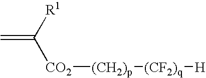

| | R¹ | p | q |
|---|---|---|---|
| F-23 | H | 1 | 12 |
| F-24 | CH₃ | 1 | 12 |
| F-25 | F | 1 | 12 |
| F-26 | H | 2 | 12 |
| F-27 | H | 3 | 12 |
| F-28 | H | 1 | 14 |
| F-29 | CH₃ | 1 | 14 |
| F-30 | F | 1 | 14 |
| F-31 | H | 2 | 14 |
| F-32 | CH₃ | 2 | 14 |
| F-33 | H | 1 | 16 |
| F-34 | CH₃ | 1 | 16 |
| F-35 | F | 1 | 16 |
| F-36 | CH₃ | 2 | 16 |
| F-37 | H | 3 | 16 |
| F-38 | H | 1 | 18 |
| F-39 | CH₃ | 1 | 18 |
| F-40 | F | 1 | 18 |
| F-41 | H | 3 | 18 |
| F-42 | CH₃ | 3 | 18 |

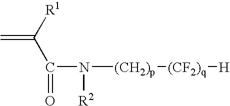

| | R¹ | R² | p | q |
|---|---|---|---|---|
| F-43 | H | H | 1 | 4 |
| F-44 | CH₃ | H | 1 | 4 |
| F-45 | H | CH₃ | 1 | 4 |
| F-46 | H | H | 2 | 4 |
| F-47 | H | H | 1 | 6 |
| F-48 | CH₃ | H | 1 | 6 |
| F-49 | H | CH₃ | 1 | 6 |
| F-50 | H | C₂H₅ | 1 | 6 |
| F-51 | CH₃ | H | 2 | 6 |
| F-52 | F | H | 2 | 6 |
| F-53 | H | H | 1 | 8 |
| F-54 | CH₃ | H | 1 | 8 |
| F-55 | H | CH₃ | 1 | 8 |
| F-56 | H | C₄H₉(n) | 1 | 8 |
| F-57 | CH₃ | C₂H₅ | 1 | 8 |
| F-58 | H | CH₂Ph | 1 | 8 |
| F-59 | H | H | 2 | 8 |
| F-60 | CH₃ | H | 3 | 8 |
| F-61 | H | H | 1 | 10 |
| F-62 | CH₃ | CH₃ | 1 | 10 |
| F-63 | H | H | 1 | 12 |
| F-64 | CH₃ | H | 1 | 12 |
| F-65 | H | H | 1 | 18 |
| F-66 | H | CH₃ | 1 | 18 |

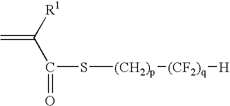

| | R¹ | p | q |
|---|---|---|---|
| F-67 | H | 1 | 4 |
| F-68 | CH₃ | 1 | 4 |
| F-69 | H | 2 | 4 |
| F-70 | H | 1 | 6 |
| F-71 | CH₃ | 1 | 6 |
| F-72 | CH₃ | 2 | 6 |
| F-73 | H | 1 | 8 |
| F-74 | CH₃ | 1 | 8 |
| F-75 | F | 1 | 8 |
| F-76 | H | 2 | 8 |
| F-77 | CH₃ | 3 | 8 |
| F-78 | H | 1 | 10 |
| F-79 | CH₃ | 1 | 10 |
| F-80 | H | 1 | 12 |
| F-81 | CH₃ | 1 | 12 |
| F-82 | H | 1 | 16 |
| F-83 | CH₃ | 2 | 16 |
| F-84 | H | 1 | 18 |
| F-85 | CH₃ | 1 | 18 |

In the general formula [3] of the invention, R³ represents a hydrogen atom, halogen atom or methyl group, preferably hydrogen atom or methyl group. L² represents a divalent connecting group, preferably divalent connecting group containing oxygen atom, sulfur atom and nitrogen atom. The suffix n represents an integer of from 1 to 6, preferably from 4 to 6, more preferably 6.

The fluoroaliphatic group-containing copolymer may contain two or more fluoroaliphatic group-containing monomer polymerizing units represented by the general formula [3] as constituent units.

In the general formula [4], R⁴ represents a hydrogen atom or methyl group. X¹ represents an oxygen atom, sulfur atom or —N(R²)—, preferably oxygen atom or —N(R²)—, more preferably oxygen atom. R² represents a hydrogen atom or a C₁-C₈ alkyl group, preferably hydrogen atom or a C₁-C₄ alkyl group, more preferably hydrogen atom or methyl group. The suffix m1 represents an integer of from 1 to 6, preferably from 1 to 3, more preferably 1. The suffix n2 represents an integer of from 1 to 3, preferably 2 or 3, more preferably 3. The fluoroaliphatic group-containing copolymer may contain two or more fluoroaliphatic group-containing monomer polymerizing units represented by the general formula [1] as constituent units.

Specific examples of the fluoroaliphatic group-containing monomer represented by the general formula [3] or [4] will be given below, but the invention is not limited thereto.

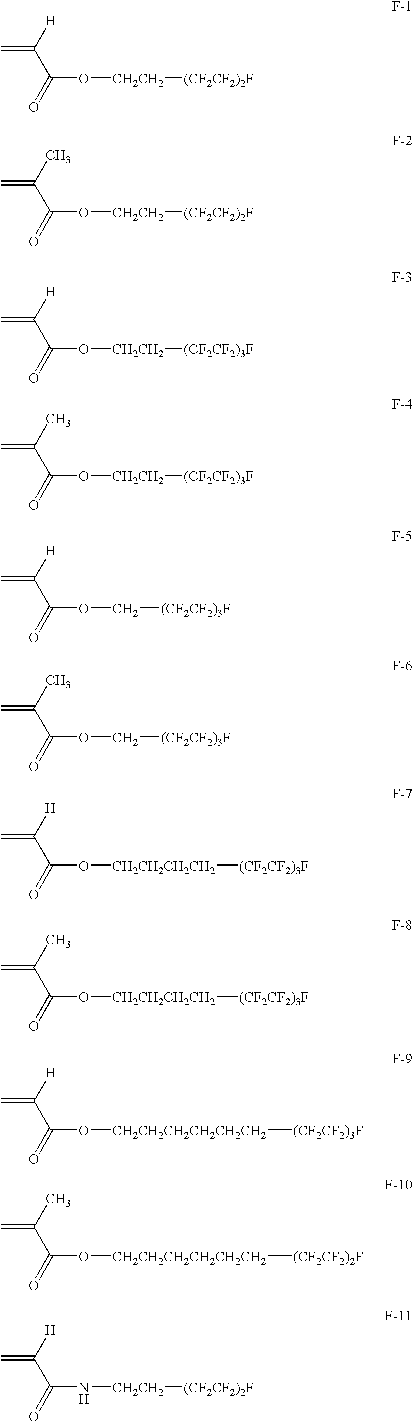

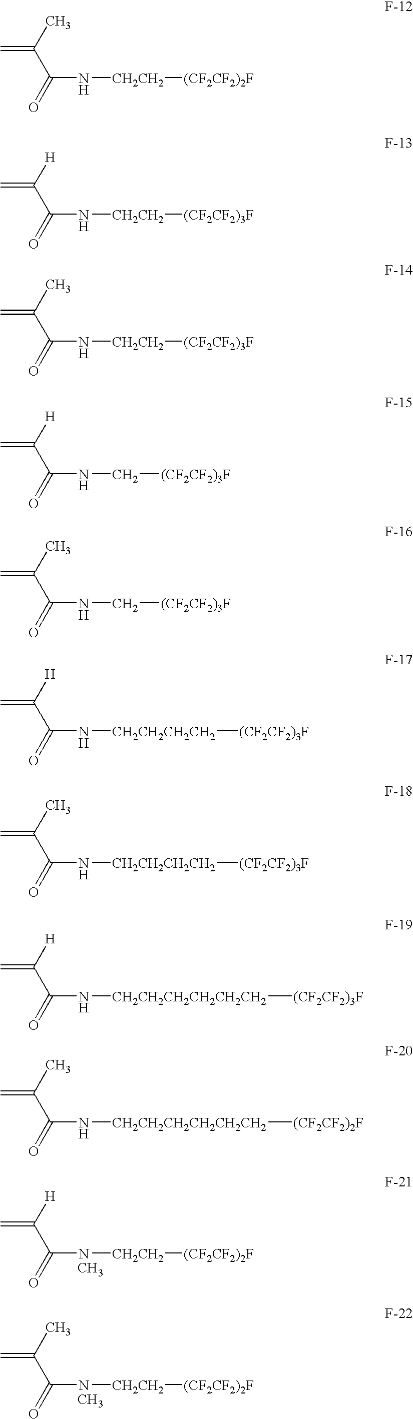

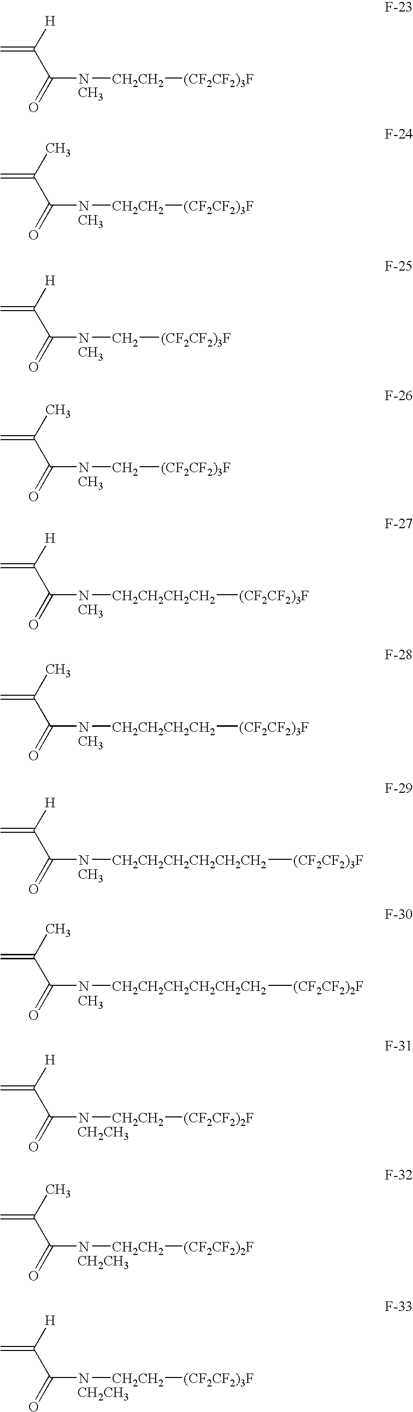

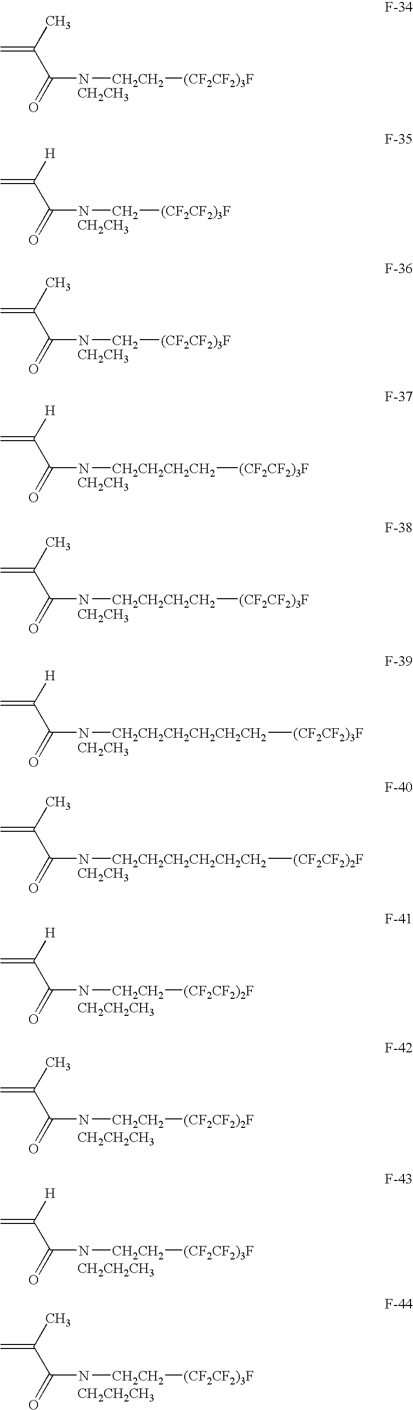

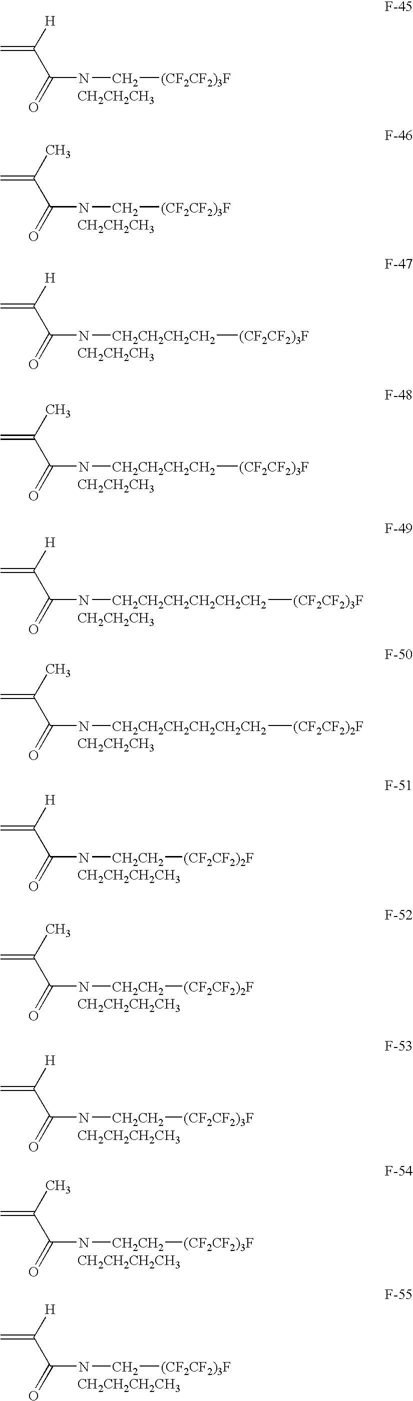

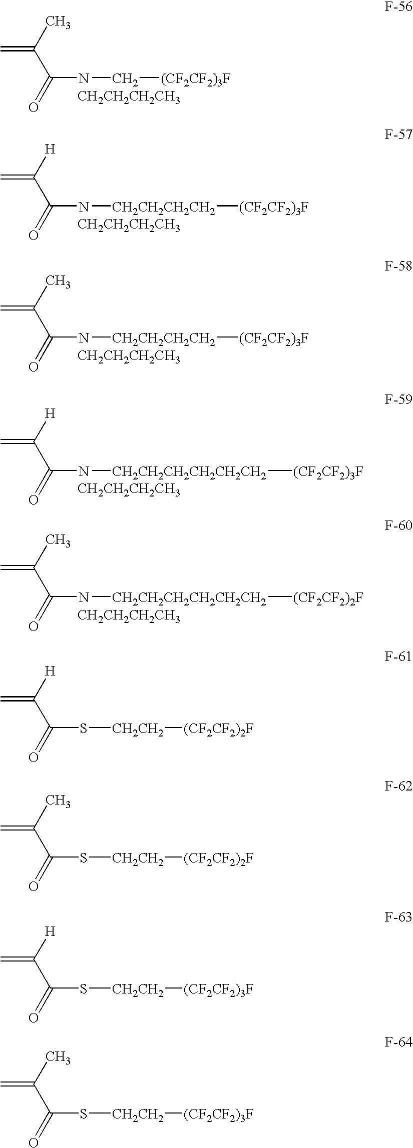

Some of fluorine-based chemical products produced by electrochemical fluorination method, which has heretofore been often used, exhibit a low degradability and hence a high bioaccumulativity and thus are likely to have reproduction toxicity and growth toxicity, through very low. The fluorine-based surface active agent having hydrogen atom at the end of fluoroaliphatic group-containing group or having as short fluoroalkyl chain length as 6 or less carbon atoms, eve though terminated by fluorine atom, of the invention is a material having a higher environmental safety to industrial advantage.

The preferred mass-average molecular weight of the fluoroaliphatic group-containing polymer to be used in the invention is preferably from 3,000 to 100,000, more preferably from 4,000 to 50,000, even more preferably from 5,000 to 25,000.

For the measurement of mass-average molecular weight and molecular weight, a GPC analyzer comprising a Type TSKgel GMHxL, TSKgel G4000HxL or TSKgel G2000HxL column (produced by TOSOH CORPORATION) is used. With THF as a solvent, detection is made using a differential refractometry. The results are then converted in polystyrene equivalence.

The fluorine-based surface active agent of the invention can be produced by any known conventional method such as method which comprises polymerizing monomers such as the aforementioned (meth)acrylate having a fluoroaliphatic group and (meth)acrylate having a straight-chain, branched or cyclic alkyl group, optionally with other addition-polymerizable unsaturated compounds in an organic solvent in the presence of a general-purpose radical polymerization initiator. A dropwise polymerization method which comprises polymerization with dropwise addition of monomers and an initiator into the reaction vessel depending on the polymerizability of the various monomers, too, can be used to obtain a polymer having a uniform formulation.

Specific examples of the structure of the fluorine-based surface active agent according to the invention will be given below, but the invention is not limited thereto. The figure in the general formulae each represent the weight percentage of the various monomer components. Mw represents the mass-average molecular weight of the compound.

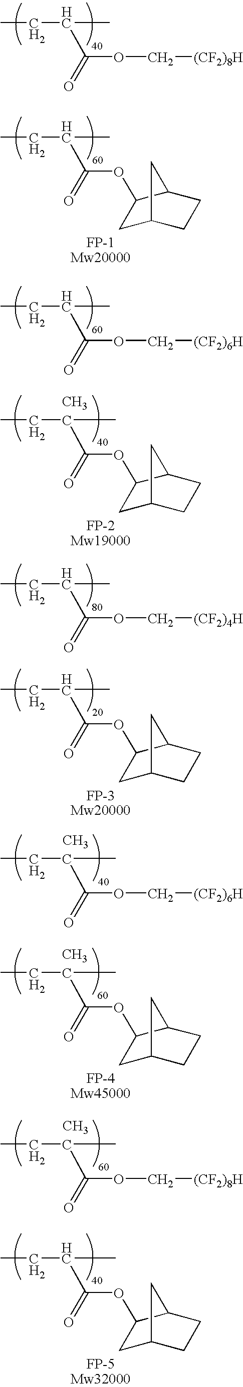

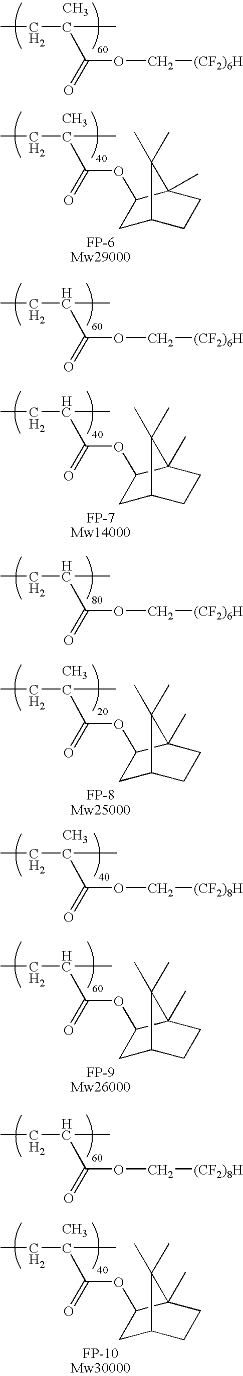

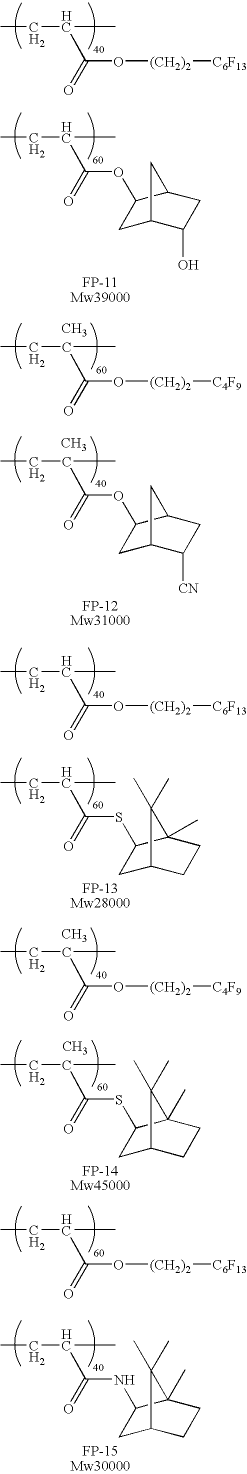

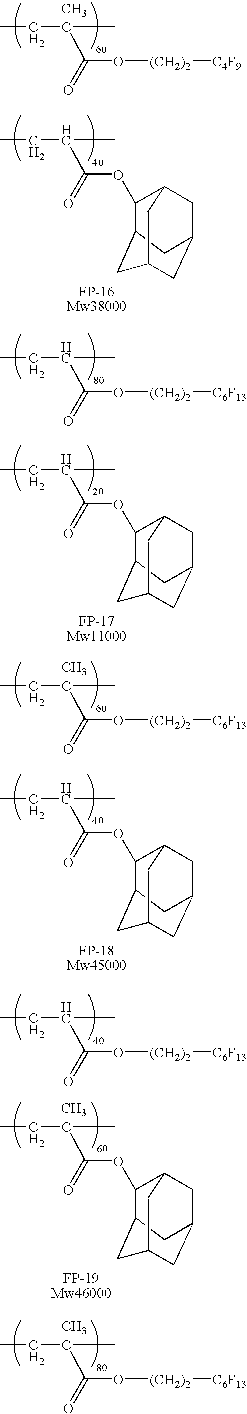

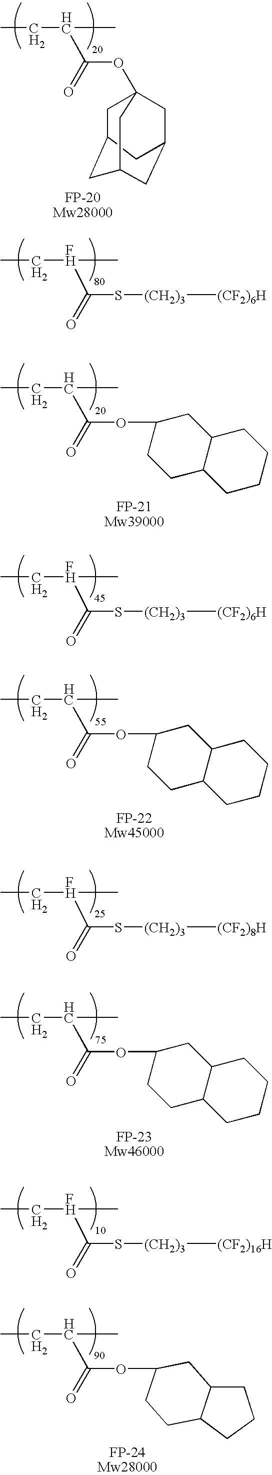

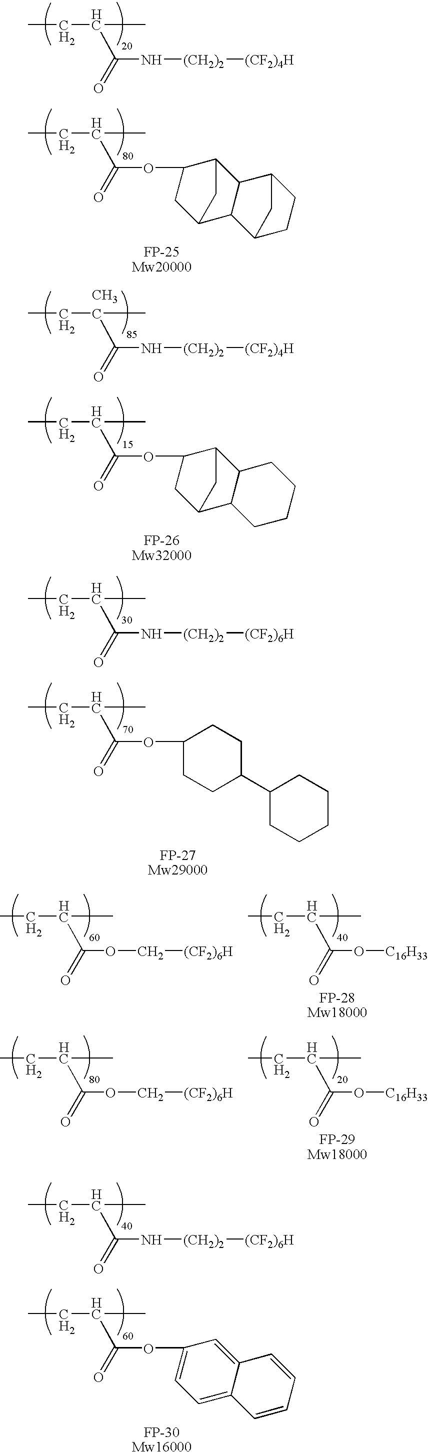

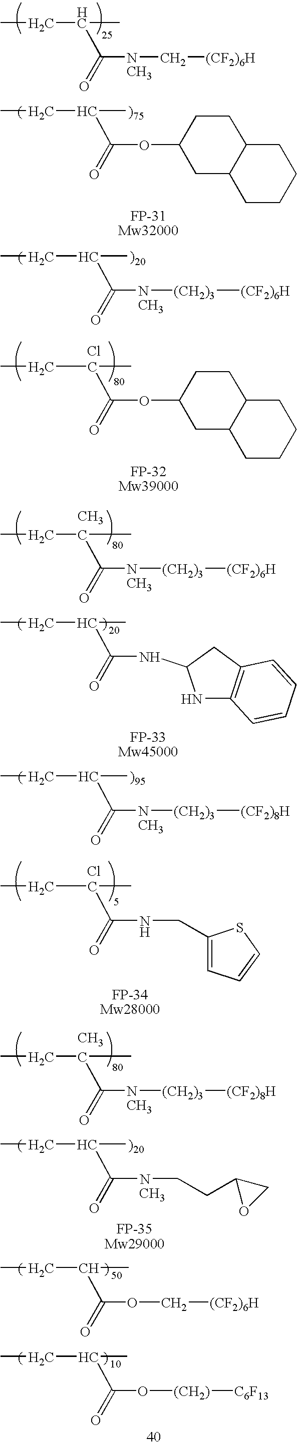

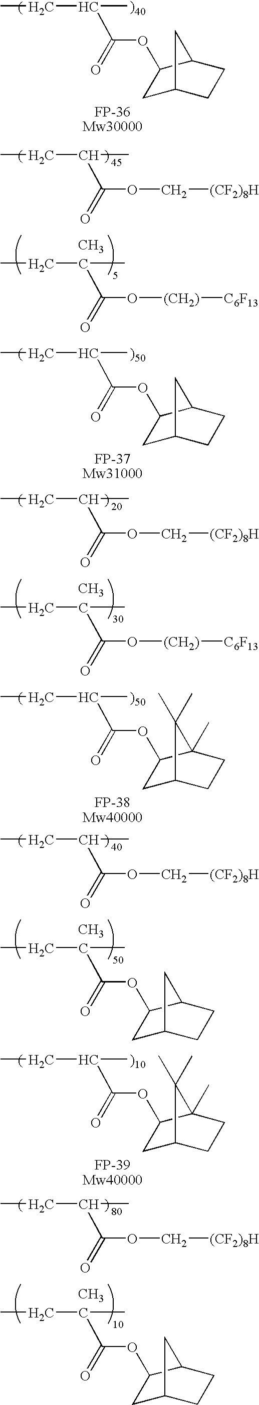

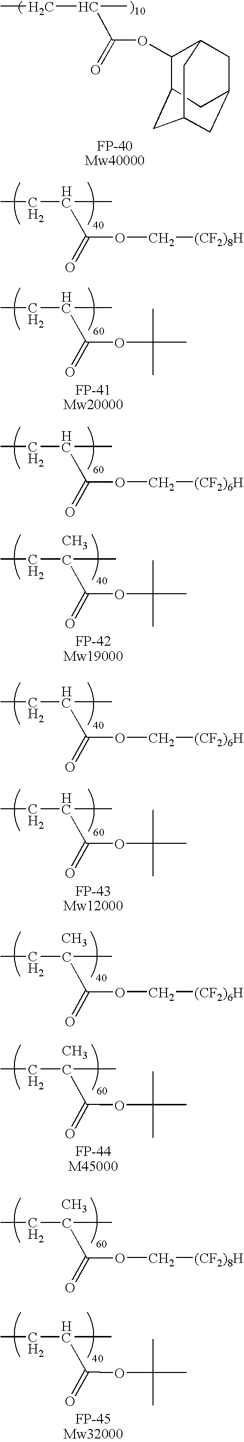

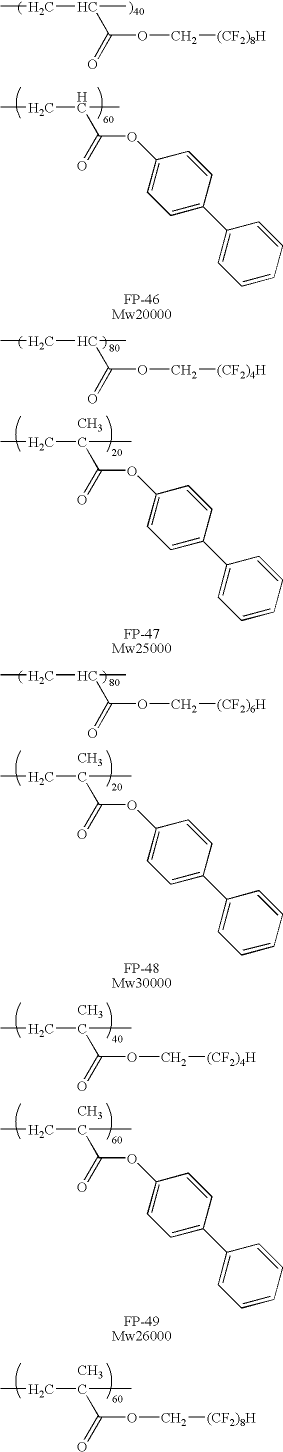

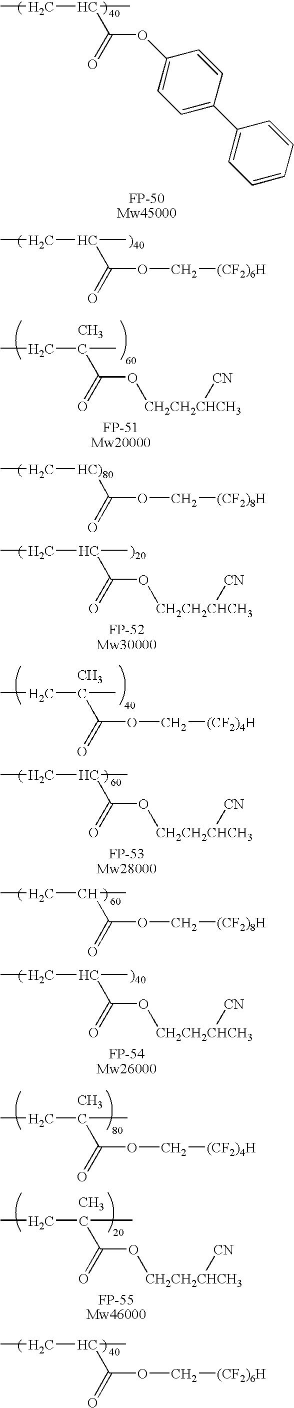

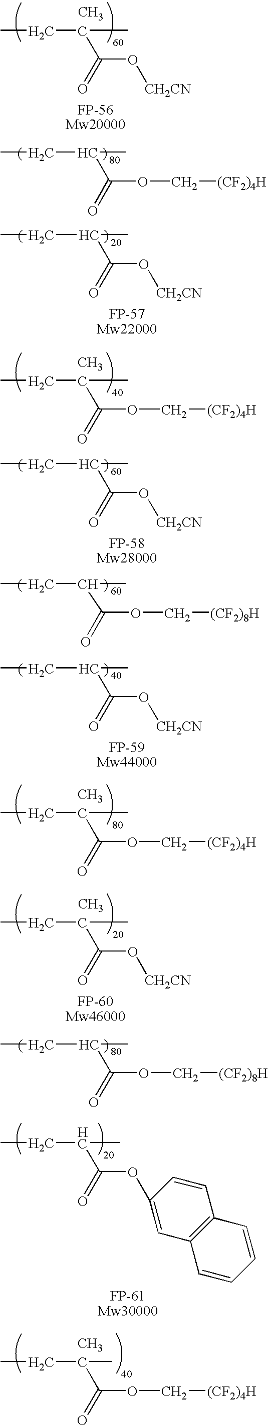

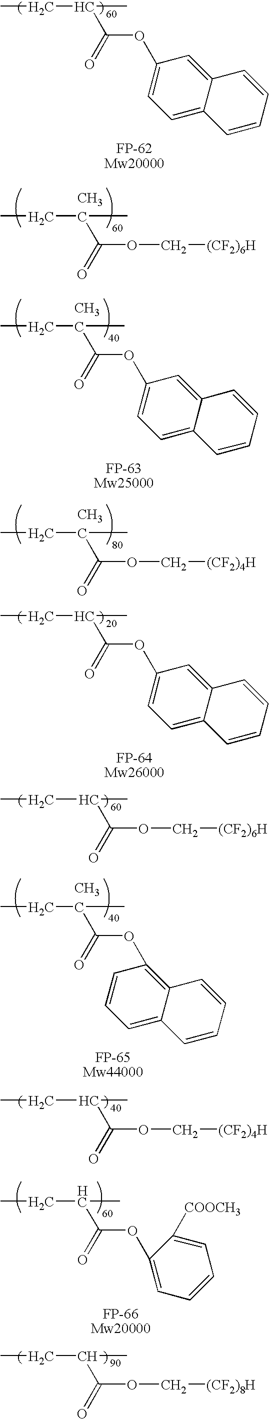

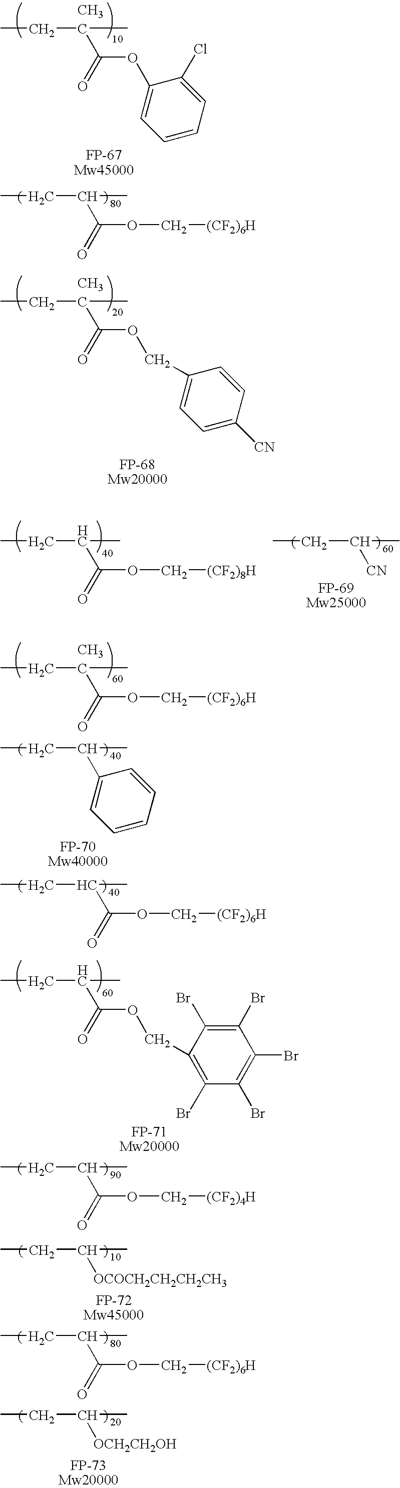

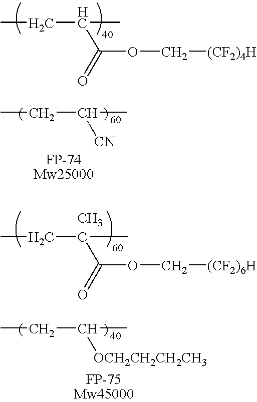

The coating composition of the invention contains at least any of the aforementioned fluorine-based surface active agents.

The amount of the aforementioned fluorine-based surface active agent to be incorporated in the coating composition is preferably from 0.001% by mass to 5.0% by mass, more preferably from 0.005% by mass to 0.5% by mass, even more preferably from 0.01% by mass to 0.2% by mass based on the total mass of the coating solution.

The coating composition preferably has a water content of 30% by mass or less, more preferably 10% by mass or less from the standpoint of improvement in surface conditions.

The coating composition of the invention may comprise necessary components such as binder, inorganic filler and dispersion stabilizer incorporated therein depending on the purpose. One or a plurality of coating compositions may be spread over a support into one or more functional layers to obtain an optical film which can be used as an anti-reflection film or polarizing plate having an anti-reflection layer. The coating composition of the invention is preferably used as hard coat layer, middle refractive layer, high refractive layer, low refractive layer or the like, more preferably hard coat layer and high refractive layer in the following anti-reflection film.

[Anti-Reflection Film]

Preferred embodiments of the anti-reflection film will be described hereinafter.

[Layer Configuration of Anti-Reflection Film]

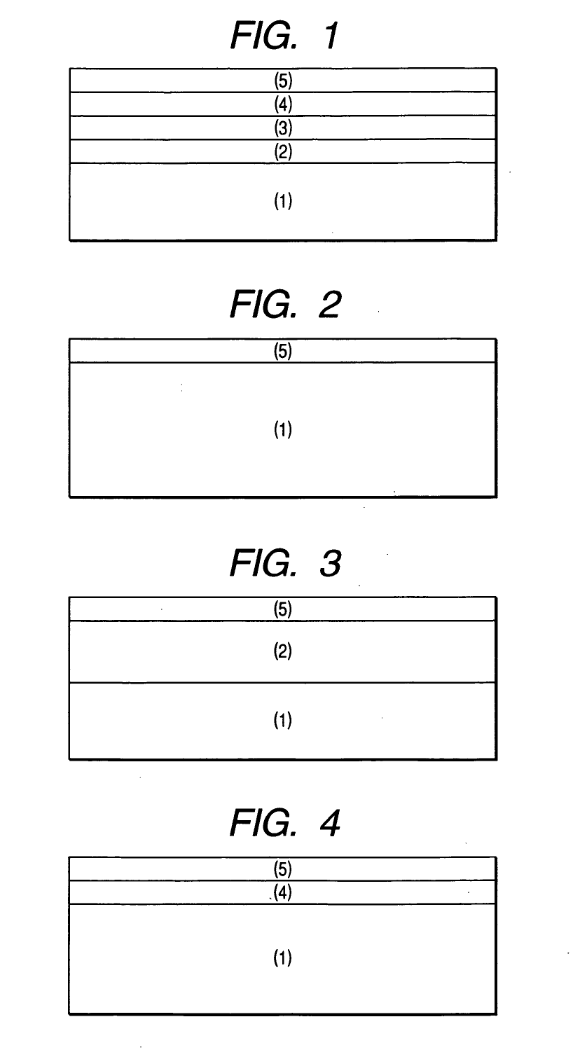

FIG. 1 is a diagrammatic sectional view illustrating an embodiment of the layer configuration of the anti-reflection film according to the invention. The anti-reflection film has a layer configuration comprising a transparent support (1), a hard coat layer (2), a middle refractive layer (3), a high refractive layer (4) and a low refractive layer (5) in this order.

As shown in FIG. 2 or 3, the low refractive layer (5) is laminated as a refractive layer on the transparent support (1) or on the hard coat layer (2) spread over the transparent support (1) to provide a desirable anti-reflection film.

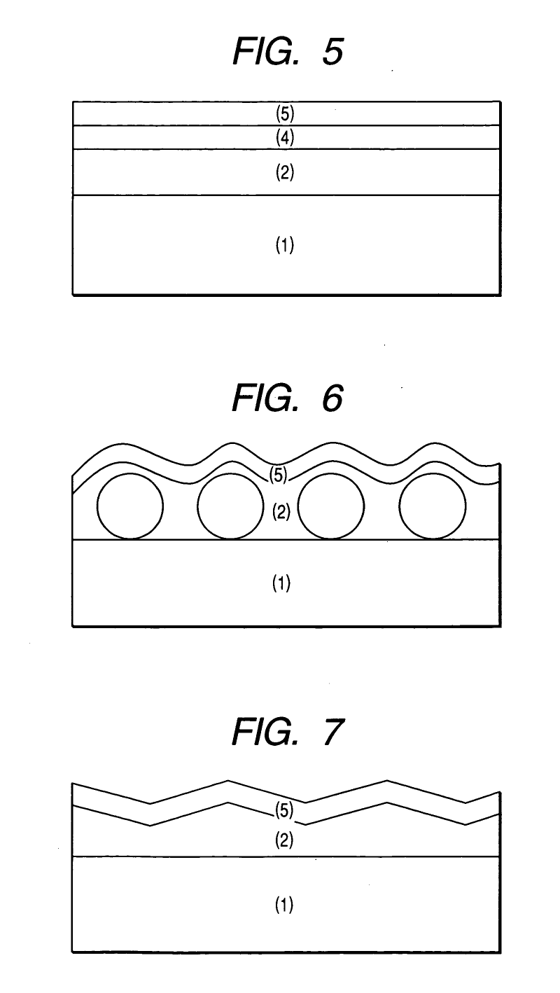

As shown in FIG. 4 or 5, the high refractive layer (4) and the low refractive layer (5) is laminated on the transparent support (1) or on the hard coat layer (2) spread over the transparent support (1) to provide a desirable anti-reflection film.

The hard coat layer (2) may have anti-glare properties. The anti-glare properties may be established by the dispersion of mat particles as shown in FIG. 6 or by the shaping of the surface involving embossing or the like as shown in FIG. 7.

[Description of the Various Layer Materials]

[Substrate Film (Support)]

As the transparent support to be used in the anti-reflection film of the invention there is preferably used a plastic film. Examples of the plastic film material employable herein include cellulose esters (e.g., triacetyl cellulose, diacetyl cellulose, propionyl cellulose, butyryl cellulose, acetylpropionyl cellulose, nitrocellulose), polyamides, polycarbonates, polyesters (e.g., polyethylene terephthalate, polyethylene naphthalate, poly-1,4-cyclohexane dimethylene terephthalate, polyethylene-1,2-diphenoxy ethane-4,4′-dicarboxylate, polybutylene terephthalate), polystyrenes (e.g., syndiotactic polystyrene), polyolefins (e.g., polypropylene, polyethylene, polymethylpentene), polysulfones, polyether sulfones, polyacrylates, polyetherimides, polymethyl methacrylate, and polyether ketones. As the material to be used in the case where the anti-reflection film of the invention is used as one of the surface protective films for polarizing plate particularly in a liquid crystal display device or organic EL display device, a triacetyl cellulose is preferably used. As the triacetyl cellulose there is used any known product such as TAC-TD80U (produced by Fuji Photo Film Co., Ltd.) or one disclosed in Kokai Giho No. 2001-1745, Japan Institute of Invention and Innovation. As the material to be used in the case where the anti-reflection film of the invention is laminated on a glass substrate or the like in a planar CRT, PDP or the like, a polyethylene terephthalate or polyethylene naphthalate is preferably used. The light transmittance of the transparent support is preferably 80% or more, more preferably 86% or more. The haze of the transparent support is 2.0% or less, more preferably 1.0% or less. The refractive index of the transparent support is preferably from 1.4 to 1.7. The thickness of the transparent support of the invention is preferably from 30 μm to 150 μm, more preferably from 40 μm to 120 μm. The thickness of the transparent support is preferably from 40 μm to 90 μm from the standpoint of reduction of the thickness of the image display device panel.

[Hard Coat Layer]

The hard coat layer of the invention will be described hereinafter.

The hard coat layer is composed of a binder for providing hard coat properties, a particulate mat for providing anti-glare properties, an inorganic filler for enhancing refractive index and strength and preventing crosslink shrinkage, an initiator for initiating reaction, an additive such as surface active agent, thixotropic agent and antistatic agent, etc.

As the binder there is preferably used a polymer having a saturated hydrocarbon chain or polyether chain, more preferably saturated hydrocarbon chain, as a main chain.

The binder polymer preferably has a crosslinked structure. As the binder polymer having a saturated hydrocarbon chain as a main chain there is preferably used a polymer of ethylenically unsaturated monomers. As the binder polymer having a saturated hydrocarbon chain as a main chain and a crosslinked structure there is preferably used a (co)polymer of monomers each having two or more ethylenically unsaturated groups.

In order to provide a higher refractive index, the structure of the monomer preferably contains an aromatic ring or at least one atom selected from the group consisting of halogen atom except fluorine, sulfur atom, phosphorus atom and nitrogen atom.

Examples of the monomer having two or more ethylenically unsaturated groups include esters of polyvalent alcohol with (meth)acrylic acid (e.g., ethylene glycol di(meth)acrylate, butanediol di(meth)acrylate, hexanediol di(meth)acrylate, 1,4-cyclohexanediacrylate, pentaerythritol tetra(meth) acrylate, pentaerythritol tri(meth)acrylate, trimethylolpropane tri(meth)acrylate, trimethylolethane tri(meth)acrylate, dipentaerythritol penta(meth)acrylate, dipentaerythritol tetra(meth)acrylate, dipentaerythritol penta(meth)acrylate, dipentaerithritol hexa(meth)acrylate, pentaerythritol hexa(meth)acrylate, 1,2,3-cyclohexane tetramethacrylate, polyurethane polyacrylate, polyester polyacrylate), vinylbenzene and derivatives thereof (e.g., 1,4-divinylbenzene, 4-vinyl benzoic acid-2-acryloylethylester, 1,4-divinyl cyclohexanone), vinylsulfones (e.g., divinylsulfone), acrylamides (e.g., methylenebisacrylamide), and methacrylamides. The aforementioned monomers may be used in combination of two or more thereof.

Specific examples of the high refractive monomer include bis(4-methacryloylthiophenyl)sulfide, vinyl naphthalene, vinyl phenyl sulfide, and 4-methacryloxy phenyl-4′-methoxyphenylthioether. These monomers, too, may be used in combination of two or more thereof.

The polymerization of the monomers having these ethylenically unsaturated groups can be effected by irradiation with ionized radiation or heating in the presence of a photo-radical polymerization initiator or heat-radical polymerization initiator.

Accordingly, an anti-reflection layer can be formed by a process which comprises preparing a coating solution containing a monomer having an ethylenically unsaturated group, a photo-polymerization initiator or heat radical polymerization initiator, a particulate mat and an inorganic filler, spreading the coating solution over the protective layer, and then irradiating the coat with ionized radiation or applying heat to the coat to cause polymerization reaction and curing.

Examples of the photoradical polymerization initiator employable herein include acetophenones, benzoins, benzophenones, phosphine oxides, ketals, anthraquinones, thioxanthones, azo compounds, peroxides, 2,3-alkyldione compounds, disulfide compounds, fluoroamine compounds, and aromatic sulfoniums. Examples of the acetophenones include 2,2-ethoxyacetophenone, p-methylacetophenone, 1-hydroxydimethylphenylketone, 1-hydroxycyclohexylpheyl ketone, 2-methyl-4-methylthio-2-morpholino propiophenone, and 2-benzyl-2-dimethylamino-1-(4-morpholinophenyl)-butanone. Examples of the benzoins include benzoinbenzenesulfonic acid ester, benzointoluenesulfonic acid ester, benzoin methyl ether, benzoin ethyl ether, and benzoin isopropyl ether. Examples of the benzophenones include benzophenone, 2,4-chlorobenzophenone, 4,4-dichlorobenzophenone, and p-chlorobenzophenone. Examples of the phosphine oxides include 2,4,6-trimethylbenzoyl diphenyl phosphine oxide.

Various examples of photoradical polymerization initiators are disclosed also in Kazuhiro Takahashi, “Saishin UV Kouka Gijutsu (Modern UV Curing Technique)”, page 159, Technical Information Institute Co., Ltd., 1991. These examples are useful in the invention.

Preferred examples of commercially available photoradical polymerization initiators include “Irgacure (651, 184, 907)” (produced by Ciba Specialty Chemicals Inc.).

The photopolymerization initiator is preferably used in an amount of from 0.1 to 15 parts by mass, more preferably from 1 to 10 parts by mass based on 100 parts by mass of polyfunctional monomers.

In addition to the photopolymerization initiator, a photosensitizer may be used. Specific examples of the photosensitizer include n-butylamine, triethylamine, tri-n-butylphosphine, Michler's ketone, and thioxanthone.

Examples of the heat radical polymerization initiator employable herein include organic or inorganic peroxides, organic azo compounds, and diazo compounds.

Specific examples of the organic peroxides include benzoyl peroxide, halogen benzoyl peroxide, lauroyl peroxide, acetyl peroxide, dibutyl peroxide, cumene hydroperoxide, and butyl hydroperoxide. Specific examples of the inorganic peroxides include hydrogen peroxide, ammonium persulfate, and potassium persulfate. Specific examples of the azo compounds include 2-azo-bis-isobutylonitrile, 2-azo-bis-propionitrile, and 2-azo-bis-cyclohexanedinitrile. Specific examples of the diazo compounds include diazoaminobenzene, and p-nitrobenzene diazonium.

The polymer having a polyether as a main chain is preferably a ring-opening polymerization product of polyfunctional epoxy compound. The ring-opening polymerization of polyfunctional epoxy compound can be carried out by irradiation with ionizing radiation or heating in the presence of a photo-acid generator or heat-acid generator.

Accordingly, the anti-reflection film can be formed by preparing a coating solution containing a polyfunctional epoxy compound, a photo-acid generator, a heat-acid generator, a particulate mat and an inorganic filler, spreading the coating solution over a transparent support, and then subjecting the coat to polymerization reaction by irradiation with ionizing radiation or heating so that it is cured.

Instead of or in addition to the monomers having two or more ethylenically unsaturated groups, monomers having crosslinkable functional groups may be used to introduce crosslinkable functional groups into a polymer. The reaction of these crosslinkable functional groups makes it possible to introduce a crosslinked structure into the binder polymer.

Examples of the crosslinkable functional groups include isocyanato groups, epoxy groups, aziridine groups, oxazoline groups, aldehyde groups, carbonyl groups, hydrazine groups, carboxyl groups, methylol groups, and active methylene groups. Further, vinylsulfonic acid, acid anhydride, cyanoacrylate derivative, melamine, etherified methylol, ester, urethane and metal alkoxide such as tetramethoxysilane may be used as a monomer by which a crosslinked structure is introduced. A functional group which exhibits crosslinkability as a result of decomposition reaction such as blocked isocyanate group may be used. In other words, the crosslinkable functional group to be used in the invention may be not immediately reactive but may be reactive as a result of decomposition reaction.

These binder polymers having a crosslinkable functional group may form a crosslinked structure when heated after being spread.

For the purpose of providing anti-glare properties, the anti-glare hard coat layer comprises a particulate mat having a greater size than the particulate filler and an average particle diameter of from 1 μm to 15 μm, preferably from 1.5 μm to 10 μm such as inorganic particulate compound and inorganic resin.

Specific examples of the aforementioned particulate mat include inorganic particulate compounds such as particulate silica and particulate TiO₂, and inorganic particulate resins such as particulate acryl, particulate crosslinked acryl, particulate crosslinked styrene, particulate melamine resin and particulate benzoguanamine resin. Preferred among these particulate mat materials are particulate crosslinked styrene, particulate crosslinked acryl, and particulate silica.

Two or more particulate mats having different particle diameters may be used in combination. A particulate mat material having a greater particle diameter may be used to provide anti-glare properties while a particulate mat material having a smaller particle diameter may be used to provide other optical properties. For example, in the case where the anti-reflection film is stuck to a display having a precision of 133 ppi or more, it is required that there occur no glittering, which is one of defects in optical properties. Glittering is attributed to the presence of roughness (contributing to anti-glare properties) on the surface of the film that causes the expansion or shrinkage of pixels leading to the loss of uniformity in brightness. Glittering can be drastically eliminated by the additional use of particulate mat having a smaller particle diameter by 5 to 50% than that of the particulate mat that provides anti-glare properties and a refractive index different from that of the binder.

Further, the distribution of particle diameter of the aforementioned particulate mat is most preferably monodisperse. The particle diameter of all the particles are preferably as close to each other as possible. For example, in the case where the particle having a particle diameter which is 20% or more of the average particle diameter greater is defined as coarse particle, the proportion of the coarse particles is preferably 1% or less, more preferably 0.1% or less, more preferably 0.01% or less based on the total number of particles. A particulate mat having such a particle diameter distribution can be obtained by classifying particles produced by an ordinary synthesis reaction. By increasing the number of times of classification or raising the degree of classification, a better distribution can be obtained.

The hard coat layer preferably comprises an inorganic filler composed of oxide of at least one of metals such as titanium, zirconium, aluminum, indium, zinc, tin and antimony having an average particle diameter of from 0.5 nm to 0.2 μm, preferably from 1 nm to 0.1 μm, even more preferably from 1 nm to 0.06 μm incorporated therein in addition to the aforementioned particulate mat to enhance the refractive index thereof.

On the contrary, in order to increase the difference in refractive index from the particulate mat, the hard coat layer comprising a high refractive particulate mat incorporated therein preferably comprises a silicon oxide incorporated therein for keeping the refractive index thereof low. The preferred particle diameter of the silicon oxide is the same as that of the aforementioned inorganic filler.

Specific examples of the inorganic filler to be incorporated in the hard coat layer include TiO₂, ZrO₂, Al₂O₃, In₂O₃, ZnO, SnO₂, Sb₂O₃, ITO (indium-tin oxide), and SiO₂. Particularly preferred among these inorganic fillers are TiO₂ and ZrO₂ from the standpoint of enhancement of refractive index.

These inorganic fillers are preferably subjected to silane coupling treatment or titanium coupling treatment on the surface thereof. A surface treatment having a functional group reactive with a binder seed on the surface of filler is preferably used.

The added amount of these inorganic fillers is preferably from 10% to 90%, more preferably from 20% to 80%, particularly from 30% to 75% based on the total weight of the hard coat layer.

The inorganic filler has a sufficiently smaller particle diameter than the wavelength of light and thus is not scattered. Thus, a dispersion of the filler in a binder polymer behaves as an optically uniform material.

The hard coat layer of the invention may comprise additives such as surface active agent, thixotropic agent and antistatic agent incorporated therein depending on the function thereof. The hard coat layer preferably comprises the fluorine-based surface active agent of the invention incorporated therein.

The total refractive index of the mixture of the binder and the inorganic filler of the hard coat layer of the invention is preferably from 1.4 to 2.00, more preferably from 1.45 to 1.80. In order to predetermine the refractive index within the above defined range, the kind and proportion of the binder and the inorganic filler may be properly predetermined. The method of selecting these factors can easily be previously known experimentally.

The thickness of the hard coat layer is preferably from 1 μm to 30 μm, more preferably from 2 μm to 18 μm.

[High Refractive Layer]

The high refractive layer of the invention is typically composed of a cured layer having a refractive index of from 1.55 to 2.40 obtained by spreading a curable composition (high refractive layer composition) containing at least an inorganic particulate compound having a high refractive index and a matrix binder (hereinafter occasionally referred to as “matrix”) and curing the coat. Further, the high refractive layer preferably contains a fluorine-based surface active agent of the invention. The refractive index of the high refractive layer is preferably from 1.65 to 2.30, particularly from 1.80 to 2.00. The high refractive layer of the invention is a so-called high refractive or middle refractive layer having a refractive index of from 1.55 to 2.40. These layers will be hereinafter occasionally referred generically to as “high refractive layer”.

[High Refractive Layer Composition]

<High Refractive Material Particles>

The inorganic particulate material having a high refractive index to be incorporated in the high refractive layer of the invention preferably has a refractive index of from 1.80 to 2.80 and a primary particle average diameter of from 3 nm to 150 nm. When the refractive index of the inorganic particulate material falls within the above defined range, the resulting effect of enhancing the refractive index of the layer is sufficient and the particles are not colored. Further, when the average diameter of primary particles falls within the above defined range, the resulting high refractive layer exhibits a low haze, a high transparency and a high refractive index. In the invention, the inorganic particulate material more preferably exhibits a refractive index of from 1.90 to 2.80 and a primary particle average diameter of from 3 nm to 100 nm, even more preferably a refractive index of from 1.90 to 2.80 and a primary particle average diameter of from 5 nm to 80 nm.

Specific preferred examples of the inorganic particulate material having a high refractive index include particles mainly composed of oxide, composite oxide or sulfide of Ti, Zr, Ta, In, Nd, Sn, Sb, Zn, LaW, Ce, Nb, V, Sm and Y. The term “be mainly composed” as used herein is meant to indicate the component which is incorporated in the highest content (% by mass) among the components constituting the particle. Preferred in the invention is a particle mainly composed of oxide or composite oxide of at least one metallic element selected from the group consisting of Ti, Zr, Ta, In and Sn. The inorganic particulate material to be used in the invention may comprise various elements incorporated therein. Examples of these elements employable herein include Li, Si, Al, B, Ba, Co, Fe, Hg, Ag, Pt, Au, Cr, Bi, P, and S. Particulate tin oxide and indium oxide each preferably contain elements such as Sb, Nb, P, B, In, V and halogen to enhance the conductivity thereof. In particular, those containing antimony oxide in an amount of from about 5 to 20% by mass are most desirable.

Particularly preferred examples of the inorganic particulate material include an inorganic particulate material mainly composed of titanium dioxide containing at least one element selected from the group consisting of Co, Zr and Al (hereinafter occasionally referred to as “specific oxide”). Particularly preferred among these elements is Co. The total content of Co, Al and Zr based on Ti is preferably from 0.05% to 30% by mass, more preferably from 0.1% to 10% by mass, even more preferably from 0.2% to 7% by mass, particularly from 0.3% to 5% by mass, most preferably from 0.5% to 3% by mass.

Co, Zl and Zr are present in the interior and/or the surface of the inorganic particulate material mainly composed of titanium dioxide, preferably in the interior of the inorganic particulate material mainly composed of titanium dioxide, most preferably in both the interior and surface of the inorganic particulate material mainly composed of titanium dioxide. These specific elements may be present in the form of oxide.

Other preferred examples of the inorganic particulate material include a particulate composite oxide of titanium element with at least one metallic element (hereinafter occasionally abbreviated as “Met”) selected from the group consisting of metallic elements the oxide of which has a refractive index of 1.95 or more wherein the composite oxide is doped with at least one metallic ion selected from the group consisting of Co ion, Zr ion and Al ion (hereinafter occasionally referred to as “specific composite oxide”). Preferred examples of the metallic element the oxide of which exhibits a refractive index of 1.95 or more include Ta, Zr, In, Nd, Sb, Sn, and Bi. Particularly preferred among these metallic elements are Ta, Zr, Sn, and Bi. The content of the metallic ions with which the composite oxide is doped is preferably not more than 25% by mass, more preferably from 0.05% to 10% by mass, even more preferably from 0.1% to 5% by mass, most preferably from 0.3% to 3% by mass based on the total amount of metals [Ti+Met] constituting the composite oxide from the standpoint of maintenance of refractive index.

The metallic ions which have been doped in the inorganic particulate material may be present in the form of either metallic ion or metallic atom. The doping metallic ions are properly present in the region ranging from the surface to the interior of the composite oxide, preferably in both the surface and interior of the composite oxide.

The inorganic particulate material to be used in the invention preferably has a crystal structure or an amorphous structure. Referring to the crystal structure of the inorganic particulate material, the inorganic particulate material is mainly composed of rutile structure, rutile/anatase mixed crystal or anatase, particularly rutile structure. In this arrangement, the inorganic particulate material of specific oxide or specific composite oxide of the invention exhibits a refractive index of from 1.90 to 2.80, preferably from 2.10 to 2.80, more preferably from 2.20 to 2.80. Further, the photocatalytic activity of titanium dioxide can be suppressed, making it possible to remarkably improve the weathering resistance of the high refractive layer of the invention.

The doping with the aforementioned specified metal elements or metal ions can be accomplished by any known methods. For example, doping can be carried out by the method disclosed in JP-A-5-330825, JP-A-11-263620, JP-T-11-512336 (the term “JP-T” as used herein means a published Japanese translation of a PCT patent application), European Patent Disclosure No. 0335773, etc., or ion implantation method as described in Shunichi Gonda, Junzo Ishikawa, Eiji Kamijo, “Ion Beam Application Technique”, CMC, 1989, Yasu Aoki, “Surface Science”, vol. 18 (5), page 262, 1998, and Shoichi Anpo et al, “Surface Science”, vol. 20 (2), page 60, 1999.

The inorganic particulate material to be used in the invention may be subjected to surface treatment. For the surface treatment, an inorganic compound and/or an organic compound is used to modify the surface of the inorganic particulate material so that the wettability of the surface of the inorganic particulate material is properly adjusted to enhance the fine division of particles in an organic solvent and the dispersibility or dispersion stability of the inorganic particulate material in the high refractive layer-forming composition. Examples of the inorganic compound which can be physicochemically adsorbed to the surface of the particles to modify the surface of the particles include inorganic compounds containing silicon (e.g., SiO₂), inorganic compounds containing aluminum (e.g., Al₂O₃, Al(OH)₃), inorganic compounds containing cobalt (e.g., CoO₂, Co₂O₃, Co₃O₄), inorganic compounds containing zirconium (e.g., ZrO₂, Zr(OH)₄), and inorganic compounds containing iron (e.g., Fe₂O₃).

As the organic compounds to be used in the surface treatment there may be used any known surface modifiers for inorganic filler such as metal oxide and inorganic pigment. For the details of these surface modifiers, reference can be made to “Ganryo Bunsan Anteika to Hyoumen Shori Gijutsu/Hyouka (Technique for Stabilization of Pigment Dispersion and Surface Treatment/Evaluation)”, Chapter 1, Technical Information Institute Co., Ltd., 2001.

Specific examples of these surface modifiers include organic compounds comprising a polar group having an affinity for the surface of the inorganic particulate material. These organic compounds include a compound called coupling compound. Examples of the polar group having an affinity for the surface of the inorganic particulate material include carboxyl group, phosphono group, hydroxyl group, mercapto group, cyclic acid anhydride group, and amino group. An organic compound having at least one such a polar group is preferred. Examples of the organic compound include long-chain aliphatic carboxylic acids (e.g., stearic acid, lauric acid, oleic acid, linoleic acid, linolenic acid), polyol compounds (e.g., pentaerythritol triacrylate, dipentaerythritol pentaacrylate, ECD(epichlorohydrin)-modified glycerol triacrylate), phosphono group-containing compounds (e.g., EO(ethylene oxide)-modified phosphoric acid triacrylate), and alkanolamines (e.g., EO adduct (5 mols) of ethylenediamine).

As the coupling compound there may be used any known organic metal compound. Examples of such an organic metal compound include silane coupling agents, titanate coupling agents, and aluminate coupling agents. Most desirable among these organic metal compounds are silane coupling agents. Specific examples of these coupling compounds include those disclosed in JP-A-2002-9908 and JP-A-2001-310423 (paragraphs [0011] to [0015]).

These compounds to be used in the surface treatment may be used in combination of two or more thereof.

As the particulate oxide to be used in the invention there is preferably used a core/shell particle comprising a shell made of other inorganic compound formed on the particulate oxide as core. The shell is preferably made of an oxide of at least one element selected from the group consisting of aluminum, silicon and zirconium. For details, reference can be made to JP-A-2001-166104.

The shape of the aforementioned inorganic particulate material is not specifically limited but is preferably grain, sphere, cube, spindle or amorphous. The aforementioned inorganic particulate material may be used singly. However, two or more inorganic particulate materials may be used in combination.

(Dispersant)

In order to use the inorganic particulate material to be used in the invention as a stabilized predetermined ultrafine particulate material, a dispersant is preferably used. As such a dispersant there is preferably used a low molecular compound comprising a polar group having an affinity for the surface of the high refractive particulate material or a polymer compound.

Examples of the aforementioned polar group include hydroxyl groups, mercapto groups, carboxyl groups, sulfo groups, phosphono groups, oxyphosphono groups, —P(═O)(R^{1b})(OH) groups, —O—P(═O)(R^{1b})(OH) groups, amide groups (—CONHR^{2b}, —SO₂NHR^{2b}), cyclic acid anhydride-containing groups, amino groups, and quaternary ammonium groups.

In the aforementioned general formulae, R^{1b} represents a C₁-C₁₈ hydrocarbon group (e.g., methyl group, ethyl group, propyl group, butyl group, hexyl group, octyl group, decyl group, dodecyl group, octadecyl group, chloroethyl group, methoxyethyl group, cyanoethyl group, benzyl group, methyl benzyl group, phenethyl group, cyclohexyl group). R^{2b} indicates a hydrogen atom or has the same meaning as R^{1b}.

In the aforementioned polar group, the group having a dissociable proton may be in the form of salt thereof. The aforementioned amino group and quaternary ammonium group may be any of primary amino group, secondary amino group and tertiary amino group, preferably tertiary amino group or quaternary ammonium group. The group connected to the nitrogen atom in the secondary amino group, tertiary amino group or quaternary ammonium group is preferably a C₁-C₁₂ aliphatic group (including those listed above with reference to R^{1b}). The tertiary amino group may be a cyclic amino group containing nitrogen atom (e.g., piperidine ring, morpholine ring, piperadine ring, pyridine ring). Further, the quaternary ammonium group may be a quaternary ammonium of cyclic amino group. The group connected to the nitrogen atom in the secondary amino group, tertiary amino group or quaternary ammonium group is more preferably a C₁-C₆ alkyl group.

As the polar group in the aforementioned dispersant there is preferably used an anionic group having pKa of 7 or less or salt of such a dissociable group. Particularly preferred examples of these polar groups include carboxyl groups, sulfo groups, phosphono groups, oxyphosphono groups, and salt of these dissociable groups.

The dispersant preferably further contains a crosslinkable or polymerizable functional group. Examples of the crosslinkable or polymerizable functional group include ethylenically unsaturated groups which can undergo addition reaction/polymerization reaction with radical seeds [e.g., (meth) acryloyl group, allyl group, styryl group, vinyloxy group, carbonyl group, vinyloxy group], cationic polymerizable groups (e.g., epoxy group, thioepoxy group, oxetanyl group, vinyloxy group, spiroorthoester group), and polycondesation reactive groups (hydrolyzable silyl group such as N-methylol group). Preferred among these crosslinkable or polymerizable functional groups are ethylenically unsaturated groups, epoxy groups, and hydrolyzable silyl groups. Specific examples of these compounds include those disclosed in JP-A-11-153703, U.S. Pat. No. 6,210,858B1, JP-A-2002-2776069, JP-A-2001-310423, paragraphs [0013] to [0015].

The dispersant to be used in the invention is preferably also a polymer dispersant. In particular, a polymer dispersant containing an anionic group and a crosslinkable or polymerizable functional group is desirable. Examples of the polymer dispersant include those having the same functional groups as mentioned above.

The amount of the dispersant to be used is preferably from 1% to 100% by mass, more preferably from 3% to 50% by mass, most preferably from 5% to 40% by mass based on the inorganic particulate material. Two or more dispersants may be used in combination.

(Dispersion Medium)

In the invention, as the dispersion medium to be used in wet dispersion of the inorganic particulate material there may be properly selected from the group consisting of water and organic solvents. A liquid having a boiling point of 50° C. or more is desirable. An organic solvent having a boiling point of from 60° C. to 180° C. is more desirable. The dispersion medium is preferably used in a proportion such that the amount of all the components constituting the high refractive layer containing an inorganic particulate material and a dispersant is from 5 to 50% by mass, more preferably from 10 to 30% by mass. When the proportion of the dispersion medium falls within the above defined range, dispersion can easily proceed. The resulting dispersion exhibits a viscosity such that a good workability can be obtained to advantage.

Examples of the dispersion medium employable herein include alcohols, ketones, esters, amides, ethers, ether esters, hydrocarbons, and halogenated hydrocarbons. Specific examples of these dispersion media include alcohols such as methanol, ethanol, propanol, butanol, benzyl alcohol, ethylene glycol, propylene glycol and ethylene glycol monoacetate, ketones such as methyl ethyl ketone, methyl isobutyl ketone, cyclohexanone and methyl cyclohexanone, esters such as methyl acetate, ethyl acetate, propyl acetate, butyl acetate, ethyl formate, propyl formate, butyl formate and ethyl lactate, aliphatic hydrocarbons such as hexane and cyclohexane, halogenated hydrocarbons such as methyl chloroform, aromatic hydrocarbons such as benzene, toluene and xylene, amides such as dimethyl formamide, dimethyl acetamide and n-methylpyrrolidone, ethers such as dioxane, tetrahydrofurane, ethylene glycol dimethyl ether and propylene glycol dimethyl ether, and ether alcohols such as 1-methoxy-2-propanol, ethyl cellosolve and methyl carbitol. These dispersion media may be used singly or in combination of two or more thereof. Preferred among these dispersion media are toluene, xylene, methyl ethyl ketone, methyl isobutyl ketone, cyclohexanone and butanol. Further, coating solvents mainly composed of ketone-based solvents (e.g., methyl ethyl ketone, methyl isobutyl ketone, cyclohexanone) are preferably used.

(Ultrafine Division of Inorganic Particulate Material)

When the curable coating composition for forming the high refractive layer of the invention is a composition having inorganic ultrafine particles having an average primary particle diameter of 100 nm or less dispersed therein, the liquid stability of the composition can be enhanced. The cure layer formed by the curable coating composition comprises an inorganic particulate material finely and uniformly dispersed in the matrix of cured layer to form a transparent high refractive layer having uniform optical properties. The size of the ultrafine particles present in the matrix of cured layer is such that the average primary particle diameter is preferably from 3 to 100 nm, more preferably from 5 to 100 nm, most preferably from 10 to 80 nm.

It is more desirable that coarse particles having a primary particle diameter of 500 nm or more be not included. It is particularly desirable that coarse particles having a particle diameter of 300 nm or more be not included. In this arrangement, the surface of the cured layer can be provided with the aforementioned specified unevenness.

The dispersion of the aforementioned high refractive particulate material to an extent such that it is ultrafinely divided into a size excluding the coarse particle range can be attained by subjecting the high refractive particulate material to wet dispersion using a medium having an average particle diameter of less than 0.8 mm with the aforementioned dispersant.

Examples of the wet dispersing machine employable herein include known wet dispersing machines such as sand grinder mill (e.g., bead mill with pin), dinomill, high speed impellor mill, pebble mill, roller mill, attritor and colloid mill. In order to disperse the high refractive particulate material to be used herein to ultrafine particles, sand grinder mill, dinomill and high speed impellor mill are particularly preferred.

The medium to be used with the aforementioned dispersing machine preferably has an average particle diameter of less than 0.8 mm. The use of a medium having an average particle diameter falling within the above defined range makes it possible to keep the particle diameter of the aforementioned high refractive particulate material 100 nm or less and obtain ultrafinely divided particles having a uniform particle diameter. The average particle diameter of the medium is more preferably 0.5 mm or less, even more preferably from 0.05 to 0.3 mm.

As the medium to be used in wet dispersion there is preferably used bead. Specific examples of the bead employable herein include zirconia bead, glass bead, ceramic bead, and steel bead. Zirconia bead having a size of from 0.05 to 0.2 mm is particularly preferred from the standpoint of durability against destruction of bead during dispersion and ease of ultrafine division. The dispersion temperature at the dispersion step is preferably from 20° C. to 60° C., more preferably from 25° C. to 45° C. When the inorganic particulate material is ultrafinely dispersed at a temperature falling within the above defined range, the dispersed particles can be prevented from undergoing reagglomeration and precipitation. This is presumably because the dispersant is properly adsorbed to the inorganic particulate compound, making it possible to prevent the occurrence of defective in dispersion stability due to desorption of the inorganic particulate compound from the particulate dispersant at ordinary temperature.

When the dispersion step is effected at a temperature falling within the above defined range, a high refractive layer excellent in uniformity in refractive index causing no loss of clarity, strength, adhesion to adjacent layers, etc. can be formed.

The aforementioned wet dispersion step may be preceded by a predispersion step. Examples of the dispersing machine to be used in the predispersion step include ball mill, three-roll mill, kneader, and extruder.

Further, in order to remove coarse agglomerates from the dispersion thus obtained so that the particles dispersed in the dispersion can satisfy the aforementioned requirements for average particle diameter and monodispersibility of particle diameters, it is preferred that a filtering material be provided to precision-filter the beads off. The filtering material for precision filtration preferably comprises filtering particles having a size of 25 μm or less. The type of the filtering material for precision filtration is not specifically limited so far as it has the aforementioned properties. However, filament type, felt type and mesh type filtering materials may be used.

The material constituting the filtering material for precision-filtering the dispersion is not specifically limited so far as it has the aforementioned properties and exerts no adverse effects on the coating solution. For example, however, stainless steel, polyethylene, polypropylene, nylon, etc. may be used.

(Matrix of High Refractive Layer)

The high refractive layer comprises a high refractive ultraparticulate material and a matrix incorporated therein.

In a preferred embodiment, the matrix of the high refractive layer is formed by spreading a high refractive layer-forming composition containing at least one of:

(i) an organic binder; and (ii) an organic metal compound containing a hydrolyzable functional group and a partial condensate thereof, and then curing the coat layer.

(i) Organic Binder

As the organic binder there may be used a binder formed by (a) a known thermoplastic resin, (b) a combination of known reactive curable resin and curing agent or (c) a combination of a binder precursor (e.g., curable polyfunctional monomer or polyfunctional oligomer described later) and a polymerization initiator.

It is preferred that the binder-forming component (a), (b) or (c) and the dispersion containing a high refractive particulate composite oxide and a dispersant be used to prepare the high refractive layer-forming coating composition. The coating composition thus prepared is spread over a transparent support to form a coat layer which is then cured by a method according to the binder-forming components to form a high refractive layer. The curing method is properly selected depending on the kind of the binder components. For example, a method which comprises subjecting a curable compound (e.g., polyfunctional monomer or polyfunctional oligomer) to at least one of heating and irradiation with light rays to cause crosslinking reaction or polymerization reaction thereof may be used. In particular, a method is preferred which comprises irradiating a curable compound comprising an organic binder (c) with light rays to cause the crosslinking reaction or polymerization reaction of the curable compound to form a cured binder.

Further, it is preferred that the dispersant contained in the dispersion of high refractive particulate composite oxide be allowed to undergo crosslinking reaction or polymerization reaction at the same time with or after the spreading of the high refractive layer-forming coating composition.

The binder in the cured layer thus prepared comprises anionic groups of the aforementioned binder incorporated therein as a result of the crosslinking reaction or polymerization reaction of the dispersant with the curable polyfunctional monomer or oligomer which is a binder precursor. Further, since the anionic groups of the binder in the cured layer are capable of keeping the high refractive particulate material well dispersed in the binder, the crosslinked or polymerized structure renders the binder capable of forming a film, making it possible to enhance the physical strength, chemical resistance and weathering resistance of the cured layer containing a high refractive particulate material.

Examples of the aforementioned thermoplastic resin include polystyrene resins, polyester resins, cellulose resins, polyether resins, vinyl chloride resins, vinyl acetate resins, vinyl chloride-vinyl oxide copolymer resins, polyacrylic resins, polymethacrylic resins, polyolefin resins, urethane resins, silicone resins, and imide resins.

Further, the aforementioned reactive curable resin, i.e., at least any of thermosetting resin and ionizing radiation-curable resin is preferably used. Examples of the thermosetting resin employable herein include phenolic resins, urea resins, diallyl phthalate resins, melamine resins, guanamine resins, unsaturated polyester resins, polyurethane resins, epoxy resins, amino alkyd resins, melamine-urea cocondensate resins, silicon resins, and polysiloxane resins. Examples of the ionized radiation-curable resin employable herein include resins containing functional groups such as radical-polymerizable unsaturated group {e.g., (meth) acryloyloxy group, vinyloxy group, styryl group, vinyl group} and/or cation-polymerizable group (e.g., epoxy group, thioepoxy group, vinyloxy group, oxetanyl group). Examples of these resins include polyester resins, polyether resins, (meth)acryl resins, epoxy resins, urethane resins, alkyd resins, spiroacetal resins, polybutadiene resins and polythiolpolyene resins having a relatively low molecular weight.

These reactive curable resins are used optionally in combination with a curing agent such as crosslinking agent (e.g., epoxy compound, polyisocyanate compound, polyol compound, polyamine compound, melamine compound), polymerization initiator (e.g., ultraviolet photopolymerization initiator such as azobis compound, organic peroxide compound, organic halogen compound, onium salt compound and ketone compound) and a known compound such as polymerization accelerator (e.g., organic metal compound, acid compound, basic compound). For the details of these compounds, reference can be made to Shinzo Yamashita and Tosuke Kaneko, “Kakyouzai Handobukku (Handbook of Crosslinking Agents)”, Taiseisha, 1981.

As a desirable method of forming a cured binder there will be mainly described hereinafter a method which comprises subjecting a curable compound comprising the aforementioned combination (c) to crosslinking or polymerization reaction by irradiation with light rays to form a cured binder.

The functional group in the photosetting polyfunctional monomer or polyfunctional oligomer which is a binder precursor may be ether radical-polymerizable or cation-polymerizable.

Examples of the radical-polymerizable functional group include ethylenically unsaturated groups such as (meth)acryloyl group, vinyloxy group, styryl group and allyl group. Preferred among these radical-polymerizable functional groups is (meth)acryloyl group.

There is preferably included a polyfunctional monomer containing two or more radical-polymerizable groups per molecule.

The radical-polymerizable polyfunctional monomer is preferably selected from the group consisting of compounds having at least two terminal ethylenically unsaturated bonds. The radical-polymerizable polyfunctional monomer is preferably a compound having from 2 to 6 terminal ethylenically unsaturated bonds per molecule. Such a group of compounds are well known in the art of polymer materials. In the invention, these compounds may be used without any limitation. These compounds may have a chemical morphology such as monomer, prepolymer (i.e., dimer, trimer, oligomer), mixture thereof and copolymer thereof.

Examples of the radical-polymerizable monomers include unsaturated carboxylic acids (e.g., acrylic acid, methacrylic acid, itaconic acid, crotonic acid, isocrotonic acid, maleic acid), and esters and amides thereof. Preferred examples of the radical-polymerizable monomers include esters of unsaturated carboxylic acids with aliphatic polyvalent alcohol compounds, and amides of unsaturated carboxylic acids with aliphatic polyvalent amine compounds. Further, adducts of unsaturated carboxylic acid esters or amides having a nucleophilic substituent such as hydroxyl group, amino group and mercapto group with monofunctional or polyfunctional isocyanates or epoxies, dehydration condensation reaction products of these unsaturated carboxylic acid esters or amides with polyfunctional carboxylic acids, etc. are preferably used. Moreover, reaction products of unsaturated polyester carboxylic acid esters or amides having an electrophilic substituent such as isocyanate group and epoxy group with monofunctional or polyfunctional alcohols, amines or thiols are preferably used. By way of another example, compounds obtained in the same manner as mentioned above except that the aforementioned unsaturated carboxylic acids are replaced by unsaturated phosphonic acids, styrenes or the like may be used.

Examples of the aliphatic polyvalent alcohol compounds employable herein include alkane diol, alkane triol, cyclohexane diol, cyclohexane triol, inositol, cyclohexane dimethanol, pentaerythritol, glycerin, and diglycerin. Examples of polymerizable ester compounds (monoester or polyester) of these aliphatic polyvalent alcohols with unsaturated carboxylic acids include compounds as disclosed in JP-A-2001-139663, paragraphs [0026]-[0027].

Other preferred examples of polymerizable esters include vinyl methacrylates, allyl methacrylates, allyl acrylates, aliphatic alcohol-based esters as disclosed in JP-B-46-27926, JP-B-51-47334 and JP-A-57-196231, those having an aromatic skeleton as disclosed in JP-A-2-226149, and those having an amino group as disclosed in JP-A-1-165613.

Specific examples of polymerizable amides formed by aliphatic polyvalent amine compound and unsaturated carboxylic acid include methylene bis(meth)acrylamide, 1,6-hexamethylene bis(meth)acrylamide, diethylene triamine tris(meth)acrylamide, xylylene bis(meth) acrylamide, and those having a cyclohexylene structure as disclosed in JP-B-54-21726.

Further, there may be used vinyl urethane compounds having two or more polymerizable vinyl groups per molecule (as disclosed in JP-B-48-41708), urethane acrylates (as disclosed in JP-B-2-16765), urethane compounds having an ethylene oxide skeleton (as disclosed in JP-B-62-39418), polyester acrylates (as disclosed in JP-B-52-30490), and photosetting monomers and oligomers as disclosed in “Journal of the Adhesion Society of Japan”, vol. 20, No. 7, pp. 300-308, 1984.

Two or more of these radical-polymerizable polyfunctional monomers may be used in combination.

The compound containing a cation-polymerizable group which can be used to form the binder for the high refractive layer (hereinafter also referred to as “cation-polymerizable compound” or “cation-polymerizable organic compound”) will be described hereinafter.

As the cation-polymerizable compound to be used herein there may be used any compound which undergoes polymerization reaction and/or crosslinking reaction when irradiated with active energy rays in the presence of an active energy ray-sensitive cation polymerization initiator. Representative examples of such a compound include epoxy compounds, cyclic thioether compounds, cyclic ether compounds, spiroorthoester compounds, and vinyl ether compounds. In the invention, one or more of the aforementioned cation-polymerizable organic compounds may be used.

The cation-polymerizable group-containing compound preferably has from 2 to 10, particularly from 2 to 5 cation-polymerizable groups per molecule. The molecular weight of the cation-polymerizable group-containing compound is 3,000 or less, preferably from 200 to 2,000, particularly from 400 to 1,500. When the molecular weight of the cation-polymerizable group-containing compound is too small, a problem of evaporation at the film-forming step can occur. When the molecular weight of the cation-polymerizable group-containing compound is too great, the compatibility with the high refractive layer-forming composition is deteriorated to disadvantage.

Examples of the aforementioned epoxy compounds include aliphatic epoxy compounds and aromatic epoxy compounds.

Examples of the aliphatic epoxy compounds include polyglycidyl ethers of aliphatic polyvalent alcohols or alkylene oxide adducts thereof, polyglycidinyl esters of aliphatic long-chain polybasic acids, and homopolymers and copolymers of glycidyl acrylates and glycidyl methacrylates. Further examples of the aliphatic epoxy compounds other than the aforementioned epoxy compounds include glycidyl esters of higher aliphatic acids, epoxylated soybean oil, butyl epoxystearate, octyl butylstearate, epoxylated linseed oil, and epoxylated polybutadiene. Examples of the alicyclic epoxy compound include cyclohexene oxide- or cyclopentene oxide-containing compounds obtained by the epoxylation of polyglycidinyl ether of polyvalent alcohol having at least one alicyclic group or compound containing an unsaturated alicyclic group (e.g., cyclohexene, cyclopentene, dicyclooctene, tricyclodecene) with a proper oxidizing agent such as hydrogen peroxide and peracid.

Examples of the aromatic epoxy compounds include monoglycidyl ethers or polyglycidyl ethers of monovalent or polyvalent phenols having at least one aromatic nucleus or alkylene oxide adducts thereof. Examples of these epoxy compounds include those disclosed in JP-A-11-242101, paragraphs [0084]-[0086], and those disclosed in JP-A-10-158385, paragraphs [0044]-[0046].

Preferred among these epoxy compounds are aromatic epoxides and alicyclic epoxides, particularly alicyclic epoxides, taking into account quick-curing properties. In the invention, the aforementioned epoxylated compounds may be used singly or in a proper combination of two or more thereof.

As the cyclic thioether compound there may be used a compound having a thioepoxy ring instead of epoxy ring of the aforementioned epoxy compound.

Specific examples of the compound an oxetanyl group as cyclic ether include those disclosed in JP-A-2000-239309, paragraphs [0024]-[0025]. These compounds are preferably used in combination with epoxy group-containing compounds.

Examples of the spiroorthoester compounds include those disclosed in JP-T-2000-506908.

Examples of the vinyl hydrocarbon compounds include styrene compounds, vinyl-substituted alicyclic hydrocarbon compounds (e.g., vinyl cyclohexane, vinyl bicycloheptene), compounds (those wherein V1 corresponds to —O—) listed above with reference to the radical-polymerizable monomer, propenyl compounds {as disclosed in “J. Polymer Science: Part A: Polymer Chemistry”, vol. 32, page 2,895, 1994}, alkoxyallene compounds {as disclosed in “J. Polymer Science: Part A: Polymer Chemistry”, vol. 33, page 2,493, 1995}, vinyl compounds {as disclosed in “J. Polymer Science: Part A: Polymer Chemistry”, vol. 34, page 1,015, 1996; JP-A-2002-29162}, and isopropenyl compounds {as disclosed in “J. Polymer Science: Part A: Polymer Chemistry”, vol. 34, page 2,051, 1996}.

Two or more of these vinyl hydrocarbon compounds may be used in proper combination.

As the aforementioned polyfunctional compound of the invention there is preferably used a compound containing at least one selected from the group consisting of the aforementioned radical-polymerizable groups and cation-polymerizable groups per molecule. Examples of such a compound include those disclosed in JP-A-8-277320, paragraphs [0031]-[0052], and those disclosed in JP-A-2000-191737, paragraph [0015]. The compound to be used in the invention is not limited to these compounds.

It is preferred that the polyfunctional compound comprise the aforementioned radical-polymerizable compound and cation-polymerizable compound incorporated therein at a weight ratio of from 90:10 to 20:80, more preferably from 80:20 to 30:70.

The polymerization initiator to be used in combination with the binder precursor in the aforementioned combination (c) will be described in detail hereinafter.

Examples of the polymerization initiator include heat polymerization initiators and photopolymerization initiators.

The aforementioned polymerization initiator (L) is a compound which generates a radical or acid either when irradiated with light rays or when heated. The photopolymerization initiator (L) to be used in the invention preferably has a maximum absorption wavelength of 400 nm or less. By thus predetermining the absorption wavelength to fall within the ultraviolet range, handling can be conducted under white lamp. Further, a compound having a maximum absorption wavelength falling within the near infrared range can be used.

The radical-generating compound (L1) will be further described hereinafter.

The radical-generating compound (L1) which is preferably used in the invention indicates a compound which, when irradiated with light rays and/or heat, generates a radical that initiates and accelerates the polymerization of a compound having a polymerizable unsaturated group.

Known polymerization initiators and compounds having a bond with a small bond dissociation energy may be properly selected. These radical-generating compounds may be used singly or in combination of two or more thereof.

Examples of the radical-generating compound employable herein include known heat radical polymerization initiators such as organic peroxide compound and azo-based polymerization initiator, and photoradical polymerization initiators such as amine compound (as disclosed in JP-B-44-20189), organic halogen compound, carbonyl compound, metalocene compounds, hexaaryl biimidazole compound, organic boric acid compound and disulfone compound.

Specific examples of the aforementioned halogen compound include compounds as disclosed in Wakabayashi et al, “Bull. Chem. Soc. Japan”, vol. 42, page 2,924, 1969, U.S. Pat. No. 3,905,815, JP-A-63-298339, and M. P. Hutt, “J. Heterocyclic Chemistry”, vol. 1, No. 3, 1970. Particularly preferred examples of the aforementioned halogen atom include trihalomethyl-substituted oxazole compounds (s-triazine compounds).

More preferably, s-triazine derivatives comprising at least one mono-, di- or trihalogen-substituted methyl group bonded to s-triazine ring are used.

Other examples of the organic halogen compound include ketones, sulfides, sulfones and heterocycles containing nitrogen atom as disclosed in JP-A-5-27830, paragraphs [0039]-[0048].

As the aforementioned carbonyl compound there may be used any of compounds as disclosed in “Saishin UV Kouka Gijutsu (Modern UV Curing Technique)”, pp. 60-62, Technical Information Institute Co., Ltd., 1991, JP-A-8-134404, paragraphs [0015]-[0016], and JP-A-11-217518, paragraphs [0029]-[0031]. Examples of these compounds include benzoin compounds such as acetophenone, hydroxyacetophenone, benzophenone, thioxane, benzoin ethyl ether and benzoin butyl ether, benzoic acid ester derivatives such as p-dimethylaminobenzoic acid ethyl and p-diethylaminobenzoic acid ethyl, benzyl dimethyl ketal, and acylphosphine oxide.

Examples of the aforementioned organic peroxide compound include compounds as disclosed in JP-A-2001-139663, paragraph [0019].

Examples of the aforementioned metalocene compound include various titanocene compounds as disclosed in JP-A-2-4705 and JP-A-5-83588, and iron-arene complexes as disclosed in JP-A-1-304453 and JP-A-1-152109.

Examples of the aforementioned hexaaryl biimidazole compound include various compounds as disclosed in JP-B-6-29285, and U.S. Pat. Nos. 3,479,185, 4,311,783 and 4,622,286.

Examples of the aforementioned organic borate compounds include those disclosed in Japanese Patent No. 2,764,769, JP-A-2002-116539, and Kunz, Martin, “Rad. Tech, 98. Proceeding Apr. 19-22, 1998, Chicago”. Specific examples of these organic borate compounds include those disclosed in the above cited JP-A-2002-116539, paragraphs [0022]-[0027].

Specific other examples of the organic borate compounds include organic boron transition metal-coordinated complexes disclosed in JP-A-6-348011, JP-A-7-128785, JP-A-7-140589, JP-A-7-306527, and JP-A-7-292014.

Examples of the aforementioned sulfone compound include compounds as disclosed in JP-A-5-239015. Examples of the aforementioned disulfone compound include compounds represented by the general formulae (II) and (III) as disclosed in JP-A-61-166544.

These radical-generating compounds may be added singly or in combination of two or more thereof.

The amount of the radical-generating compounds to be added is from 0.1% to 30% by mass, preferably from 0.5% to 25% by mass, particularly from 1% to 20% by mass based on the total weight of the radical-polymerizable monomers. When the amount of the radical-generating compounds to be added falls within the above defined range, the resulting high refractive layer-forming composition has no age stability problems and hence a high polymerizability.

The photo-acid generator (L2) which can be used as a photopolymerization initiator (L) will be further described hereinafter.

Examples of the acid generator (L2) employable herein include known compounds such as photoinitiator for photocationic polymerization, photodecolorizing agent for dyes, photo-discoloring agent and known acid generator for use in microresist, etc., and mixture thereof.

Further examples of the acid generator (L2) include organic halogen compounds, disulfone compounds, and onium compounds. Specific examples of the organic halogen compounds and disulfone compounds include those listed above with reference to the radical-generating compounds.

Examples of the onium compounds include diazonium salts, ammonium salts, iminium salts, phosphonium salts, iodonium salts, sulfonium salts, arsonium salts, selenonium salts. Specific examples of these onium compounds include those disclosed in JP-A-2002-29162, paragraphs [0058]-[0059].

As the acid generator (L2), an onium salt is particularly preferred. Preferred among these onium salts are diazonium salts, iodoinium salts, sulfonium salts and iminium salts from the standpoint of photosensitivity of initiation of photopolymerization, material stability, etc.

Specific examples of the onium salts which can be preferably used in the invention include amylated sulfonium salts disclosed in JP-A-9-268205, paragraph [0035], diaryl iodonium salts and triaryl sulfonium salts disclosed in JP-A-2000-71366, paragraphs [0030]-[0011], sulfonium salts of thiobenzoic acid S-phenylester disclosed in JP-A-2001-288205, paragraph [0017], and onium salts disclosed in JP-A-2001-133696, paragraphs [0030]-[0033].

Other examples of the acid generator include compounds such as organic metal/organic halide, photo-acid generator having o-nitrobenzyl type protective group and compound which undergoes photodecomposition to generate sulfonic acid (e.g., iminosulfonate) disclosed in JP-A-2002-29162, paragraphs [0059]-[0062]. These acid-generators may be used singly or in combination of two or more thereof. These acid-generators may be added in an amount of from 0.1 to 20% by mass, preferably from 0.5 to 15% by mass, particularly from 1 to 10% by mass based on the total mass of the cation-polymerizable monomers. When the amount of the acid-generators to be added falls within the above defined range, it is advantageous in the stability, polymerization-reactivity, etc. of the high refractive layer-forming composition.

The high refractive layer-forming composition of the invention preferably comprises a radical polymerization initiator or a cationic polymerization initiator incorporated therein in an amount of from 0.5 to 10% by mass, more preferably from 1 to 5% by mass or from 1 to 10% by mass, more preferably from 2 to 6% by mass based on the total mass of the radical-polymerizable compounds or cation-polymerizable compounds, respectively.

In the case where polymerization reaction involves ultraviolet irradiation, the high refractive layer-forming composition of the invention may comprise any known ultraviolet spectral sensitizer or chemical sensitizer incorporated therein. Examples of these sensitizers include Michler's ketones, amino acids (e.g., glycine), and organic amines (e.g., butylamine, dibutylamine).

In the case where polymerization reaction involves near infrared irradiation, a near infrared spectral sensitizer is preferably used.

As the near infrared spectral sensitizer there may be used any light-absorbing material having an absorption band in at least a part of the wavelength range of 700 nm or more. A compound having a molecular absorptivity or 10,000 or more is preferred. A compound having absorption in the wavelength range of from 750 nm to 1,400 nm and a molecular absorptivity of 20,000 or more is more desirable. It is even more desirable that the near infrared spectral sensitizer show a minimum absorption in the visible light range of from 420 nm to 700 nm and hence be optically transparent. As the near infrared spectral sensitizer there may be used any pigment or dye known as near infrared-absorbing pigment or near infrared-absorbing dye. Preferred among these near infrared spectral sensitizers are known near infrared absorbers.

Commercially available dyes and known dyes disclosed in “Kagaku Kogyo (Chemical Industry)”, May 1986, pp. 45-51 (“Kinsekigai Kyushu Shikiso (Near Infrared-absorbing Dyes”), “90-nendai Kinoshikiso no Kaihatsu to Shijo Doko (Development and Market Trend of Functional Dyes in the 1990s)”, Clause 2.3 of Chapter 2, 1990, CMC, Ikemori and Hashiradani, “Tokushu Kino Shikiso (Special Functional Dyes)”, 1986, CMC, J. FABIAN, “Chem. Rev.”, vol. 92, pp. 1,197-1,226, 1992, catalog issued by Nihon Kanko Shikiso Kenkyujo in 1995, and laser dye catalogs and patents issued by Exciton Inc. in 1989 may be used.

(ii) Organic Metal Compound Containing a Hydrolyzable Functional Group

As the matrix of the high refractive layer to be used in the invention there is preferably used a film obtained by subjecting an organic metal compound containing a hydrolyzable functional group to sol/gel reaction to form a coat layer which is then cured. As the organic metal compound there may be used a compound made of silicon, titanium, zirconium, aluminum or the like. Examples of the hydrolyzable functional groups include alkoxy groups, alkoxycarbonyl groups, halogen atoms, and hydroxyl groups. Particularly preferred among these hydrolyzable functional groups are alkoxy groups such as methoxy group, ethoxy group, propoxy group and butoxy group. A preferred organic metal compound is an organic silicon compound represented by the following general formula (1′) or a partial hydrolyzate (partial condensate) thereof. It is a well known fact that an organic silicon compound represented by the general formula (1′) can easily undergo hydrolysis followed by dehydration condensation reaction.
(R^{a})ₘₐ—Si(X)ₙₐ (1′)

In the general formula (1′), R^{a} represents a substituted or unsubstituted C₁-C₃₀ aliphatic group or C₆-C₁₄ aryl group. X represents a halogen atom (e.g., chlorine atom, bromine atom), OH group, OR^{2a} or OCOR^{2a} group (in which R^{2a} represents a substituted or unsubstituted alkyl group). The suffix ma represents an integer of from 0 to 3, with the proviso that when ma is 0, X represents OR^{2a} or OCOR^{2a} group. The suffix na represents an integer of from 1 to 4. The sum of ma and na is 4.

Preferred examples of the aliphatic group represented by R^{a} in the general formula (1′) include C₁-C₁₈ aliphatic groups (e.g., methyl, ethyl, propyl, butyl, pentyl, hexyl, octyl, decyl, dodecyl, hexadecyl, octadecyl, benzyl, phenethyl, cyclohexyl, cyclohexylmethyl, hexenyl, decenyl, dodecenyl), more preferably C₁-C₁₂, particularly C₁-C₈ aliphatic groups.

Examples of the aryl group represented by R^{a} include phenyl, naphthyl, and anthranyl. Preferred among these aryl groups is phenyl.

The substituents on these groups are not specifically limited. Preferred examples of these substituents include halogen atoms (e.g., fluorine, chlorine, bromine), hydroxyl groups, mercapto groups, carboxyl groups, epoxy groups, alkyl groups (e.g., methyl, ethyl, i-propyl, propyl, t-butyl), aryl groups (e.g., phenyl, naphthyl), aromatic heterocyclic groups (e.g., furyl, pyrazolyl, pyridyl), alkoxy groups (e.g., methoxy, ethoxy, i-propoxy, hexyloxy), aryloxy groups (e.g., phenoxy), alkylthio groups (e.g., methylthio, ethylthio), arylthio groups (e.g., phenylthio), alkenyl groups (e.g., vinyl, 1-propenyl), alkoxysilyl groups (e.g., trimethoxysilyl, triethoxysilyl), acyloxy groups (e.g., acetoxy, (meth)acryloyl), alkoxycarbonyl groups (e.g., methoxycarbonyl, ethoxycarbonyl), aryloxycarbonyl groups (e.g., phenoxycarbonyl), carbamoyl groups (e.g., carbamoyl, N-methylcarbamoyl, N,N-dimethylcarbamoyl, N-methyl-N-octylcarbamoyl), and acylamino groups (e.g., acetylamino, benzoylamino, acrylamino, methacrylamino).

Even more desirable among these substituents are hydroxyl groups, mercapto groups, carboxyl groups, epoxy groups, alkyl groups, alkoxysilyl groups, acyloxy groups, and acylamino groups. Particularly preferred among these substituents are epoxy groups, polymerizable acyloxy groups (e.g., (meth)acryloyl), and polymerizable acylamino groups (e.g., acrylamino, methacrylamino). These substituents may be further substituted.

R^{2a} represents a substituted or unsubstituted alkyl group. The substituents on the alkyl group are as defined with reference to R^{a}.

The suffix ma represents an integer of from 0 to 3. The suffix na represents an integer of from 1 to 4. The sum of ma and na is 4. The suffix ma is preferably 0, 1 or 2, particularly 1. When ma is 0, X represents OR^{2a} or OCOR^{2a} group.

The content of the compound represented by the general formula (1′) is preferably from 10% to 80% by mass, more preferably from 20% to 70% by mass, particularly from 30% to 50% by mass based on the total solid content of the high refractive layer.

Specific examples of the compound of the general formula (1′) include those disclosed in JP-A-2001-166104, paragraphs [0054]-[0056].

The organic binder to be incorporated in the high refractive layer preferably has a silanol group. When the binder has a silanol group, the resulting high refractive layer exhibits further improvements in physical strength, chemical resistance and weathering resistance.

The incorporation of the silanol group can be accomplished by incorporating an organic silicon compound having a crosslinkable or polymerizable functional group represented by the general formula (1′) in the high refractive layer-forming coating composition as a binder-forming component constituting the coating composition with a binder precursor (curable polyfunctional monomer, polyfunctional oligomer, etc.), a polymerization initiator and a dispersant to be incorporated in the dispersion of high refractive particulate material, spreading the coating composition over a transparent protective film, and then allowing the dispersant, the polyfunctional monomer or polyfunctional oligomer and the organic silicon compound represented by the general formula (1′) to undergo crosslinking reaction or polymerization reaction.

The hydrolysis/condensation reaction for the purpose of curing the aforementioned organic metal compound is preferably effected in the presence of a catalyst. Examples of the catalyst employable herein include inorganic acids such as hydrochloric acid, sulfuric acid and nitric acid, organic acids such as oxalic acid, acetic acid, formic acid, trifluoroacetic acid, methanesulfonic acid and toluenesulfonic acid, inorganic bases such as sodium hydroxide, potassium hydroxide and ammonia, organic bases such as triethylamine and pyridine, metal alkoxides such as triisopropoxy aluminum, tetrabutoxy zirconium and tetrabutoxy titanate, and metal chelate compounds of β-diketones or β-ketoesters. Specific examples of these catalysts include compounds disclosed in JP-A-2000-275403, paragraphs [0071]-[0083].

The proportion of these catalyst compounds in the composition is from 0.01 to 50% by mass, preferably from 0.1 to 50% by mass, more preferably from 0.5 to 10% by mass based on the mass of the organic metal compound. The reaction conditions are preferably adjusted properly by the reactivity of the organic metal compound.

In the high refractive layer, the matrix preferably has a specific polar group.

Examples of the specific polar group include anionic groups, amino groups, and quaternary ammonium groups. Specific examples of the anionic groups, amino groups and quaternary ammonium groups include those listed above with reference to the dispersant.

The matrix having a specific polar group in the high refractive layer is obtained, e.g., by compounding a high refractive layer-forming coating composition with a dispersion containing a high refractive particulate material and a dispersant, a combination of a binder precursor having a specific polar group (e.g., curable polyfunctional monomer or polyfunctional oligomer having a specific polar group) and a polymerization initiator and at least any of organic silicon compounds having a specific polar group and a crosslinkable or polymerizable functional group represented by the general formula (1′) as a cured layer-forming component and optionally a monofunctional monomer having a specific polar group and crosslinkable or polymerizable functional group, spreading the coating composition over a transparent protective film, and then allowing the dispersant, the monofunctional monomer, polyfunctional monomer or polyfunctional oligomer and/or organic silicon compound represented by the general formula (1′) to undergo crosslinking or polymerization reaction.

The monofunctional monomer having a specific polar group can act as a dispersing aid for high refractive particulate material in the coating composition. After the spreading of the coating composition, the monofunctional monomer can further undergo crosslinking or polymerization reaction with the dispersant, the polyfunctional monomer or polyfunctional oligomer to form a binder that can keep the high refractive particulate material dispersed uniformly in the high refractive layer, making it possible to prepare a high refractive layer excellent in physical strength, chemical resistance and weathering resistance.

The amount of the monofunctional monomer having an amino group or quaternary ammonium group to be incorporated in the dispersant is preferably from 0.5 to 50% by mass, more preferably from 1 to 30% by mass. When the crosslinking or polymerization reaction is effected at the same time with or after the spreading of the high refractive layer-forming coating composition to form a binder, the monofunctional monomer is allowed to perform effectively before the spreading of the high refractive layer-forming coating composition.

Another example of the matrix of the high refractive layer of the invention is one formed by curing an organic polymer containing a known crosslinkable or polymerizable functional group corresponds to the aforementioned organic binder (a). After the formation of the high refractive layer, the polymer preferably has a crosslinked or polymerized structure. Examples of the polymer include polyolefins (made of saturated hydrocarbon), polyethers, polyureas, polyurethanes, polyesters, polyamides, polyamides, and melamine resins. Preferred among these polymers are polyolefins, polyethers and polyureas, more preferably polyolefins and polyethers. The uncured organic polymer preferably has a mass-average molecular weight of from 1×10³ to 1×10⁶, more preferably from 3×10³ to 1×10⁵.

The uncured organic polymer is preferably a copolymer of repeating units having a specific polar group and repeating units having a crosslinked or polymerized structure similar to the contents described above. The proportion of the repeating units having an anionic group in the polymer is preferably from 0.5 to 99% by mass weight, more preferably from 3 to 95% by mass, most preferably from 6 to 90% by mass based on the mass of the repeating units. The repeating units may have two or more same or different anionic groups.

The proportion of the repeating units having a silanol group, if any, is preferably from 2 to 98 mol-%, more preferably from 4 to 96 mol-%, most preferably from 6 to 94 mol-%.

The proportion of the repeating units having an amino group or quaternary ammonium group, if any, is preferably from 0.1 to 50% by mass, more preferably from 0.5 to 30% by mass.

Even when a silanol group, an amino group and a quaternary ammonium group are contained in the repeating units having an anionic group or the repeating units having a crosslinked or polymerized structure, similar effects can be exerted.

The proportion of the repeating units having a crosslinked or polymerized structure in the polymer is preferably from 1 to 90% by mass, more preferably from 5 to 80% by mass, most preferably from 8 to 60% by mass.

The matrix comprising a crosslinked or polymerized binder is preferably formed by spreading a high refractive layer-forming composition over a transparent support, and allowing the coat layer to undergo crosslinking or polymerization reaction at the same time with or after spreading.

(Other Compositions of High Refractive Layer)

The high refractive layer of the invention may further properly comprise other compounds incorporated therein depending on the purpose. For example, in the case where the low refractive layer is provided on the high refractive layer, the refractive index of the high refractive layer is preferably higher than that of the transparent support. When the high refractive layer comprises an aromatic ring, halogen elements other than fluorine (e.g., Br, I, Cl) and atoms such as S, N and P incorporated therein, the refractive index of the organic compound is raised. Therefore, a binder obtained by the crosslinking or polymerization reaction of a curable compound comprising these components may be preferably used as well.

The high refractive layer may comprise a resin, a surface active agent, an antistatic agent, a coupling agent, a thickening agent, a coloring inhibitor, a coloring agent (e.g., pigment, dye), anti-foaming agent, a leveling agent, a fire retardant, an ultraviolet absorber, an infrared absorber, an adhesion-providing agent, a polymerization inhibitor, an oxidation inhibitor, a surface modifier, an electrically-conductive particulate metal, etc. incorporated therein besides the aforementioned components (e.g., high refractive particulate material, polymerization initiator, sensitizer).

[Middle Refractive Layer]

The anti-reflection layer of the invention preferably has a two-layer laminated structure having high refractive layers having different refractive indexes. In some detail, the anti-reflection layer preferably has a three-layer laminated structure comprising a low refractive layer formed by spreading a composition by the following method on a high refractive layer having a higher refractive index than that of the low refractive layer and a middle refractive layer having a refractive index intermediate between that of the support and the high refractive layer disposed adjacent to the high refractive layer and on the side of the high refractive layer opposite the low refractive layer. As mentioned above, the refractive index of the various refractive layers are relative to each other.

The material constituting the middle refractive layer of the invention may be any known material but is preferably the same as that of the high refractive layer. The refractive index of the middle refractive layer can be easily adjusted by the kind and amount of the inorganic particulate material to be used. The middle refractive layer is formed to a thickness as small as 30 to 500 nm, preferably from 50 to 300 nm, in the same manner as described above with reference to the high refractive layer.

[Low Refractive Layer]

The low refractive layer of the invention will be described hereinafter.

The low refractive layer of the invention is formed by curing a coating solution containing a binder and an inorganic particulate material.

The refractive index of the low refractive layer in the anti-reflection film of the invention is from 1.20 to 1.49, preferably from 1.30 to 1.44.

(Hollow Particulate Silica)

The low refractive layer of the invention may contain an inorganic particulate material having a hollow structure to reduce the rise of the refractive index thereof. The hollow inorganic particulate material is preferably silica having a hollow structure. The refractive index of the hollow particulate silica is preferably from 1.17 to 1.40, more preferably from 1.17 to 1.35, even more preferably from 1.17 to 1.30. The refractive index used herein means the refractive index of the entire particulate material rather than the refractive index of only the shell silica constituting the hollow particulate silica. Supposing that the radius of the bore of the particle is a and the radius of the shell of the particle is b, the percent void x represented by the following numerical formula (III) is preferably from 10% to 60%, more preferably from 20% to 60%, most preferably from 30% to 60%.
x=(4πa³/3)/(4πb³/3)×100 (III)

As the refractive index of the hollow particulate silica decreases and the percentage void of the hollow particulate silica rises, the thickness of the shell decreases to lower the strength of the particle. Therefore, particulate materials having a refractive index as low as less than 1.17 cannot be used from the standpoint of scratch resistance.

For the measurement of the refractive index of these hollow particulate silica materials, an Abbe refractometer (produced by ATAGO CO., LTD.) was used.

For the method of producing the hollow silica, reference can be made to JP-A-2001-233611 and JP-A-2002-79616.

The amount of the hollow silica to be incorporated is preferably from 1 mg/m² to 100 mg/m², more preferably from 5 mg/m² to 80 mg/m², even more preferably from 10 mg/m² to 60 mg/m². When the amount of the hollow silica to be incorporated falls within the above defined range, the resulting anti-reflection film exhibits an excellent scratch resistance, less fine roughness on the surface of the low refractive layer and improved external appearance such as black tone and density and integrating sphere reflectance.

The average particle diameter of the hollow silica is preferably from 30% to 150%, more preferably from 35% to 80%, even more preferably from 40% to 60% of the thickness of the low refractive layer. In other words, when the thickness of the low refractive layer is 100 nm, the particle diameter of the hollow silica is preferably from 30 nm to 150 nm, more preferably from 35 nm to 80 nm, even more preferably from 40 nm to 60 nm.

When the particle diameter of the particulate silica falls within the above defined range, the resulting low refractive layer exhibits a lowered refractive index, less fine roughness on the surface thereof and improved external appearance such as black tone and density and integrating sphere reflectance. The particulate silica may be crystalline or amorphous and is preferably monodisperse. The shape of the particulate silica is most preferably sphere but may be amorphous.

The average particle diameter of the hollow silica can be determined by electron microphotography.

In the invention, a non-hollow particulate silica may be used in combination with the hollow silica. The particle size of the non-hollow silica is preferably from 30 nm to 150 nm, more preferably from 35 nm to 80 nm, most preferably from 40 nm to 60 nm.

The aforementioned particulate silica having a particle diameter falling within the above defined range (hereinafter referred to as “large particle size particulate silica”) may be used in combination with at least one particulate silica having an average particle diameter of less than 25% of the thickness of the low refractive layer (hereinafter referred to as “small particle size particulate silica”).

The small particle size particulate silica can be present in the gap between the large size silica particles and thus can act as a retainer for large particle diameter particulate silica.

The average particle diameter of the small particle diameter particulate silica is preferably from 1 nm to 20 nm, more preferably from 5 nm to 15 nm, particularly from 10 nm to 15 nm. The use of such a particulate silica is advantageous in material cost and effect of retainer.

The particulate silica may be subjected to physical surface treatment such as plasma discharge and corona discharge or chemical surface treatment with a surface active agent, coupling agent or the like to enhance the stability of dispersion in the dispersion or coating solution or the affinity for or the bonding properties with the binder component. As the coupling agent there is preferably used an alkoxy metal compound (e.g., titanium coupling agent, silane coupling agent). Particularly effective among these surface treatments is silane coupling treatment.

The aforementioned coupling agent is used as a surface treatment for the inorganic filler in the low refractive layer to effect surface treatment before the preparation of the layer coating solution. The coupling agent is preferably incorporated as additive in the low refractive layer during the preparation of the layer coating solution.

It is preferred that the particulate silica be previously dispersed in the medium to reduce the burden of surface treatment.

As the binder constituting the low refractive layer of the invention there may be used the same binder as incorporated in the aforementioned hard coat layer. Further, the low refractive binder may be a fluorine-containing polymer. The fluorine-containing polymer is preferably one having a dynamic friction coefficient of from 0.03 to 0.15 and a contact angle of from 90° to 120° with respect to water which undergoes crosslinking when heated or irradiated with ionizing radiation.

Examples of the fluorine-containing polymer which is preferably used in the low refractive layer include hydrolyzates and dehydration condensates of perfluoroalkyl group-containing silane compounds (e.g., (heptadecafluoro-1,1,2,2-tetrahydrodecyl)triethoxy silane). Other examples of the fluorine-containing polymer include fluorine-containing copolymers comprising as constituents a fluorine-containing monomer unit and a constituent unit for providing crosslinking reactivity.

Specific examples of the fluorine-containing monomer unit include fluoroolefins (e.g., fluoroethylene, vinylidene fluoride, tetrafluoroethylene, perfluorooctylethylene, hexafluoropropylene, perfluoro-2,2-dimethyl-1,3-dioxol), partly or fully fluorinated alkyl ester derivatives of (meth)acrylic acid (e.g., Biscoat 6FM (produced by OSAKA ORGANIC CHEMICAL INDUSTRY LTD.), M-2020 (produced by DAIKIN INDUSTRIES, ltd.), and partly or fully fluorinated vinyl ether derivatives of (meth)acrylic acid. Preferred among these fluorine-containing monomer units are perfluoroolefins. Particularly preferred among these fluorine-containing monomer units is hexafluoropropylene from the standpoint of refractive index, solubility, transparency, availability, etc.

Examples of the constituent unit for providing crosslinking reactivity include constituent units obtained by the polymerization of monomers previously having self-crosslinkable functional group in molecule such as glycidyl (meth)acrylate and glycidyl vinyl ether, constituent units obtained by the polymerization of monomers having carboxyl group, hydroxyl group, amino group, sulfo group, etc. (e.g., (meth)acrylic acid, methylol (meth)acrylate, hydroxyalkyl (meth)acrylate, allyl acrylate, hydroxy ethyl vinyl ether, hydroxy butyl vinyl ether, maleic acid, crotonic acid), and constituent units obtained by incorporating crosslinking reactive groups such as (meth)acryloyl group into these constituent units by polymer reaction (e.g., method involving the action of acrylic acid chloride on hydroxyl group).

Besides the aforementioned fluorine-containing monomer units and the constituent units for providing crosslinking reactivity, monomers free of fluorine atom may be properly copolymerized from the standpoint of solubility in solvent and transparency of film. The monomer units which can be used in combination with the aforementioned monomer units are not specifically limited. Examples of the monomer units employable herein include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrene derivatives (e.g., styrene, divinylbenzene, vinyl toluene, α-methylstyrene), vinyl ethers (e.g., methyl vinyl ether, ethyl vinyl ether, cyclohexyl vinyl ether), vinyl esters (e.g., vinyl acetate, vinyl propionate, vinyl cinnamate), acrylamides (e.g., N-tert-butyl acrylamide, N-cyclohexylacylamide), methacrylamides, and acrylonitrile derivatives.

The aforementioned polymer may be used properly in combination with a hardener as disclosed in JP-A-10-25388 and JP-A-10-147739.

A fluorine-containing polymer particularly useful in the invention is a random copolymer of perfluoroolefin and vinyl ether or vinyl ester. The fluorine-containing polymer preferably contains a group which can undergo crosslinking reaction per se (e.g., radical reactive group such as (meth)acryloyl group, ring-opening polymerizable group such as epoxy group and oxetanyl group). These crosslinking reactive group-containing polymerizing units preferably account for from 5 to 70 mol-%, particularly from 30 to 60 mol-% of all the polymerizing units of the polymer.

A preferred embodiment of the copolymer to be used in the invention is one represented by the following general formula 1.

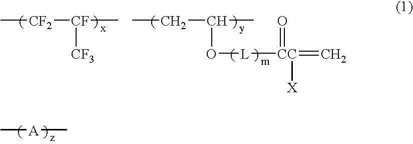

In the general formula (1), L represents a C₁-C₁₀ connecting group, preferably a C₁-C₆ connecting group, particularly C₂-C₄ connecting group. The connecting group may be straight-chain or may have a branched or cyclic structure. The connecting group may have hetero atoms selected from the group consisting of oxygen, nitrogen and sulfur.

Preferred examples of L include *-(CH₂)₂—O-**, *-(CH₂)₂—NH-**, *-(CH₂)₄—O-**, *-(CH₂)₆—O-**, *-(CH₂)—O—(CH₂)₂—O-**, *-CONH—(CH₂)₃—O-**, *-CH₂CH(OH)CH₂—O-**, and *-CH₂CH₂OCONH(CH₂)₃—O-** (in which * indicates the connecting site on the polymer main chain side and ** indicates the connecting site on the (meth)acryloyl group side). The suffix m represents 0 or 1.

In the general formula 1, X represents a hydrogen atom or methyl group, preferably hydrogen atom from the standpoint of curing reactivity.

In the general formula 1, the group A represents a repeating unit derived from arbitrary vinyl monomer. The repeating unit is not specifically limited so far as it is a constituent of a monomer copolymerizable with hexafluoropropylene. The repeating unit may be properly selected from the standpoint of adhesion to substrate, Tg of polymer (contributing to film hardness), solubility in solvent, transparency, slipperiness, dustproofness, stainproofness, etc. The repeating unit may be composed of a single or a plurality of vinyl monomers depending on the purpose.

Preferred examples of the aforementioned vinyl monomer include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether, vinyl esters such as vinyl acetate, vinyl propionate and vinyl butyrate, (meth)acrylates such as methyl (meth)acrylate, ethyl (meth)acrylate, hydroxyethyl (meth)acrylate, glycidyl methacrylate, allyl (meth)acrylate and (meth)acryloyloxypropyl trimethoxysilane, styrene derivatives such as styrene and p-hydroxymethylstyrene, unsaturated carboxylic acids such as crotonic acid, maleic acid and itaconic acid, and derivatives thereof. More desirable among these vinyl monomers are vinyl ether derivatives and vinyl ester derivatives. Particularly preferred among these vinyl monomers are vinyl ether derivatives.

The suffixes x, y and z each represent the molar percentage of the respective constituent component and satisfy the relationships 30≦x≦60, 5≦y≦70 and 0≦z≦65, preferably 35≦x≦55, 30≦y≦60 and 0≦z≦20, particularly 40≦x≦55, 40≦y≦55 and 0≦z≦10.

A particularly preferred embodiment of the aforementioned fluorine-containing copolymer is one represented by the general formula 2.

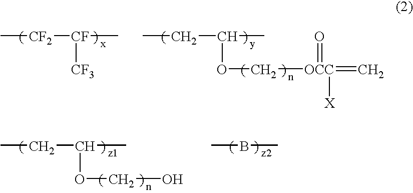

In the general formula 2, X, x and y and their preferred range are as defined in the general formula 1.

The suffix n represents an integer of from 2 to 10, preferably from 2 to 6, particularly from 2 to 4.

The group B represents a repeating unit derived from arbitrary vinyl monomer. The repeating unit may be composed of a single composition or a plurality of compositions. Examples of the repeating unit include those listed above with reference to the group A in the general formula 2.

The suffixes z1 and z2 each represent the molar percentage of the respective repeating unit and satisfy the relationship 0≦z1≦65 and 0≦z2≦65, preferably 0≦z≦30 and 0≦z2≦10, particularly 0≦z1≦10 and 0≦z2≦5.

The fluorine-containing copolymer represented by the general formula 1 or 2 can be synthesized by introducing a (meth)acryloyl group into a copolymer containing a hexafluoropropylene component and a hydroxy alkyl vinyl ether component by any of the aforementioned methods.

Preferred examples of the copolymer which can be used in the invention will be given below, but the invention is not limited thereto.

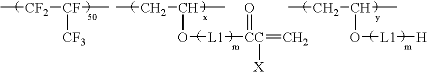

| | | | | |
|---|---|---|---|---|
| x | y | m | L1 | X |

| | | | | | |
|---|---|---|---|---|---|
| P-1 | 50 | 0 | 1 | *—CH₂CH₂O—** | H |
| P-2 | 50 | 0 | 1 | *—CH₂CH₂O—** | CH₃ |
| P-3 | 45 | 5 | 1 | *—CH₂CH₂O—** | H |
| P-4 | 40 | 10 | 1 | *—CH₂CH₂O—** | H |
| P-5 | 30 | 20 | 1 | *—CH₂CH₂O—** | H |
| P-6 | 20 | 30 | 1 | *—CH₂CH₂O—** | H |
| P-7 | 50 | 0 | 0 | — | H |
| P-8 | 50 | 0 | 1 | *—C₄H₈O—** | H |
| P-9 | 50 | 0 | 1 | *—(CH₂)₂—O—(CH₂)₂—O—** | H |
| P-10 | 50 | 0 | 1 | 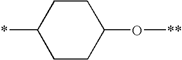 | H |

The symbol * indicates the polymer main chain side.
The symbol ** indicates (meth)acryloyl group side.

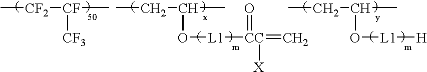

| | x | y | m | L1 | X |
|---|---|---|---|---|---|
| P-11 | 50 | 0 | 1 | *—CH₂CH₂NH—** | H |
| P-12 | 50 | 0 | 1 | 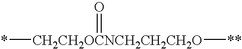 | H |
| P-13 | 50 | 0 | 1 | 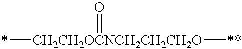 | CH₃ |
| P-14 | 50 | 0 | 1 | 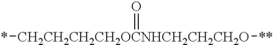 | CH₃ |
| P-15 | 50 | 0 | 1 | 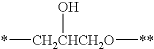 | H |
| P-16 | 50 | 0 | 1 | 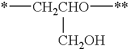 | H |
| P-17 | 50 | 0 | 1 | 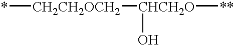 | H |
| P-18 | 50 | 0 | 1 | 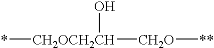 | CH₃ |
| P-19 | 50 | 0 | 1 | 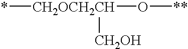 | CH₃ |
| P-20 | 40 | 10 | 1 | *—CH₂CH₂O—** | CH₃ |

The symbol * indicates the polymer main chain side.
The symbol ** indicates (meth)acryloyl group sode.

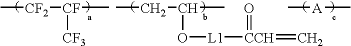

| | a | b | c | L1 | A |
|---|---|---|---|---|---|
| P-21 | 55 | 45 | 0 | *—CH₂CH₂O—** | — |
| P-22 | 45 | 55 | 0 | *—CH₂CH₂O—** | — |
| P-23 | 50 | 45 | 5 | 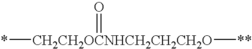 | 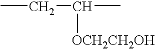 |
| P-24 | 50 | 45 | 5 | 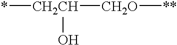 | 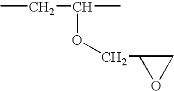 |
| P-25 | 50 | 45 | 5 | 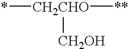 | 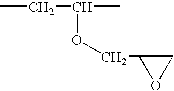 |
| P-26 | 50 | 40 | 10 | *—CH₂CH₂O—** | 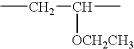 |
| P-27 | 50 | 40 | 1 | *—CH₂CH₂O—** | 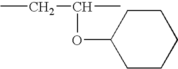 |
| P-28 | 50 | 40 | 10 | *—CH₂CH₂O—** | 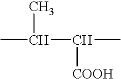 |

The symbol * indicates the polymer main chain side.
The symbol ** indicates acryoyl group side.

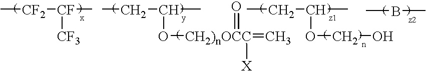

| | x | y | z1 | z2 | n | X | B |
|---|---|---|---|---|---|---|---|
| P-29 | 50 | 40 | 5 | 5 | 2 | H | 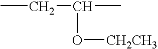 |
| P-30 | 50 | 35 | 5 | 10 | 2 | H | 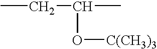 |
| P-31 | 40 | 40 | 10 | 10 | 4 | CH₃ | 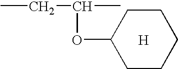 |

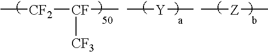

| | a | b | Y | Z |
|---|---|---|---|---|
| P-32 | 45 | 5 | 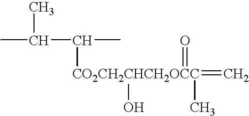 | 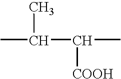 |
| P-33 | 40 | 10 | 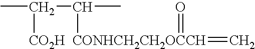 | 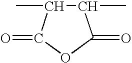 |

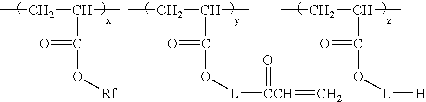

| | x | y | z | Rf | L |
|---|---|---|---|---|---|
| P-34 | 60 | 40 | 0 | —CH₂CH₂C₈F₁₇-n | —CH₂CH₂O— |
| P-35 | 60 | 30 | 10 | —CH₂CH₂C₄F₈H-n | —CH₂CH₂O— |
| P-36 | 40 | 60 | 0 | —CH₂CH₂C₆F₁₂H | —CH₂CH₂CH₂CH₂O— |

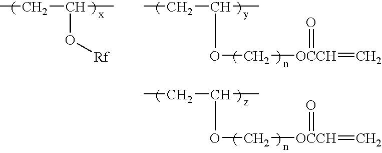

| | x | y | z | n | Rf |
|---|---|---|---|---|---|
| P-37 | 50 | 50 | 0 | 2 | —CH₂C₄F₈H-n |
| P-38 | 40 | 55 | 5 | 2 | —CH₂C₄F₈H-n |
| P-39 | 30 | 70 | 0 | 4 | —CH₂C₈F₁₇-n |
| P-40 | 60 | 40 | 0 | 2 | —CH₂CH₂C₈F₁₆H-n |

The production of the aforementioned fluorine-containing polymer by polymerization can be carried out by irradiation with ionizing radiation or heating in the presence of a photo-acid generator or heat-acid generator.

The binder having a reactive crosslinking group to be used in the low refractive layer of the invention is preferably a binder having any of (meth)acryloyl group, epoxy group and isocyanate group, more preferably (meth)acryloyl group, as a reactive crosslinking group.

The synthesis of the fluoroaliphatic group-containing copolymer to be used in the invention is carried out by a process which comprises synthesizing a precursor such as hydroxyl group-containing polymer by any polymerization method such as solution polymerization, precipitation polymerization, suspension polymerization, bulk polymerization and emulsion polymerization, and then subjecting the precursor to the aforementioned polymer reaction to introduce a (meth)acryloyl group into the precursor. The polymerization reaction can be effected in a known process such as batchwise process, half-continuous process and continuous process.

Examples of the method for the initiation of polymerization include a method involving the use of a radical polymerization initiator, and a method involving the irradiation with light rays or radiation. For the details of these polymerization methods and polymerization initiating methods, reference can be made to Teiji Tsuruta, “Kobunshi Gosei Hoho (Polymer Synthesis Methods)”, revised edition, THE NIKKAN KOGYO SHINBUN LTD., 1971, and Takayuki Otsu and Masayoshi Kinoshita, “Kobunshi Gosei no Jikkenho (Experimental Methods of Polymer Synthesis)”, Kagakudojin, 1972, pp. 124-154.

Particularly preferred among the aforementioned polymerization methods is solution polymerization using a radical polymerization initiator. Examples of the solvent to be used in solution polymerization include various organic solvents such as ethyl acetate, butyl acetate, acetone, methyl ethyl ketone, methyl isobutyl ketone, cyclohexanone, tetrahydrofurane, dioxane, N,N-dimethylformamide, N,N-dimethyl acetamide, benzene, toluene, acetonitrile, methylene chloride, chloroform, dichloroethane, methanol, ethanol, 1-propanol, 2-propanol, and 1-butanol. These organic solvents may be used singly or in combination of two or more thereof or in admixture with water.

The polymerization temperature needs to be predetermined in connection with the molecular weight of the polymer thus produced, the kind of the initiator, etc. and may be from 0° C. to 100° C. but is preferably from 50° C. to 100° C.

The reaction pressure can be properly predetermined but normally is preferably from 9.8×10⁴ to 9.8×10⁶ Pa (1 to 100 kg/cm²), particularly 9.8×10⁴ to 294×10⁴ Pa (from 1 to 30 kg/cm²). The reaction time is from about 5 hours to 30 hours.

Preferred examples of the reprecipitating solvent for the polymer thus obtained include isopropanol, hexane, and methanol.

In the invention, the various layer-forming coating solutions may each further comprise a dispersion stabilizer incorporated therein for the purpose of inhibiting the agglomeration and precipitation of the inorganic filler. Examples of the dispersion stabilizer employable herein include polyvinyl alcohols, polyvinyl pyrrolidones, cellulose derivatives, polyamides, phosphoric acid esters, polyethers, surface active agents, silane coupling agents, and titanium coupling agents. The previously mentioned silane coupling agents are particularly desirable because they can provide a rigid cured film.

The low refractive layer-forming composition of the invention is normally in the form of liquid and preferably composed of the aforementioned copolymer. The low refractive layer-forming composition of the invention is prepared by dissolving the aforementioned copolymer and optionally various additives and a radical polymerization initiator in a proper solvent. The solid content concentration of the liquid low refractive layer-forming composition is properly predetermined depending on the purpose but is normally from about 0.01% to 60% by mass, preferably from 0.5% to 50% by mass, particularly from 1% to 20% by mass.

It is not necessarily advantageous from the standpoint of the hardness of the low refractive layer that the additives such as hardener be incorporated in the low refractive layer. From the standpoint of interfacial adhesion to the high refractive layer, however, a hardener such as polyfunctional (meth)acrylate compound, polyfunctional epoxy compound, polyisocyanate compound, aminoplast, polybasic acid and anhydride thereof or an inorganic particulate material such as silica may be incorporated in the low refractive layer in a small amount. The amount of these additives, if incorporated, is preferably from 0% to 30% by mass, more preferably from 0% to 20% by mass, particularly from 0% to 10% by mass based on the total solid content of the low refractive layer.

For the purpose of providing properties such as stainproofness, water resistance, chemical resistance and slipperiness, a known silicone-based or fluorine-based stainproof agent, lubricant or the like may be incorporated in the low refractive layer in a proper amount. The amount of these additives, if incorporated, is preferably from 0.01% to 20% by mass, more preferably from 0.05% to 10% by mass, particularly from 0.1% to 5% by mass based on the total solid content of the low refractive layer.

Preferred examples of the silicone-based compound employable herein include a compound containing a plurality of dimethylsilyloxy units as repeating units wherein there are contained substituents at least at the end of the compound chain and/or in its side chains.

The compound chain containing dimethylsilyloxy as repeating unit may contain a structural unit other than dimethylsilyloxy. These substituents may be the same or different. There are preferably present a plurality of substituents. Preferred examples of the substituents include acryloyl groups, methacryloyl groups, vinyl groups, aryl groups, cinnamoyl groups, epoxy groups, oxetanyl groups, hydroxyl groups, fluoroalkyl groups, polyoxyalkylene groups, carboxyl groups, and amino groups. The molecular weight of the silicone-based compound is not specifically limited but is preferably 100,000 or less, more preferably 50,000 or less, particularly from 3,000 to 30,000, most preferably from 10,000 to 20,000. The content of silicon atom in the silicone-based compound is not specifically limited but is preferably 18.0% by mass or more, particularly preferably from 25.0% to 37.8% by mass, most preferably from 30.0% to 37.0% by mass. Preferred examples of the silicone-based compound include X-22-174DX, X-22-2426, X-22-164B, X-22-164C, X-22-170DX, X-22-176D, X-22-1821 (produced by Shin-Etsu Chemical Co., Ltd.), and FM-0725, FM-7725, FM-4421, FM-5521, FM-6621, FM-1121 (produced by CHISSO CORPORATION), and DMS-U22, RMS-033, RMS-083, UMS-182, DMS-H21, DMS-H31, HMS-301, FMS121, FMS123, FMS131, FMS141 and FMS221 (produced by Gelest Inc.).

As the fluorine-based compound which can be used as stainproofing agent there is preferably used a compound having a fluoroalkyl group. The fluoroalkyl group preferably has from 1 to 20 carbon atoms, more preferably from 1 to 10 carbon atoms, and may have a straight-chain structure [e.g., —CF₂CH₃, —CH₂(CF₂)₄H, —CH₂(CF₂)₈CF₃, —CH₂CH₂(CF₂)₄H], a branched structure [e.g., —CH(CF₃)₂, —CH₂CF(CF₃)₂, —CH(CH₃)CF₂CF₃, —CH(CH₃) (CF₂)₅CF₂H] or an alicyclic structure (preferably 5-membered or 6-membered ring such as perfluorocyclohexyl group, perfluorocyclopentyl group or alkyl group substituted thereby). The fluoroalkyl group may have an ether bond (e.g., —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H). A plurality of the fluoroalkyl groups may be incorporated in the same molecule.

The fluorine-based compound preferably further contain substituents contributing to the formation of bond to the low refractive layer or the compatibility with the low refractive layer. These substituents may be the same or different. It is preferred that there be a plurality of these substituents. Preferred examples of these substituents include acryloyl group, methacryloyl group, vinyl group, aryl group, cinnamonyl group, epoxy group, oxetanyl group, hydroxyl group, polyoxyalkylene group, carboxyl group, and amino group. The fluorine-based compound may be used in the form of polymer or oligomer with a fluorine-free compound. The fluorine-based compound may be used without any limitation on the molecular weight. The content of fluorine atoms in the fluorine-based compound is not specifically limited but is preferably 20% by mass or more, particularly from 30% to 70% by mass, most preferably from 40% to 70% by mass. Preferred examples of the fluorine-based compound include R-2020, M-2020, R-3833 and M-3833 (produced by DAIKIN INDUSTRIES, Ltd.), and Megafac F-171, Megafac F-172 and Megafac F-179A, Diffenser MCF-300 (produced by DAINIPPON INK AND CHEMICALS, INCORPORATED). However, the invention is not limited to these products.

For the purpose of providing properties such as dustproofing agent and antistatic properties, a dustproofing agent such as known cationic surface active agent and polyoxyalkylene-based compound, antistatic agent or the like may be properly added. Referring to these dustproofing agents and antistatic agents, the aforementioned silicone-based compound or fluorine-based compound may have its structural unit to act partly to perform such a performance. These additives, if any, are preferably added in an amount of from 0.01 to 20% by mass, more preferably from 0.05 to 10% by mass, particularly from 0.1 to 5% by mass based on the total solid content of the low refractive layer-forming composition. Preferred examples of these compounds include Megafac F-150 (produced by DAINIPPON INK AND CHEMICALS, INCORPORATED), and SH-3748 (produced by Toray Dow Corning Co., Ltd.). However, the invention is not limited to these products.

The solvent to be used in the coating solution for forming the various layers (e.g., hard coat layer, high refractive layer, middle refractive layer, low refractive layer) in the anti-reflection film of the invention will be described hereinafter.

Examples of the solvent having a boiling point of 100° C. or less include hydrocarbons such as hexane (boiling point: 68.7° C.), heptane (boiling point: 98.4° C.), cyclohexane (boiling point: 80.7° C.) and benzene (boiling point: 80.1° C.), halogenated hydrocarbons such as dichloromethane (boiling point: 39.8° C.), chloroform (boiling point: 61.2° C.), carbon tetrachloride (boiling point: 76.8° C.), 1,2-dichloroethane (boiling point: 83.5° C.) and trichloroethylene (boiling point: 87.2° C.), ethers such as diethylether (boiling point: 34.6° C.), diisopropylether (boiling point: 68.5° C.), dipropylether (boiling point: 90.5° C.) and tetrahydrofurane (boiling point: 66° C.), esters such as ethyl formate (boiling point: 54.2° C.), methyl acetate (boiling point: 57.8° C.), ethyl acetate (boiling point: 77.1° C.) and isopropyl acetate (boiling point: 89° C.), ketones such as acetone (boiling point: 56.1° C.) and 2-butanone (also referred to as “methyl ethyl ketone”; boiling point: 79.6° C.), alcohols such as methanol (boiling point: 64.5° C.), ethanol (boiling point: 78.3° C.), 2-propanol (boiling point: 82.4° C.) and 1-propanol (boiling point: 97.2° C.), cyano compounds such as acetonitrile (boiling point: 81.6° C.) and propionitrile (boiling point: 97.4° C.), and carbon disulfide (boiling point: 46.2° C.).

Examples of the solvent having a boiling point of 100° C. or more include octane (boiling point: 125.7° C.), toluene (boiling point: 110.6° C.), xylene (boiling point: 138° C.), tetrachloroethylene (boiling point: 121.2° C.), chlorobenzene (boiling point: 131.7° C.), dioxane (boiling point: 101.3° C.), dibutylether (boiling point: 142.4° C.), isobutyl acetate (boiling point: 118° C.), cyclohexanone (boiling point: 155.7° C.), 2-methyl-4-pentanone (also referred to as “MIBK”; boiling point: 115.9° C.), 1-butanol (boiling point: 117.7° C.), N,N-dimethylformamide (boiling point: 153° C.), N,N-dimethylacetamide (boiling point: 166° C.), and dimethylsulfoxide (boiling point: 189° C.). Preferred among these solvents are toluene, cyclohexanone and 2-methyl-4-pentanone.

Preferred among these solvents are ketones, aromatic hydrocarbons and esters. Particularly preferred among these solvents are ketones. Particularly preferred among the ketones is 2-butanone.

The ketone-based solvents, if any, may be used singly or in admixture. In the case where these ketone-based solvents are used in admixture, the content of the ketone-based solvents is preferably 10% by mass or more, more preferably 30% by mass or more, even more preferably 60% by mass or more of the total amount of the solvents contained in the coating composition.

Referring to the method of producing the anti-reflection film of the invention, the functional layer and low refractive layer components are diluted with the solvent having the aforementioned formulation to prepare the respective layer coating solutions. The concentration of the coating solutions are preferably properly adjusted taking into account the viscosity of the coating solution, the specific gravity of the layer materials, etc. but are each preferably from 0.1% to 80% by mass, more preferably from 1% to 60% by mass.

The solvents for the various layers may have the same or different formulations.

[Coating Method]

The anti-reflection film of the invention can be formed by the following method, but the invention is not limited thereto.

Firstly, coating solutions containing components for the various layers are prepared. Subsequently, the coating solutions for constituting the various layers are spread over the transparent support using a dip coating method, air knife coating method, curtain coating method, roller coating method, wire bar coating method, gravure coating method or die coating method, and then heated and dried. Preferred among these coating methods are gravure coating method, wire bar coating method and die coating method. Further, it is most desirable that spreading be effected using a die the configuration of which is devised as described later. Thereafter, the solvent is removed at the drying step. The drying step is preferably arranged such that the coating zone is directly followed by a drying zone the atmosphere in which can be controlled to control the drying speed. It is more desirable that the coating zone is preferably followed by a condensation plate which is a platelike member disposed almost parallel to the running direction as disclosed in JP-A-2003-106767. In this arrangement, the distance between the condensation plate and the coat layer or the temperature of the condensation plate can be controlled to condensate the solvent in the coating solution which is then recovered.

Thereafter, the coat layer is irradiated with light or heated to cure the monomers constituting the various layers. In this manner, the various layers are formed.

[Configuration of Die Coater]

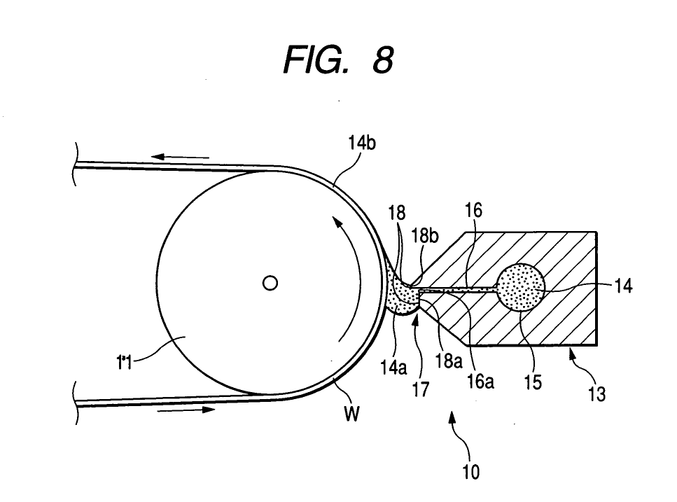

FIG. 8 is a sectional view of a coater comprising a slot die used in the implementation of the invention.

A coater 10 is adapted to spread a coating solution 14 from a slot die 13 in the form of bead 14a over a web W which is continuously running while being supported on a backup roller 11 to form a coat layer 14b on the web W.

Formed inside the slot die 13 are a pocket 15 and a slot 16. The pocket 15 has a section formed by a curve and a straight line. The section may be substantially circular as shown in FIG. 8 or semicircular. The pocket 15 is a coating solution reservoir space extending in the crosswise direction of the slot die 13 with its sectional shape. The effective length of extension of the space is normally equal to or somewhat longer than the coating width.

The supply of the coating solution 14 into the pocket 15 is conducted on the side of the slot die 13 or on the center of the side of the slot die 13 opposite the slot opening 16a. The pocket 15 comprises a plug provided therein for preventing the leakage of the coating solution 14.

The slot 16 is a channel for the coating solution 14 from the pocket 15 to the web W. The channel has a sectional shape extending in the crosswise direction of the slot die 13 as in the pocket 15. The width of the opening 16a disposed on the web side of the channel is normally adjusted to a value substantially equal to the coating width by a width limiting plate (not shown). The angle of the forward end of the slot 16 with respect to the line normal to the surface of the backup roller 11 in the web running direction is preferably from 30° to 90°.

The forward end lip 17 of the slot die 13 at which the opening 16a of the slot 16 is disposed is convergent. The forward end of the lip 17 forms a flat portion 18 called land. In the land 18, the portion disposed upstream from the slot 16 along the running direction of web W is called upstream lip land 18a. The portion disposed downstream from the slot 16 along the running direction of web W is called downstream lip land 18b.

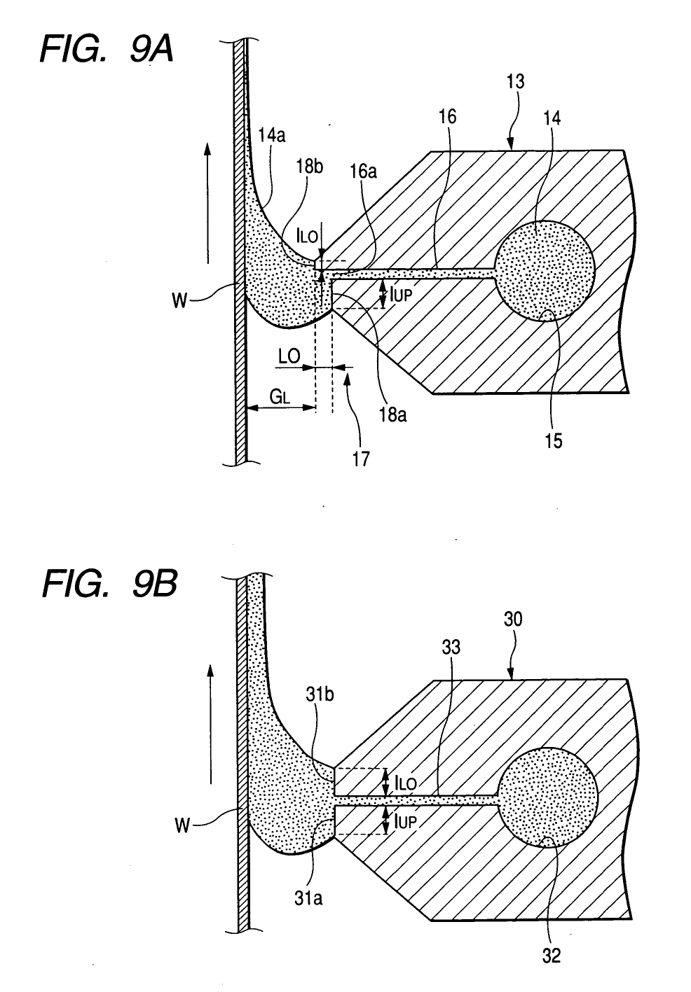

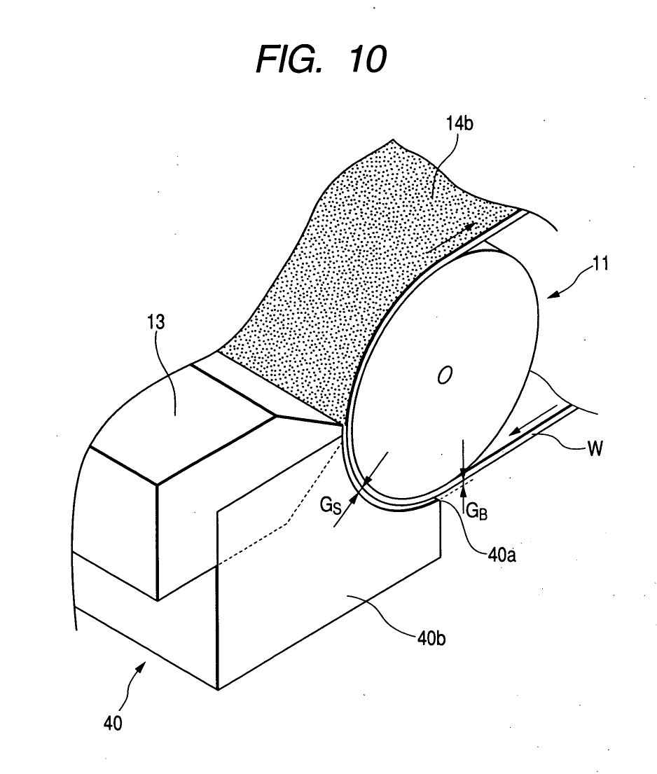

FIGS. 9A and 9B illustrate the sectional shape of the slot die 13 as compared with the related art. FIG. 9A illustrates the slot die 13 of the invention. FIG. 9B illustrates a related art slot die 30. In the related art slot die 30, the distance between the upstream lip land 31a and the web W and the distance between the downstream lip land 31b and the web W are the same as each other. In FIG. 9B, the reference numeral 32 indicates a pocket and the reference numeral 33 indicates a slot. In the slot die 13 of the invention, on the contrary, the length I_{LO} of the downstream lip land is shorter than the length of the upstream lip land. In this arrangement, spreading can be conducted to a wet thickness of 20 μm or less with a good precision.

The length I_{UP} of the upstream lip land 18a is not specifically limited but is preferably from 100 μm to 1 mm. The length I_{LO} of the downstream lip land 18b is from 30 μm to 100 μm, preferably from 30 μm to 80 μm, more preferably from 30 μm to 60 μm.

When the length I_{LO} of the downstream lip land is less than 30 μm, the edge or land of the forward lip 17 can easily break off, making it easy to cause the occurrence of streak on the coat layer and hence making spreading impossible. Another problem arises that the wet line position on the downstream side can be difficultly predetermined, making it easy for the coating solution to spread on the downstream side. It has heretofore been known that the expansion of wet by the coating solution on the downstream side means unevenness in wet line and results in the occurrence of defective shapes such as streak on the coat layer.

On the contrary, when the length I_{LO} of the downstream lip land is more than 100 μm, the bead itself cannot be formed, making it impossible to make thin layer spreading.

Further, the downstream lip land 18b has an overbite configuration such that it is disposed closer to the web W than the upstream lip land 18a. In this arrangement, the degree of vacuum can be reduced to form a bead suitable for thin layer spreading. The difference in distance from the web W between the downstream lip land 18b and the upstream lip land 18a (hereinafter referred to as “overbite length LO”) is preferably from 30 μm to 120 μm, more preferably from 30 μm to 100 μm, most preferably from 30 μm to 80 μm.

When the slot die 13 has an overbite configuration, the gap G_{L} between the forward end lip 17 and the web W indicates the gap between the downstream lip land 18b and the web W.

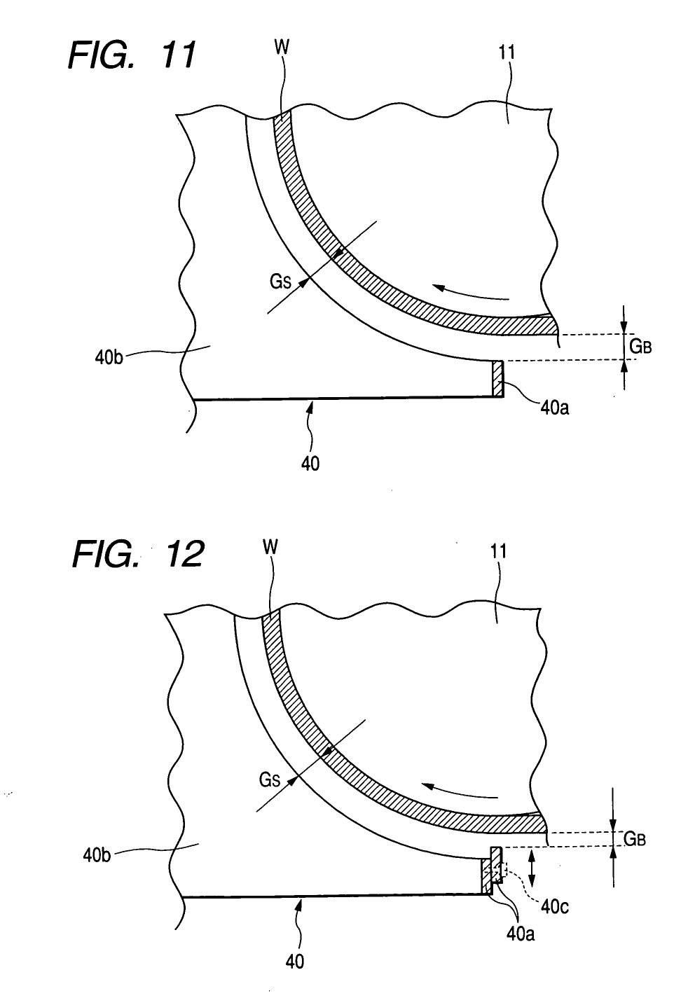

FIG. 10 is a perspective view illustrating a slot die used at the coating step in the implementation of the invention and its periphery. Disposed on the side of the slot die opposite the side on which the web W is running is a pressure-reducing chamber 40 at a position where it doesn't come in contact with the slot die such that sufficient adjustment of pressure reduction can be made on the bead 14a. The pressure-reducing chamber 40 comprises a back plate 40a and a side plate 40b for maintaining the operating efficiency. There are present gaps GB and Gs between the back plate 40a and the web W and between the side plate 40b and the web W, respectively.

FIGS. 11 and 12 each are a sectional view illustrating the pressure-reducing chamber 40 and the web W which are disposed close to each other. The side plate 40b and the back plate 40a may be formed integral with the chamber as shown in FIG. 11 or may be fixed to the chamber 40 with a screw 40c so that the gap can be properly varied as shown in FIG. 12.

Regardless of the configuration, the actual space between the back plate 40a and the web W and between the side plate 40b and the web W are defined to be G_{B} and G_{S}, respectively. The gap G_{B} between the back plate 40a and the web W in the pressure-reducing chamber 40 indicates the gap between the uppermost end of the back plate 40a and the web W in the case where the pressure-reducing chamber 40 is disposed beneath the web W and the slot die 13 as shown in FIG. 10.

The arrangement is preferably made such that the gap GB between the back plate 40a and the web W is larger than the gap G_{L} between the forward end lip 17 of the slot die 13 and the web W. In this arrangement, the change of the degree of vacuum in the vicinity of bead attributed to the eccentricity of the backup roller 11 can be inhibited.

For example, when the gap G_{L} between the forward end lip 17 of the slot die 13 and the web W is from 30 μm to 100 μm, the gap GB between the back plate 40a and the web W is preferably predetermined to be from 100 μm to 500 μm.

[Material, Precision]

As the length of the forward end lip 17 in the web running direction on the web W running side increases, it is less advantageous for the formation of bead. When the length of the forward end lip varies with arbitrary sites in the crosswise direction of the slot die, the resulting slight external disturbance makes the bead unstable. Accordingly, the change of the length of the forward end lip in the crosswise direction of the slot die is preferably predetermined to be 20 μm or less.

Referring to the material of the forward end lip of the slot die, a material such as stainless steel undergoes sagging during die machining, making it impossible to satisfy the desired precision of the forward end lip 17 even if the length of the forward end lip 17 of the slot die is from 30 to 100 μm in the web running direction as previously mentioned.

Accordingly, in order to maintain a high working precision, it is important to use an ultrahard material as disclosed in Japanese Patent No. 2,817,053. In some detail, at least the forward end lip 17 of the slot die is preferably made of an ultrahard alloy comprising carbide crystals having an average particle diameter of 5 μm or less bonded thereto.

Examples of the ultrahard alloy include those obtained by bonding carbide crystallites such as tungsten carbide (hereinafter referred to as “WC”) with a binding metal such as cobalt. As the binding metal there may be used titanium, tantalum, niobium or mixture thereof besides cobalt. The average particle diameter of WC crystallites is more preferably 3 μm or less.

In order to realize a high precision spreading, the aforementioned length of the forward end lip 17 on the side where the web is running and the dispersion of the gap between the forward end lip 17 and the web in the crosswise direction of the slot die, too, are important factors. The combination of the two factors, i.e., straightness such that the change of gap can be somewhat inhibited is preferably attained. More preferably, the straightness of the forward end lip 17 with respect to the backup roller is attained such that the change of the gap in the crosswise direction of the slot die is not greater than 5 μm.

A polarizing plate is mainly composed of two sheets of protective film with a polarizing membrane provided interposed therebetween. The optical film of the invention, particularly anti-reflection film, is preferably used as at least one of the two sheets of protective film between which the polarizing membrane is disposed interposed. When the anti-reflection film of the invention acts also as a protective film, the production cost of the polarizing plate can be reduced. Further, when the anti-reflection film of the invention is used as an outermost surface layer, the reflection of external light, etc. can be prevented, making it possible to provide a polarizing plate excellent also in scratch resistance, stainproofness, etc.

As the polarizing layer there may be used a known polarizing layer or a polarizing layer cut out of a polarizing layer of continuous length having an absorption axis which is neither parallel to nor perpendicular to the longitudinal direction. The polarizing layer of continuous length having an absorption axis which is neither parallel to nor perpendicular to the longitudinal direction is prepared by the following method.

This is a polarizing layer stretched by tensing a continuously supplied polymer while being retained at the both ends thereof by a retainer. In some detail, the polarizing layer can be produced by a stretching method which comprises stretching the film by a factor of from 1.1 to 20.0 at least in the crosswise direction in such a manner that the difference in longitudinal progress speed of retainer between at both ends is 3% or less and the direction of progress of film is deflexed with the film retained at the both ends thereof such that the angle of the direction of progress of film at the outlet of the step of retaining both ends of the film with respect to the substantial direction of film stretching is from 20° to 70°. In particular, those obtained under the aforementioned conditions wherein the inclination angle is 45° are preferably used from the standpoint of productivity.

For the details of the method of stretching polymer film, reference can be made to JP-A-2002-86554, paragraphs [0020]-[0030].

It is also preferred that the film other than anti-reflection film among the two sheets of protective films for polarizer be an optical compensation film having an optical compensation layer containing an optically anisotropic layer. The optical compensation film (retardar film) can improve the viewing angle properties of the screen of liquid crystal display device.

As the optical compensation film there may be used any material known as such. In respect to the rise of viewing angle, there is preferably used an optical compensation layer having an optically anisotropic layer made of a compound having a discotic structural unit wherein the angle of the discotic compound with respect to the transparent support changes with the distance from the transparent support as disclosed in JP-A-2001-100042.

This angle preferably changes with the rise of the distance from the transparent support side of the optically anisotropic layer.

The anti-reflection film of the invention can be applied to an image display device such as liquid crystal display device (LCD), plasma display panel (PDP), electroluminescence display (ELD) and cathode ray tube display device (CRT). The anti-reflection film of the invention has a transparent support and thus can be bonded to the image display surface of the image display device on the transparent support side thereof.

The anti-reflection film of the invention, if used as one of polarizing layer surface protective films, is preferably used in transmission type, reflection type or semi-transmission type liquid crystal display devices of mode such as twisted nematic (TN), supertwisted nematic (STN), vertical alignment (VA), in-plane switching (IPS) and optically compensated bend cell (OCB).

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell (1), there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode, CAP mode) (as disclosed in Preprints of Symposium on Japanese Liquid Crystal Society Nos. 58 to 59, 1988 and (4) liquid crystal cell of SURVALVAL mode (as reported in LCD International 98).

An OCB mode liquid crystal cell is a liquid crystal cell of bend alignment mode wherein rod-shaped liquid crystal molecules are oriented in substantially opposing directions (symmetrically) from the upper part to the lower part of the liquid crystal cell as disclosed in U.S. Pat. Nos. 4,583,825 and 5,410,422. In the OCB mode liquid crystal cell, rod-shaped liquid crystal molecules are oriented symmetrically with each other from the upper part to the lower part of the liquid crystal cell. Therefore, the bend alignment mode liquid crystal cell has a self optical compensation capacity. Accordingly, this liquid crystal mode is also called OCB (optically compensated bend) liquid crystal mode. The bend alignment mode liquid crystal display device is advantageous in that it has a high response.

In ECB mode liquid crystal cell, rod-shaped liquid crystal molecules are oriented substantially horizontal when no voltage is applied thereto. The ECB mode liquid crystal cell is used mostly as a color TFT liquid crystal display device. For details, reference can be made to many literatures, e.g., “EL, PDP, LCD Displays”, Toray Research Center, 2001.

For TV or IPS mode liquid crystal display devices in particular, the use of an optical compensation sheet having a viewing angle expanding effect as one of two sheets of polarizing layer protective film opposite the anti-reflection film of the invention makes it possible to obtain a polarizing plate having both anti-reflection effect and viewing angle expanding effect by the thickness of only one sheet of polarizing plate as disclosed in JP-A-2001-100043.

### EXAMPLE

The invention will be further described in the following examples, but the invention is not limited thereto.

### Example 1

(Preparation of Hard Coat Layer Coating Solution (HCL-1))

284 g of a commercially available zirconia-containing UV-curing hard coat solution (DeSolite Z7404, produced by JSR Co., Ltd.; solid content concentration: approx. 61%; ZrO₂ content in solid content: approx. 70%; polymerizable monomer; polymerization initiator contained) and 86 g of a mixture of dipentaerythritol pentaacrylate and dipentaerythritol hexaacrylate (DPHA, produced by NIHON KAYAKU CO., LTD.) were mixed. The mixture was then diluted with 60 g of methyl isobutyl ketone and 17 g of methyl ethyl ketone. To the mixture was then added 28.5 g of a silane coupling agent (KBM-5103, produced by Shin-Etsu Chemical Co., Ltd.). The mixture was then stirred. To the solution was then added 30 g of a dispersion obtained by dispersing a 30% methyl isobutyl ketone dispersion of a classified reinforced crosslinked particulate PMMA having an average particle diameter of 3.0 μm (refractive index: 1.49; MXS-300, produced by Soken Chemical & Engineering Co., Ltd.) at 10,000 rpm by a polytron dispersing machine for 20 minutes. Subsequently, to the mixture was added 95 g of a dispersion obtained by dispersing a 30% methyl ethyl ketone dispersion of a particulate silica having an average particle diameter of 1.5 μm (refractive index: 1.46, SEAHOSTER KE-P150, produced by NIPPON SHOKUBAI CO., LTD.) at 10,000 rpm by a polytron dispersing machine for 30 minutes. The mixture was then stirred to complete the desired solution. The aforementioned mixture was filtered through a polypropylene filter having a pore diameter of 30 μm to prepare a hard coat layer coating solution (HCL-1).

(Preparation of Hard Coat Layer Coating Solution (HCL-2))

284 g of a commercially available zirconia-containing UV-curing hard coat solution (DeSolite Z7404, produced by JSR Co., Ltd.; solid content concentration: approx. 61%; ZrO₂ content in solid content: approx. 70%; polymerizable monomer; polymerization initiator contained) and 86 g of a mixture of dipentaerythritol pentaacrylate and dipentaerythritol hexaacrylate (DPHA, produced by NIHON KAYAKU CO., LTD.) were mixed. The mixture was then diluted with 60 g of methyl isobutyl ketone and 17 g of methyl ethyl ketone. To the mixture was then added 28.5 g of a silane coupling agent (KBM-5103, produced by Shin-Etsu Chemical Co., Ltd.). The mixture was then stirred. To the solution was then added 0.26 g of a fluorine-based surface active agent (FP-7, 40 mass-% MEK solution). The mixture was then stirred. To the solution was then added 30 g of a dispersion obtained by dispersing a 30% methyl isobutyl ketone dispersion of a classified reinforced crosslinked particulate PMMA having an average particle diameter of 3.0 μm (refractive index: 1.49; MXS-300, produced by Soken Chemical & Engineering Co., Ltd.) at 10,000 rpm by a polytron dispersing machine for 20 minutes. Subsequently, to the mixture was added 95 g of a dispersion obtained by dispersing a 30% methyl ethyl ketone dispersion of a particulate silica having an average particle diameter of 1.5 μm (refractive index: 1.46, SEAHOSTER KE-P150, produced by NIPPON SHOKUBAI CO., LTD.) at 10,000 rpm by a polytron dispersing machine for 30 minutes. The mixture was then stirred to complete the desired solution. The aforementioned mixture was filtered through a polypropylene filter having a pore diameter of 30 μm to prepare a hard coat layer coating solution (HCL-2).

(Preparation of Hard Coat Layer Coating Solution (HCL-3))

A hard coat layer coating solution (HCL-3) was prepared in the same manner as in the coating solution (HCL-2), including the added amount, except that to the hard coat layer coating solution (HCL-2) was added 0.26 g of a fluorine-based surface active agent (FP-17, 40 mass-% MEK solution) instead of the fluorine-based surface active agent (FP-7).

(Preparation of Hard Coat Layer Coating Solution (HCL-4))

A hard coat layer coating solution (HCL-4) was prepared in the same manner as in the coating solution (HCL-2), including the added amount, except that to the hard coat layer coating solution (HCL-2) was added 0.26 g of a fluorine-based surface active agent (FP-28, 40 mass-% MEK solution) instead of the fluorine-based surface active agent (FP-7).

(Preparation of Hard Coat Layer Coating Solution (HCL-5))

A hard coat layer coating solution (HCL-5) was prepared in the same manner as in the coating solution (HCL-2), including the added amount, except that to the hard coat layer coating solution (HCL-2) was added 0.26 g of a fluorine-based surface active agent (FP-30, 40 mass-% MEK solution) instead of the fluorine-based surface active agent (FP-7).

(Preparation of Hard Coat Layer Coating Solution (HCL-6))

A hard coat layer coating solution (HCL-6) was prepared in the same manner as in the coating solution (HCL-2), including the added amount, except that to the hard coat layer coating solution (HCL-2) was added 0.26 g of a fluorine-based surface active agent (FP-43, 40 mass-% MEK solution) instead of the fluorine-based surface active agent (FP-7).

(Preparation of Hard Coat Layer Coating Solution (HCL-7))

A hard coat layer coating solution (HCL-7) was prepared in the same manner as in the coating solution (HCL-2), including the added amount, except that to the hard coat layer coating solution (HCL-2) was added 0.26 g of the following fluorine-based surface active agent (R-1, 40 mass-% MEK solution) instead of the fluorine-based surface active agent (FP-7). 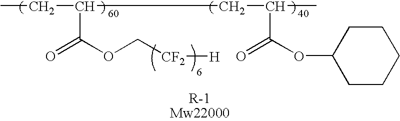
(Preparation of Hard Coat Layer Coating Solution (HCL-8))

A hard coat layer coating solution (HCL-8) was prepared in the same manner as in the coating solution (HCL-2), including the added amount, except that to the hard coat layer coating solution (HCL-2) was added 0.26 g of the following fluorine-based surface active agent (R-2, 40 mass-% MEK solution) instead of the fluorine-based surface active agent (FP-7). 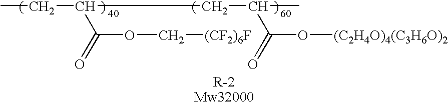
(Preparation of Sol Solution a-2)

To a 1,000-ml reaction vessel equipped with a thermometer, a nitrogen-introducing pipe and a dropping funnel were charged 187 g (0.80 mol) of acryloxypropyltrimethoxysilane, 27.2 g (0.20 mol) of methyltrimethoxysilane, 320 g (10 mols) of methanol and 0.06 g (0.001 mol) of KF, and 15.1 g (0.86 mol) of water was gradually dropwise added thereto at room temperature under stirring. After completion of the dropwise addition, the mixture was stirred for 3 hours at room temperature, and then heated for 2 hours while stirring under methanol reflux. Thereafter, low-boiling components were distilled off under reduced pressure, followed by filtering the residue to obtain 120 g of sol solution a-2. GPC measurement of the thus-obtained product revealed that the product had a weight-average molecular weight of 1,500, with the content of ingredients of from 1,000 to 20,000 in molecular weight amounting to 30% of the ingredients of oligomers or more polymers.

Also, results of measurement of ¹H-NMR show that the structure of the resultant substance is a structure represented by the following general formula.

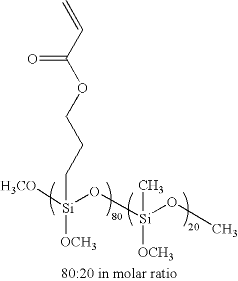

Further, condensation ratio α was found to be 0.56 by measurement of ²⁹Si-NMR. It is seen from this analytical result that most of this silane coupling agent sol comprises a straight-chain structure.

Also, gas chromatography analysis revealed that the content of the remaining starting material of acryloxypropyltrimethoxysilane was 5% or less.

(Preparation of a coating solution (HCL-9)
for forming a hard coat layer)

| | |
|---|---|
| PET-30 | 50.0 g |
| Irgacure 184 | 2.0 g |
| SX-350 (30% by mass toluene solution) | 1.5 g |
| Cross-linked acryl-styrene particles (30%) | 13.0 g |
| FP-7 (40% by mass MEK solution) | 0.75 g |
| Sol solution a-2 | 9.5 g |
| Toluene | 38.5 g |

(Preparation of a coating solution (HCL-10)
for forming a hard coat layer)

| | |
|---|---|
| PET-30 | 50.0 g |
| Irgacure 184 | 2.0 g |
| 8-μm cross-linked polymethyl | 14.5 g |
| methacrylate particles (30% by mass, toluene solution) | |
| FP-7 (40% by mass MEK solution) | 0.75 g |
| Sol solution a-2 | 10.0 g |
| Toluene | 38.5 g |

(Preparation of a coating solution (HCL-11)
for forming a hard coat layer)

| | |
|---|---|
| PET-30 | 50.0 g |
| Irgacure 184 | 2.0 g |
| 8-μm cross-linked polymethyl | 14.5 g |
| methacrylate particles (30% by mass, MiBK solution) | |
| FP-7 (40% by mass MEK solution) | 0.75 g |
| Sol solution a-2 | 10.0 g |
| MiBK | 38.5 g |

The above-described coating solution was filtered through a polypropylene-made filter of 30 μm in pore size to prepare a coating solution (HCL-9 to 11) for forming a hard coat layer.

(Preparation of Sol a)

Into a reaction vessel equipped with an agitator and a reflux condenser were charged 119 parts by mass of methyl ethyl ketone, 101 parts by mass of acryloyl oxypropyl trimethoxysilane “KBM-5103” (produced by Shin-Etsu Chemical Co., Ltd.) and 3 parts by mass of diisopropoxy aluminum ethyl acetoacetate. The mixture was then stirred. To the mixture were then added 30 parts by mass of deionized water. The reaction mixture was allowed to undergo reaction at 60° C. for 4 hours, and then allowed to cool to room temperature to obtain a sol a.

The sol a thus obtained had a mass-average molecular weight of 1,600. The proportion of components having a molecular weight of from 1,000 to 20,000 in the oligomer components or high components was 100%. The gas chromatography of the reaction product showed that none of the acryloyloxy propyl trimethoxysilane as raw material remained.

(Preparation of Low Refractive Layer Coating Solution (LL-1))

13.1 g of JTA113 (trade name; refractive index: 1.44; solid content concentration: 6%; MEK solution; produced by JSR) having an enhanced coat layer strength as compared with JN-7228A, which has been already mentioned, 1.31 g of a colloidal silica dispersion MEK-ST-L (trade name; average particle diameter: 45 nm; solid content concentration: 30%; produced by NISSAN CHEMICAL INDUSTRIES, LTD.), 0.59 g of the aforementioned sol a 5.1 g of methyl ethyl ketone and 0.6 g of cyclohexanone were mixed, stirred, and then filtered through a polypropylene filter having a pore diameter of 1 μm to prepare a low refractive layer coating solution (LL-1).

(Configuration of Die Coater)

As the slot die 13 shown in FIGS. 9A and 9B there was used one having an upstream lip land length I_{UP} of 0.5 mm and a downstream lip land length of I_{LO} of 50 μm and comprising a slot 16 having an opening length of 150 μm in the web running direction and a length of 50 mm.

The gap between the upstream lip land 18a and the web W was 50 μm longer than the gap between the downstream lip land 18b and the web W (hereinafter referred to as “overbite length of 50 μm”) and the gap GL between the downstream lip land 18b and the web W was predetermined to be 50 μm.

The gap GS between the side plate 40b of the pressure-reducing chamber 40 and the web W and the gap GB between the back plate 40a of the pressure-reducing chamber 40 and the web W were both predetermined to be 200 μm.

### Inventive Example 1

(Preparation of Anti-Reflection Film)

The hard coat layer coating solution (HCL-2) was spread over a triacetyl cellulose film having a thickness of 80 μm (TAC-TD80UF”, produced by Fuji Photo Film Co., Ltd.) which had been destaticized on the coat layer side thereof by an ultrasonic dust remover using the aforementioned die coater at a rate of 30 m/min. The degree of vacuum of the pressure-reducing chamber was 0.8 kPa. The spreading of HCL-2 was effected the gap GL between the downstream lip land 18b and the web W kept at 80 μm. The web thus spread was dried at 80° C., and then irradiated with ultraviolet rays at an illuminance of 400 mW/cm² and a dose of 500 mJ/cm² using a 160 W/cm air-cooled metal halide lamp (produced by EYE GRAPHICS CO., LTD.) while the air in the system was being purged with nitrogen to form a 0.1 vol-% oxygen atmosphere so that it was cured. The web was then wound. Thus, a hard coat layer was formed to a thickness of 7 μm. Using the aforementioned die coater, the low refractive layer coating solution (LL-19 was then spread over the hard coat layer. The degree of vacuum of the pressure-reducing chamber was 0.8 kPa. The web thus spread was dried at 90° C. for 30 seconds, and then irradiated with ultraviolet rays at an illuminance of 600 mW/cm² and a dose of 400 mJ/cm² using a 240 W/cm air-cooled metal halide lamp (produced by EYE GRAPHICS CO., LTD.) while the air in the system was being purged with nitrogen to form a 0.1 vol-% oxygen atmosphere so that a low refractive layer was formed (refractive index: 1.45; thickness: 83 nm). Thus, an anti-reflection film was prepared.

During the aforementioned procedure, spreading and drying were effected in an air atmosphere having an air purification degree of 30 or less particles having a size of 0.5 μm or less per cubic meter. Spreading was effected while attached foreign matters peeled off the surface of the film by blowing air having a high purification degree as disclosed in JP-A-10-309553 onto the film at a high rate was being sucked by a suction port disposed close to the surface of the film. The charged voltage of the undestaticized base was 200 V or less. The aforementioned spreading step involved feeding, destaticization, spreading, drying, UV or thermal curing and winding every layer.

### Inventive Examples 2 to 6

Anti-reflection films were prepared in the same manner as in Inventive Example 1 except that the hard coat layer coating solutions (HCL-3) to (HCL-6) and (HCL-9) were used instead of the hard coat layer coating solution (HCL-2).

### Inventive Examples 7 and 8

Anti-reflection films were prepared in the same manner as in Inventive Example 1 except that the hard coat layer coating solutions (HCL-10) and (HCL-11) were used instead of the hard coat layer coating solution (HCL-2) and except for coating so that the thickness of the film curing became 17 μm.

### Comparative Examples 1 to 3

Anti-reflection films were prepared in the same manner as in Inventive Example 1 except that the hard coat layer coating solutions (HCL-1), (HCL-7) and (HCL-8) were used instead of the hard coat layer coating solution (HCL-2), respectively.

Evaluation of Surface Conditions

The anti-reflection films obtained in Inventive Examples 1 to 8 and Comparative Examples 1 to 3 were each painted black on the back side thereof, and then visually observed for surface conditions thereof. The results of evaluation are set forth in Table 1 below. The anti-reflection films obtained in Inventive Examples 1 to 8 by spreading coating solutions containing the compositions obtained in the invention exhibited a good resistance to wind unevenness. On the other hand, the anti-reflection films prepared in Comparative Example 1 was free of fluorine-based surface active agent and thus was subject to wind unevenness.

Moisture Test

An acrylic adhesive layer was provided on the side of the anti-reflection films prepared in Inventive Examples 1 to 8 and Comparative Examples 1 to 3 opposite the coat layer thereof to a thickness of 25 μm to prepare adhesive type optical films. These adhesive type optical films were each cut into a size of 200 mm×150 mm, laminated on an alkali-free glass sheet (Corning 1737, produced by Corning Incorporated), and then allowed to stand in a 50° C.-0.5 MPa atmosphere for 15 minutes. These samples were each allowed to stand in a 60° C.-90% RH atmosphere for 500 hours, and then visually observed for the occurrence of defectives such as lifting and exfoliation. These showing such a defective are represented by P (poor). Those showing no such a defective are represented by G (good). The results are set forth in Table 1.

TABLE 1

| | Fluorine-based | Glass transition | Glass transition point | Evaluation of | |
|---|---|---|---|---|---|
| | surface active | point [K] of | [K] of fluorine-based | surface | Moisture |
| | agent | repeating unit B | surface active agent | conditions | test |
| Inventive | FP-7 | 367 | 287 | G | G |
| Example 1 | | | | | |
| Inventive | FP-17 | 426 | 274 | G | G |
| Example 2 | | | | | |
| Inventive | FP-28 | 308 | 280 | G | G |
| Example 3 | | | | | |
| Inventive | FP-30 | 358 | 305 | G | G |
| Example 4 | | | | | |
| Inventive | FP-43 | 391 | 301 | G | G |
| Example 5 | | | | | |
| Inventive | FP-7 | 367 | 287 | G | G |
| Example 6 | | | | | |
| Inventive | FP-7 | 367 | 287 | G | G |
| Example 7 | | | | | |
| Inventive | FP-7 | 367 | 287 | G | G |
| Example 8 | | | | | |
| Comparative | None | — | — | P | G |
| Example 1 | | | | | |
| Comparative | R-1 | 292 | 270 | G | P |
| Example 2 | | | | | |
| Comparative | R-2 | 250 | 226 | G | P |
| Example 3 | | | | | |

As can be seen in Table 1, the fluorine-based surface active agent of the invention has a high glass transition point and thus cannot be transferred to the back side of the web when spread over the web. Accordingly, when laminated on a glass sheet or the like, the anti-reflection films containing the fluorine-based surface active agent can neither lifted nor exfoliated from the substrate to exhibit good properties. Further, the incorporation of the fluorine-based surface active agent causes no wind unevenness on the coat layer, making it possible to obtain a high quality anti-reflection film. On the other hand, the comparative fluorine-based surface active agent makes it possible to inhibit wind unevenness but exhibits a low glass transition point and thus can be easily transferred to the back side of the web to deteriorate the adhesion of the adhesive layer, causing the occurrence of lifting or exfoliation to disadvantage. Further, when the comparative fluorine-based surface active agent is not contained, the resulting coat layer exhibits a good adhesion but undergoes some wind unevenness and thus cannot provide a high quality anti-reflection film.

The anti-reflection films prepared in Inventive Examples 1 to 6 were each dipped in a 2.0 N 55° C. aqueous solution of NaOH for 2 minutes to undergo saponification on the triacetyl cellulose surface of the back side thereof. A triacetyl cellulose film having a thickness of 80 μm (TAC-TD80U, produced by Fuji Photo Film Co., Ltd.) was saponified under the same conditions as mentioned above. The aforementioned saponified anti-reflection film and the triacetyl cellulose film thus saponified were then bonded to the respective side of a polarizer obtained by allowing a polyvinyl alcohol to adsorb iodine, and then stretching the film so that the polarizer was protected to prepare a polarizing plate. The polarizing plate thus prepared was then used to replace the viewing side polarizing plate of the liquid crystal display device (comprising a Type D-BEF polarizing separation film with polarization selective layer, produced by Sumitomo 3M Co., Ltd., provided interposed between backlight and liquid crystal cell) in a note type personal computer comprising a transmission type TN liquid crystal display device mounted thereon in such an arrangement that the anti-reflection layer was disposed outermost. As a result, a display device having a very high display quality which causes little reflection of background, shows remarkably eliminated tint of reflected light and assures desired uniformity in display plane was obtained.

In accordance with the invention, a coating composition useful as an anti-reflection layer or the like having improvements in resistance to drying unevenness or air flow unevenness is provided. The use of such an anti-reflection layer makes it possible to obtain an anti-reflection film having a high uniformity in surface conditions and sufficient anti-reflection properties. Further, a polarizing plate and an image display device comprising such an anti-reflection film can be obtained.

The entire disclosure of each and every foreign patent application from which the benefit of foreign priority has been claimed in the present application is incorporated herein by reference, as if fully set forth.

What is claimed is:

1. A coating composition comprising:
a fluoroaliphatic group-containing copolymer comprising a repeating unit A corresponding to a fluoroaliphatic group-containing monomer and a repeating unit B corresponding to at least one monomer,
wherein a material obtained by polymerization of only the repeating unit B exhibits a glass transition point of 300K or more.

2. A coating composition comprising:
a fluoroaliphatic group-containing copolymer comprising a repeating unit A corresponding to a fluoroaliphatic group-containing monomer and a repeating unit B corresponding to at least one monomer,
wherein the fluoroaliphatic group-containing copolymer exhibits a glass transition point of 273K or more.

3. The coating composition as defined in claim 1,
wherein the repeating unit A comprises a fluoroaliphatic group-containing monomer represented by general formula [1]: 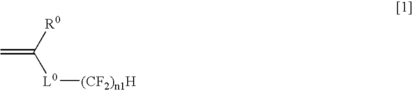
wherein R⁰ represents a hydrogen atom, halogen atom or methyl group; L⁰ represents a divalent connecting group; and n1 represents an integer of from not smaller than 1 to not greater than 18.

4. The coating composition as defined in claim 2,
wherein the repeating unit A comprises a fluoroaliphatic group-containing monomer represented by general formula [1]: 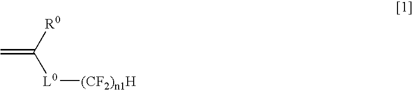
wherein R⁰ represents a hydrogen atom, halogen atom or methyl group; L⁰ represents a divalent connecting group; and n1 represents an integer of from not smaller than 1 to not greater than 18.

5. The coating composition as defined in claim 1,
wherein the repeating unit A comprises a fluoroaliphatic group-containing monomer represented by general formula [2]: 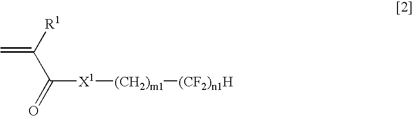
wherein R¹ represents a hydrogen atom, halogen atom or methyl group; X¹ represents an oxygen atom, sulfur atom or —N(R²)— in which R² represents a hydrogen atom or a C₁-C₈ alkyl group which may have substituents; and n1 represents an integer of from not smaller than 1 to not greater than 18.

6. The coating composition as defined in claim 2,
wherein the repeating unit A comprises a fluoroaliphatic group-containing monomer represented by general formula [2]: 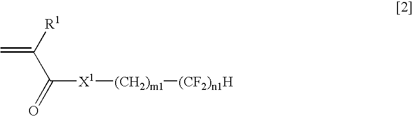
wherein R³ represents a hydrogen atom, halogen atom or methyl group; X¹ represents an oxygen atom, sulfur atom or —N(R²)— in which R² represents a hydrogen atom or a C₁-C₈ alkyl group which may have substituents; and n1 represents an integer of from not smaller than 1 to not greater than 18.

7. The coating composition as defined in claim 1,
wherein the repeating unit A comprises a fluoroaliphatic group-containing monomer represented by general formula [3]: 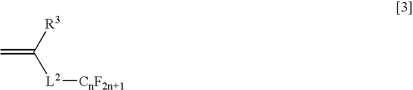
wherein R³ represents a hydrogen atom, halogen atom or methyl group; L² represents a divalent connecting group; and n represents an integer of from not smaller than 1 to not greater than 6.

8. The coating composition as defined in claim 2,
wherein the repeating unit A comprises a fluoroaliphatic group-containing monomer represented by general formula [3]: 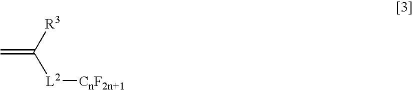
wherein R³ represents a hydrogen atom, halogen atom or methyl group; L² represents a divalent connecting group; and n represents an integer of from not smaller than 1 to not greater than 6.

9. The coating composition as defined in claim 1,
wherein the repeating unit A comprises a fluoroaliphatic group-containing monomer represented by general formula [4]: 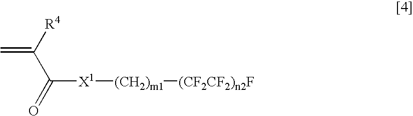
wherein R⁴ represents a hydrogen atom or methyl group; X¹ represents an oxygen atom, sulfur atom or —N(R²)— in which R² represents a hydrogen atom or a C₁-C₄ alkyl group which may have substituents; m1 represents an integer of from not smaller than 1 to not greater than 6; and n2 represents an integer of from not smaller than 1 to not greater than 3.

10. The coating composition as defined in claim 2,
wherein the repeating unit A comprises a fluoroaliphatic group-containing monomer represented by general formula [4]: 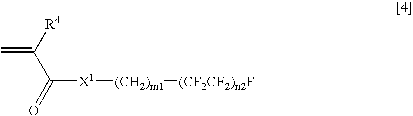
wherein R⁴ represents a hydrogen atom or methyl group; X¹ represents an oxygen atom, sulfur atom or —N(R²)— in which R¹ represents a hydrogen atom or a C₁-C₄ alkyl group which may have substituents; m1 represents an integer of from not smaller than 1 to not greater than 6; and n2 represents an integer of from not smaller than 1 to not greater than 3.

11. The coating composition as defined in claim 3, wherein n1 in the general formula [1] is 6.

12. The coating composition as defined in claim 4, wherein n1 in the general formula [1] is 6.

13. The coating composition as defined in claim 5, wherein n1 in the general formula [2] is 6.

14. The coating composition as defined in claim 6, wherein n1 in the general formula [2] is 6.

15. The coating composition as defined in claim 7, wherein n in the general formula [3] is 6.

16. The coating composition as defined in claim 8, wherein n in the general formula [3] is 6.

17. The coating composition as defined in claim 9, wherein n2 in the general formula [4] is 3.

18. The coating composition as defined in claim 10, wherein n2 in the general formula [4] is 3.

19. The coating composition as defined in claim 1, wherein the repeating unit B is an isobornyl acrylate or isobornyl methacrylate unit.

20. The coating composition as defined in claim 2, wherein the repeating unit B is an isobornyl acrylate or isobornyl methacrylate unit.

21. The coating composition as defined in claim 1, wherein the repeating unit B is a tertiary butyl acrylate or tertiary butyl methacrylate unit.

22. The coating composition as defined in claim 2, wherein the repeating unit B is a tertiary butyl acrylate or tertiary butyl methacrylate unit.

23. The coating composition as defined in claim 1, wherein the fluoroaliphatic group-containing copolymer is included in an amount of 0.15% by mass or less based on the total amount of the coating composition.

24. The coating composition as defined in claim 2, wherein the fluoroaliphatic group-containing copolymer is included in an amount of 0.15% by mass or less based on the total amount of the coating composition.

25. The coating composition as defined in claim 1, wherein a mass-average molecular weight of the fluoroaliphatic group-containing copolymer is from 5,000 to 25,000.

26. The coating composition as defined in claim 2, wherein a mass-average molecular weight of the fluoroaliphatic group-containing copolymer is from 5,000 to 25,000.

27. An optical film obtained by spreading a coating composition as defined in claim 1 into at least one layer.

28. An optical film obtained by spreading a coating composition as defined in claim 2 into at least one layer.

29. An optical film obtained by spreading a coating composition as defined in claim 1 into at least one layer, and then, onto the layer thus formed, spreading another layer.

30. An optical film obtained by spreading a coating composition as defined in claim 2 into at least one layer, and then, onto the layer thus formed, spreading another layer.

31. An anti-reflection film comprising an optical film as defined in claim 27, wherein the optical film has anti-reflection property.

32. An anti-reflection film comprising an optical film as defined in claim 28, wherein the optical film has anti-reflection property.

33. A polarizing plate comprising:
a polarizing layer; and
an anti-reflection film as defined in claim 31 provided on at least one side of the polarizing layer.

34. A polarizing plate comprising:
a polarizing layer; and
an anti-reflection film as defined in claim 32 provided on at least one side of the polarizing layer.

35. A polarizing plate comprising:
a polarizing layer;
an anti-reflection film as defined in claim 31 as one of protective films for the polarizing layer; and
an optically anisotropic optical compensation film as the other one of the protective films for the polarizing layer.

36. A polarizing plate comprising:
a polarizing layer;
an anti-reflection film as defined in claim 32 as one of protective films for the polarizing layer; and
an optically anisotropic optical compensation film as the other one of the protective films for the polarizing layer.

37. An image display device comprising an anti-reflection film as defined in claim 31.

38. An image display device comprising an anti-reflection film as defined in claim 32.

39. An image display device comprising a polarizing plate as defined in claim 33.

40. An image display device comprising a polarizing plate as defined in claim 34.

41. An image display device comprising a polarizing plate as defined in claim 35.

42. An image display device comprising a polarizing plate as defined in claim 36.
